(19) United States
(12) Patent Application Publication
(10) Pub. No.: US 2026/0343043 A1
(43) Pub. Date: Oct. 29, 2026

(54) PLAYBACK SYSTEM ARCHITECTURES AND AREA ZONE CONFIGURATIONS

(71) Applicant: Sonos, Inc., Goleta, CA (US)

(72) Inventors: Steven Beckhardt, Santa Barbara, CA (US); Luis R. Vega-Zayas, Cambridge, MA (US); Ted Lin, Goleta, CA (US)

(21) Appl. No.: 19/116,954

(22) PCT Filed: Sep. 29, 2023
(86) PCT No.: PCT/US2023/034170

§ 371 Date: Mar. 28, 2025

Related U.S. Application Data
(60) Provisional application No. 63/377,899, filed on Sep. 30, 2022.
(60) Provisional application No. 63/377,948, filed on Sep. 30, 2022.
(60) Provisional application No. 63/377,967, filed on Sep. 30, 2022.
(60) Provisional application No. 63/377,978, filed on Sep. 30, 2022.
(60) Provisional application No. 63/377,979, filed on Sep. 30, 2022.
(60) Provisional application No. 63/502,347, filed on May 15, 2023.
(60) Provisional application No. 63/513,735, filed on Jul. 14, 2023.

(51) Int. Cl. H04N 21/43; G06F 3/16

(52) U.S. Cl. CPC H04N 21/43076; G06F 3/165; H04N 21/4305

(57) ABSTRACT

Disclosed embodiments include multi-tier hierarchical network architectures built from several playback groups, where individual playback groups include two or more playback devices where one of the playback devices in the playback group is configured to operate as a primary playback device for the playback group, and where the other playback devices and the playback group are configured to operate as secondary playback devices in the playback group. In operation, the playback groups formed from the primary playback devices and secondary playback devices enable hierarchical distribution of audio content, playback timing, clock timing, and/ or configuration and control signaling to facilitate groupwise playback of audio content by the several playback groups comprising the playback devices.

### CROSS REFERENCE TO RELATED APPLICATIONS

This application claims priority to: (i) U.S. Provisional App. 63/377,948, titled “Playback System Architecture,” referred to as Docket No. 21-0703p, filed on Sep. 30, 2022; (ii) U.S. Provisional App. 63/377,899, titled “Multichannel Content Distribution,” referred to as Docket No. 22-0207p (0400042), filed on Sep. 30, 2022; (iii) U.S. Provisional App. 63/377,967, titled “Playback Systems with Dynamic Forward Error Correction,” referred to as Docket No. 22-0401p (0403973), filed on Sep. 30, 2022; (iv) U.S. Provisional App. 63/377,978, titled “Broker/Subscriber Model for Information Sharing and Management Among Connected Devices,” referred to as Docket No. 22-0606Ap (0404192), filed on Sep. 30, 2022; (v) U.S. Provisional App. 63/377,979, titled “Multiple Broker Deployment for Information Sharing and Management Among Connected Devices,” referred to as Docket No. 22-0606Bp (0404193), filed on Sep. 30, 2022; (vi) U.S. Provisional App. 63/502,347, titled “Area Zones,” referred to as Docket No. 22-1002p, filed on May 15, 2023; and (vii) U.S. Provisional App. 63/513,735, titled “State Information Exchange Among Connected Devices,” referred to as Docket No. 23-0306p, filed on Jul. 14, 2023. The entire contents of Apps. 63/377,948; 63/377,899; 63/377,967; 63/377,978; 63/377,979; 63/502,347; 63/513,735 are incorporated herein by reference.

Aspects of the features and functions disclosed and described in the above-identified applications can be used in combination with the examples disclosed and described herein and with each other in some instances to improve the functionality and performance of playback systems including playback systems having large numbers of playback devices.

### FIELD OF THE DISCLOSURE

The present disclosure is related to consumer goods and, more particularly, to methods, systems, products, features, services, and other elements directed to media playback systems, media playback devices, and aspects thereof.

### BACKGROUND

Options for accessing and listening to digital audio in an out-loud setting were limited until in 2002, when SONOS, Inc. began development of a new type of playback system. Sonos then filed one of its first patent applications in 2003, titled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), individuals can play most any music they like in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a partial cutaway view of an environment having a media playback system configured in accordance with aspects of the disclosed technology.

FIG. 1B shows a schematic diagram of the media playback system of FIG. 1A and one or more networks.

FIG. 1C shows a block diagram of a playback device.

FIG. 1D shows a block diagram of a playback device.

FIG. 1E shows a block diagram of a network microphone device.

FIG. 1F shows a block diagram of a network microphone device.

FIG. 1G shows a block diagram of a playback device.

FIG. 1H shows a partially schematic diagram of a control device.

FIG. 1-I through 1L show schematic diagrams of corresponding media playback system zones.

FIG. 1M shows a schematic diagram of media playback system areas.

FIG. 2A shows a front isometric view of a playback device configured in accordance with aspects of the disclosed technology.

FIG. 2B shows a front isometric view of the playback device of FIG. 3A without a grille.

FIG. 2C shows an exploded view of the playback device of FIG. 2A.

FIG. 3A shows a front view of a network microphone device configured in accordance with aspects of the disclosed technology.

FIG. 3B shows a side isometric view of the network microphone device of FIG. 3A.

FIG. 3C shows an exploded view of the network microphone device of FIGS. 3A and 3B.

FIG. 3D shows an enlarged view of a portion of FIG. 3B.

FIG. 3E shows a block diagram of the network microphone device of FIGS. 3A-3D

FIG. 3F shows a schematic diagram of an example voice input.

FIGS. 4A-4D show schematic diagrams of a control device in various stages of operation in accordance with aspects of the disclosed technology.

FIG. 5 shows front view of a control device.

FIG. 6 shows a message flow diagram of a media playback system.

FIG. 7 shows a multi-tier architecture for a media playback system according to some example configurations.

FIG. 8 shows an method relating to the operation of a multi-tier architecture for media playback systems according to some example configurations.

FIG. 9A shows a media playback system that includes playback devices organized into zones and a group according to some example embodiments.

FIG. 9B shows a media playback system that includes playback devices and Multi-Player Playback Devices organized into Area Zones, groups, and zones according to some example embodiments.

FIG. 10 shows an example Multi-Player Playback Device configurable to implement from one to eight logical players according to some example embodiments.

FIG. 11 shows a method flowchart depicting aspects of storing Area Zone configurations, activating Area Zone configurations, and performing various Area Zone operations according to some example embodiments.

The drawings are for the purpose of illustrating example configurations, but those of ordinary skill in the art will understand that the technology disclosed herein is not limited to the arrangements and/or instrumentality shown in the drawings.

### DETAILED DESCRIPTION

### I. Overview

Existing playback devices, examples of which include Sonos's intelligent playback devices, can be used to implement a decentralized playback system. Some such decentralized playback systems implemented with intelligent playback devices have flexibility in terms of configuration options and ability to play many different types of audio content, thereby enabling many different playback system configurations for many different types of listening environments. However, the technical complexity underpinning such flexibility may be unnecessary (and perhaps even undesirable) in some scenarios, potentially including scenarios when a playback system is scaled to larger and larger system implementations having many tens (or even up to over 100) separate playback devices.

For example, one widely recognized benefit of current existing intelligent playback devices and playback systems is that, in some configurations, each playback device in the playback system exchanges control and/or configuration information with each other playback device in the playback system. Such configurations might be characterized as a flat control plane hierarchy. One beneficial aspect of such an approach might be reliable, robust, and/or redundant exchange of information among devices. In some instances, playback devices within such a playback system that may not be grouped together within a synchrony group or that otherwise do not need to communicate with each other to facilitate groupwise playback of audio content may nevertheless exchange at least some control and/or configuration information with each other because of the flat control plane hierarchy, and/or to otherwise participate in message, content, or other information exchange within the playback system.

This flat, control plane hierarchy where many (or all) playback devices might communicate with each other to forward configuration and control information throughout the playback system has several benefits. For example, when the playback devices exchange configuration and control information with each other, each playback device participating in the information exchange can build and maintain a redundant topological model of the playback system along with computing and networking capabilities of the other playback devices in the playback system. Building and maintaining a topological model of the playback system enables playback devices to respond to playback system configuration changes much more quickly than other systems that lack such a flat, peer-to-peer control plane implementation. Also, exchanging configuration and control information among the playback devices also facilitates certain automatic playback system reconfiguration capabilities. One such automatic reconfiguration capability includes playback devices deciding among themselves whether to transfer group management functionality from one playback device within a synchrony group to another playback device within the synchrony group based operational metrics, such as network characteristics, network performance, processor load, memory, and/or other metrics that may be shared among the playback devices. Another benefit of sharing configuration and control information among the playback devices is that computing systems configured to monitor and/or control aspects of the playback system can obtain configuration and control information relating to the playback system by accessing a single playback device within the playback system.

Although a flat peer-to-peer control plane provides operational benefits in many operating environments, the amount of configuration and control information exchanged between and among the playback devices grows (potentially exponentially) as the number of playback devices in a playback system increases.

For playback systems with a large number of playback devices, the amount of configuration and control information exchanged between the playback devices can start to cause network congestion, especially on networks that are otherwise busy and/or have lower bandwidth capabilities. In addition to the networking complexities, exchanging configuration and control information between all the playback devices also creates additional communications and processing burdens on each individual playback device as the total number of playback devices in the playback system grows. For playback systems having several tens of playback devices, or even up to or over 100 playback devices, exchanging configuration and control information between all the playback devices can sometimes require so much bandwidth and individual processing time as to be unfeasible or at least impractical.

On the other hand, for playback systems with a lot of playback devices, it may not be necessary for every playback device to exchange configuration and control information with every other playback device. For example, in a hotel environment, playback devices in a ballroom on one floor may never need to know anything about playback devices in a different ballroom on a different floor, and thus, such playback devices would have little reason to exchange configuration and control information with each other.

Another widely recognized feature of playback devices such as Sonos's existing intelligent playback devices and playback systems is the ability of playback groups formed from several playback devices to consistently and reliably play audio content together in a groupwise manner with each other, including, e.g., playing audio content together in very tight synchrony with each other. One technical approach to enabling playback groups formed from such playback devices to consistently and reliably play audio content together in a groupwise manner is related to the manner in which an audio sourcing device (such as a group coordinator or similar computing device configured to source audio content) unicasts a data stream comprising audio content and playback timing for the audio content separately to each group member in the playback group. By unicasting a data stream to each group member individually, the group coordinator enables each group member to consistently and reliably receive the data stream. In some instances, unicasting individual data streams may also enable individual group members to request retransmissions of missing or corrupted packets within the data stream from the group coordinator or other playback device sourcing audio content for the playback group.

Although unicasting a separate stream to each group member enables reliable receipt of all the packets in the data stream by each group member, unicasting a separate stream to each group member can become technically challenging for playback groups that include a large number of group members because the volume of data transmitted from the audio sourcing device to each of the group members grows as the total number of group members in the playback group increases. For playback systems, and/or playback groups, having several tens of playback devices, or even up to or over 100 playback devices, unicasting a separate stream from the audio sourcing device to each playback device in the playback system consumes a large amount of network bandwidth and also creates a heavy processing load on the audio sourcing device. Depending on the underlying network infrastructure and the total number of playback devices in the playback system, some networks may lack sufficient bandwidth to support unicasting a separate stream from the audio sourcing device to every individual playback device in the playback system. Similarly, some audio sourcing devices may lack sufficient processing and networking capabilities to support unicasting a separate stream from the audio sourcing device to every individual playback device in the playback system.

Another benefit of some existing intelligent playback devices and playback systems is the ability to exercise individualized control over each playback device in the system via a controller application running on controller device (e.g., a smartphone, tablet, laptop, desktop, or other computing device) that enables a playback system user to see every playback device within a single graphical user interface window. This type of individualized control of playback devices can give users a quick and easy way to view all the playback devices in the playback system along with a great deal of flexibility in configuring individual playback devices to customize the playback system to individual user preferences. However, for very large playback systems with several tens or perhaps over a hundred playback devices, it may be neither desirable nor feasible to display all the playback devices within a single graphical user interface window. Similarly, it may be impractical to try to configure each playback device individually when the playback system includes a very large number of playback devices.

To help ameliorate some of the technical problems that may arise with playback systems having a large number of playback devices, some example configurations herein introduce various combinations of features that enable playback devices to operate in a multi-tier architecture where audio content, playback timing, clock timing, and network configuration and control signaling is generated, distributed, and/or received in some ways that are different than in some existing network configurations.

In some examples, these new combinations of features enable playback devices to operate as any of: (i) an audio sourcing device for the playback system; (ii) a playback system coordinator for the playback system; (iii) a playback system coordinator that also functions as an audio sourcing device for the playback system; (iv) a primary playback device that (a) processes audio for a playback group and (b) controls and/or facilitates control of secondary playback devices in the playback group; and/or (v) a secondary playback device in a playback group in the playback system that (a) plays audio processed by the playback group's primary playback device and (b) exchanges configuration and control messaging with the playback group's primary playback device.

In some example embodiments, playback devices within a playback group are additionally configured to determine which playback device should function as the primary playback device for the playback group, which effectively also determines which playback devices will function as secondary playback devices in the playback group. This ability to self-organize a playback group by selecting a primary playback device is advantageous both when initially setting up a system as well as scenarios where networking, power, and/or other disruptions may cause at least temporary playback group and/or playback system instabilities. In some example configurations, individual playback devices are additionally configured to store their particular playback configuration settings in persistent memory so that the playback device can more quickly resume its operating role in the hierarchical network architecture after a power outage, network outage, or other disruption to playback group and/or playback system operation.

When operating as an audio sourcing device for the playback system, a playback device in some examples is configured to perform features comprising: (i) obtaining audio content from an audio source; (ii) processing the received audio content (as described further herein); (iii) generating system playback timing for the processed audio content; and/or (iv) transmitting or otherwise distributing the processed audio content and the system playback timing for the processed audio content to individual primary playback devices in the playback system.

When operating as a playback system coordinator for the playback system, the playback device in some examples is configured to perform features comprising exchanging control and/or configuration information with individual primary playback devices in the playback system. In some scenarios, the playback system coordinator may additionally provide reference clock timing to individual primary playback devices in the playback system.

When operating as a playback system coordinator that also functions as an audio sourcing device for the playback system, the playback device in some examples is configured to perform features comprising both: (i) the aforementioned playback system coordinator functions (and any other playback system coordinator functions disclosed herein); and (ii) the aforementioned audio sourcing device functions (and any other audio sourcing device functions disclosed herein).

When operating as a primary playback device for a playback group within the playback system, the playback device in some examples is configured to perform features comprising: (i) receiving (or otherwise obtaining) reference clock timing from a reference clock for the playback system, which in some instances may be provided by the playback system coordinator; (ii) after receiving the reference clock timing information from the reference clock, determining a timing offset between a clock time of the primary playback device clock and a clock time of the reference clock; (iii) receiving (or otherwise obtaining) a first series of frames from the playback system coordinator (or perhaps another audio sourcing device), where the first series of frames comprises (a) audio content and (b) system playback timing for the audio content; (iv) for the playback group comprising the primary playback device and one or more secondary playback devices, generating group playback timing for the audio content based on the system playback timing received from the playback system coordinator (or other audio sourcing device) and the timing offset between the clock time of the primary playback device's clock and the clock time of the reference clock (which could be provided by the playback system coordinator); (v) transmitting primary playback device clock timing information from the primary playback device to the one or more secondary playback devices of the playback group; and (vi) transmitting a second series of frames from the primary playback device to the one or more secondary playback devices of the playback group, where the second series of frames comprises the audio content and the group playback timing for the audio content. In some configurations, the primary playback device is additionally configured to play the audio content in synchrony with one or both of (i) the playback system coordinator and/or (ii) the one or more secondary playback devices of the playback group.

When operating as a secondary playback device for a playback group within the playback system, the playback device in some examples is configured to perform functions comprising: (i) receiving (or otherwise obtaining) primary playback device clock timing information from the primary playback device, (ii) after obtaining the primary playback device clock timing from the primary playback device, determining a timing offset between a clock time of the secondary playback device clock and a clock time of the primary playback device; (iii) receiving (or otherwise obtaining) a series of frames from the primary playback device, where the series of frames comprises (a) audio content and (b) group playback timing for the audio content; and (iv) playing the audio content in synchrony with one or more other playback devices of the playback group based on the group playback timing and the secondary playback device clock.

Playback devices that are configurable to operate as any of the aforementioned audio sourcing device, playback system coordinator (including a playback system coordinator that also functions as an audio sourcing device), a primary playback device for a playback group, and/or a secondary playback device in a playback group enable the implementation of playback systems having multi-tier hierarchical network architectures for the distribution of audio content, playback timing, clock timing, and configuration and control information according to example configurations described herein.

In some example hierarchical playback system architectures, an audio sourcing device (which may be a playback system coordinator) streams (via unicast or multicast transmission) audio content and system playback timing to individual primary playback devices in the playback system.

An individual primary playback device that receives the audio content and the system playback timing from the audio sourcing device then uses the audio content and the system playback timing received from the audio sourcing device in some instances to play audio based on the audio content in a groupwise fashion with one or more other playback devices in the playback system. The individual primary playback device additionally uses the system playback timing received from the audio sourcing device to generate new playback timing for the audio content that is specific to the individual primary playback device's playback group. This new playback timing is sometimes referred to herein as group playback timing. The individual primary playback then streams (via unicast or multicast transmission) the audio content (received from the audio sourcing device) and the group playback timing (generated by the primary playback device) to each secondary playback device in the primary playback device's playback group. Some example configurations additionally include the primary playback device (i) providing primary playback device clock timing information to each secondary playback device in the primary playback device's playback group, and/or (ii) exchanging configuration and control messaging with individual secondary playback devices within the primary playback device's playback group.

The hierarchical distribution of audio content and playback timing described herein can be more efficient than traditional approaches of distributing audio content and playback timing, especially in playback networks involving very large number of playback devices.

For example, because the audio sourcing device transmits the audio content and system playback timing to only the primary playback devices (rather than all playback devices in the playback system), the audio sourcing device in some hierarchical network configurations disclosed herein should, in practice, need to transmit less data to the playback devices, particularly in configurations where the audio sourcing device is configured to transmit the audio content and system playback timing to individual primary playback devices via separate unicast transmissions.

Additionally, this type of hierarchical distribution can be more efficient than some prior approaches where the network infrastructure via which an individual primary playback device streams audio content and group playback timing to its corresponding secondary network devices is different than the network infrastructure via which the audio sourcing device streams audio content and playback timing to individual primary playback device, e.g., different channels, different networks, different frequency ranges within the same network, and so on.

This type of hierarchical configuration can be more efficient than typical configurations by additionally or alternatively allowing several primary playback devices within a playback system (rather than the audio sourcing device) to receive and process retransmit requests received from secondary playback devices to avoid overwhelming the audio sourcing device with processing large numbers of retransmit requests from a corresponding large number of secondary playback devices. This may be especially important in configurations where the computing device performing the audio sourcing device function is also performing playback system coordinator functions. Instead, the audio sourcing device needs to process retransmit requests received only from a smaller number of primary playback devices.

This type of hierarchical configuration can provide similar benefits to the exchanging of configuration and control messages within the playback system by allowing the primary playback device to process configuration and control messaging (e.g., volume control, track playback start/stop/pause, exchanging clock timing information, playback device status monitoring and reporting, and so on) to avoid overwhelming the playback system coordinator (which may also be performing audio sourcing device functions, too) with exchanging and processing a larger volume of configuration and control messaging with a corresponding large number of secondary playback devices.

An example of a type of playback grouping that can benefit from some of the technical features of hierarchical network architectures described herein is Area Zones.

However, the technical features are equally applicable to media playback systems that may not implement Area Zone configurations. Similarly, some Area Zone configurations may not necessarily implement all (or any) of the technical features of the hierarchical network architecture described herein.

Some embodiments disclosed herein provide enhanced flexibility and scalability over existing types of grouped configurations via the introduction of several new concepts in addition to the ones described above, examples of which include (i) a new type of grouping referred to herein as an “Area Zone” which implements a new type of hierarchical control plane to streamline signaling between and among playback entities within the Area Zone to support audio distribution to and playback by a relatively large number of playback entities within the Area Zone, (ii) a new type of playback device referred to herein as a Multi-Player Playback Device that includes one or more processors, tangible, non-transitory computer readable media and numerous (such as, in an example, up to eight) configurable audio outputs, where one example of such a new Multi-Player Playback Device is configurable to implement from one to eight logical “players,” and (iii) a new type of logical “player” implemented by a Multi-Player Playback Device. These and other aspects of this new “Area Zone” grouping and these new physical and logical playback entities are described herein.

Given the new concepts described herein, certain terminology is introduced and used for explaining various example features and embodiments. However, it should be understood that such terminology and the use thereof may be uniquely applicable in at least some respects to the examples described herein, such as when describing both existing concepts and new concepts.

For example, to help illustrate aspects of some embodiments, a playback device as used herein sometimes refers to a single, physical hardware device that is configured to play audio. Such a playback device includes one or more network interfaces, one or more processors, and tangible, non-transitory computer-readable media storing program instructions that are executed by the one or more processors to cause the playback device to perform the playback device features and functions described herein.

In some embodiments, a playback device includes integrated speakers. In other embodiments, a playback device includes speaker outputs that connect to external speakers. In still further embodiments, a playback device includes a combination of integrated speakers and speaker outputs that connect to external speakers.

In some instances, a playback device may include a set of headphones. In some instances, a playback device may include a smartphone, tablet computer, laptop/desktop computer, smart television, or other type of device configurable to paly audio content.

In some embodiments, a playback device comprises one or more microphones configured to receive voice commands. In some instances, playback devices with microphones are referred to herein as Networked Microphone Devices (NMDs). In some NMD embodiments, the NMD is configured to perform any (or all) of the playback device functions disclosed herein.

Additional details about playback devices consistent with some example embodiments are disclosed and described herein.

As another example, a logical player as used herein sometimes refers to a logical playback entity implemented by one or more physical playback devices to act as a single entity to play one stream of audio. In some instances where the one stream of audio comprises multichannel audio having two or more channels and the player includes two or more channel outputs, playing the multichannel audio includes the player playing the two or more channels via two or more corresponding channel outputs. In some instances, a single physical playback device implements a single logical player. In other instances, several physical playback devices may be configured to implement a single logical player. In still further instances, one physical playback device (i.e., a Multi-Player Playback Device) may implement several logical players.

Additional details about logical players consistent with some example embodiments are disclosed and described herein.

As another example, a Multi-Player Playback Device as used herein sometimes refers to a type of physical playback device comprising multiple configurable audio outputs, one or more processors, and tangible, non-transitory computer readable media storing program instructions that are executed by the one or more processors to cause the Multi-Player Playback Device to perform the Multi-Player Playback Device features and functions described herein. In scenarios where a playback device might be referred to as a zone player, the Multi-Player Playback Device may sometimes be referred to as a Multi-Zone Player.

In operation, the multiple audio outputs can be grouped together in different combinations to implement one or more logical players. In some embodiments, a single Multi-Player Playback Device is configurable to implement from one to eight logical players. Multi-Player Playback Devices according to some embodiments include eight configurable audio outputs. Multi-Player Playback Devices according to other embodiments include fewer than eight configurable audio outputs or more than eight configurable audio outputs. For example, in some embodiments, a Multi-Player Playback Device may include anywhere from two to six, eight, twelve, sixteen, eighteen, twenty four, or more configurable audio outputs. Multi-Player Playback Devices with more or fewer audio outputs than those specifically identified herein are possible as well.

Additional details about Multi-Player Playback Devices consistent with some example embodiments are disclosed and described herein.

As another example, a playback entity as used herein sometimes refers to a logical or physical entity configured to play audio. Playback entities include physical playback devices, physical Multi-Player Playback Devices, and logical players that are implemented via one or more Multi-Player Playback Devices.

Additional details about playback entities consistent with some example embodiments are disclosed and described herein.

As another example, a zone (sometimes referred to herein as a playback zone or a bonded zone) as used herein sometimes refers to a logical container of one or more physical playback devices that are managed together. But in some instances, and some of the examples described herein, a zone may include only a single, physical playback device.

Thus, in operation, a zone may include any one or more playback devices managed as a logical zone entity, including, for example, (i) a single playback device managed as a logical zone entity, (ii) a group of playback devices managed as a logical zone entity, including but not limited to any of (a) a bonded zone that includes two or more playback devices configured to play the same audio, (b) a bonded pair of two playback devices configured to play the same audio, (c) a stereo pair of two playback devices where one of the playback devices is configured to play a left channel of stereo audio content and the other playback device is configured to play a right channel of stereo audio content, or (d) a home theater zone that includes two or more playback devices configured to play home theater and/or surround sound audio content.

In this manner, in some examples, a zone is a type of logical entity implemented by one or more playback devices. When the zone includes two or more playback devices, the two or more playback devices play one stream of audio content. In some instances, the one stream of audio content played by the zone comprises multichannel audio. In some zone scenarios that include two or more playback devices where the one stream of audio content comprises multichannel audio, each playback device (of the two or more physical playback devices) may be configured to play a different channel of the multichannel audio content.

For example, a first physical playback device in the zone may be configured to play a left channel of the audio content and a second physical playback device in the zone may be configured to play a right channel of the audio content. This type of example zone configuration is sometimes referred to as a stereo pair.

In another example, a first playback device in the zone may play a left channel, a second playback device in the zone may play a right channel, and a third playback device in the zone may play a subwoofer channel. This type of example zone configuration is sometimes referred to as a home theater zone.

In some existing zone configurations, each of the individual playback devices within the zone communicate with each other in a fully-connected control plane configuration to exchange commands, configuration information, events, and state information to each other via dedicated websocket connections between each pair of playback devices within the zone.

Additional details about zones consistent with some example embodiments are disclosed and described herein.

A playback group (sometimes referred to herein simply as a group) is a logical container of two or more logical or physical playback entities. Logical and physical entities that can grouped into a playback group include: (i) a zone, (ii) a playback device, (iii) a Multi-Player Playback Device, and/or (iii) a logical player.

A playback group differs from a zone in a few ways. First, a zone includes one or more playback devices, whereas a playback group includes two or more logical or physical playback entities (i.e., zones, playback devices, Multi-Player Playback Device, or players).

Second, when one or more playback devices are configured into a zone, the playback system treats the zone as a single logical entity even though the zone may include several physical playback devices. By contrast, when two or more playback devices are configured into a group, the playback system manages each playback device separately even though each of the playback entities within the playback group are playing the same audio stream.

Similar to playback devices configured into a zone, all of the playback entities within a playback group are configured to play the same audio stream. In some instances, the audio stream comprises multichannel audio. In some scenarios where the audio stream comprises multichannel audio, each zone, playback device, Multi-Player Playback Device, or player in the playback group is configured to play the same set of audio channels. In some example playback group implementations, the playback group includes a group coordinator and one or more group members. The group coordinator sources audio for the playback group and manages certain configuration and control functions for the group member(s) in the playback group. However, other playback group implementations may distribute audio among the group and handle configuration and control functions differently.

Similar to a zone configuration (described above), and in contrast to an Area Zone configuration (described further herein), each of the individual playback devices within a playback group communicate with each other in a fully-connected configuration to exchange commands, configuration information, events, and state information with each other via dedicated websocket connections (or similar communication links/sessions) between each of the playback devices within the playback group. For example, a playback group with four playback devices in some playback group configurations would include six dedicated websocket connections (or similar communication links/sessions) for a fully-connected mesh between all four playback devices, e.g., dedicated connections between (i) playback device 1 and playback 2, (ii) playback device 1 and playback device 3, (iii) playback device 1 and playback device 4, (iv) playback device 2 and playback device 3, (v) playback device 2 and playback device 4, and (v) playback device 3 and playback device 4.

Additional details about playback groups consistent with some example embodiments are disclosed and described herein.

### A. Area Zone

As mentioned above, an Area Zone is a new type of playback grouping. An Area Zone includes a set of two or more logical or physical playback entities grouped together.

The playback entities that can be grouped together into an area zone include: (i) a zone, (ii) a playback device, (iii) a Multi-Player Playback Device, (iv) a logical player, and/or (iv) a playback group.

Similar to some zone and a playback group configurations (described above), all of the playback entities within an Area Zone are configured to play one audio stream. In some instances, the one audio stream comprises a multichannel audio stream. In some embodiments described herein, an Area Zone includes an Area Zone Primary and one or more Area Zone Secondaries, each of which is described further herein.

In some embodiments, and similar to some zone configurations (described above), the playback system manages all of the playback entities within an Area Zone as a single logical playback entity. And similar to some playback group configurations (described above), in some embodiments, the individual playback entities can be managed and configured independently of each other.

One difference between some zone implementations (described above) on the one hand, and an Area Zone on the other, is that in some existing systems, prior zone configurations cannot be saved, and then activated or deactivated during operation of the playback system. With some prior zone implementations, the zone is configured typically when the playback devices forming the zone are added to the playback system. In contrast to those prior zone implementations, with some Area Zone embodiments, an individual playback entity can save several different Area Zone configurations and switch between operating in each of the different saved Area Zone configurations, as described further herein.

Another difference between zones and playback groups (described above) on the one hand, and an Area Zone on the other, is that unlike prior zone and playback group configurations, the playback entities within an Area Zone do not all communicate with each other in a fully-connected control plane configuration to exchange commands, configuration information, events, and state information with each other. In some examples, this fully-connected control plane is implemented via dedicated websocket connections between each pair of playback entities within the Area Zone.

Instead, the Area Zone Primary communicates with each Area Zone Secondary (and each Area Zone Secondary communicates with the Area Zone Primary) to exchange commands, configuration information, events, and state information in a hierarchical control plane. In contrast to how group members within a playback group maintain a fully-connected mesh between each other (e.g., via dedicated websocket connections in some instances) to facilitate communication between the different group members, in normal operation, the Area Zone Secondaries within the same Area Zone typically do not communicate with each other, and Area Zone Secondaries typically do not communicate with any other playback entity in a playback system other than their corresponding Area Zone Primary. Instead, the Area Zone Secondaries communicate with the Area Zone Primary which can, in turn, facilitate any exchange of commands, configuration information, events, or state information that may need to occur between two Area Zone Secondaries.

Additional details about area zones consistent with some example embodiments are disclosed and described herein

B. Area Zone Primary An Area Zone Primary is a player (or perhaps a playback device or Multi-Player Playback Device) that is configured to handle audio sourcing and control signaling on behalf of itself and all of the Area Zone Secondaries within an Area Zone. In some embodiments, the Area Zone Primary may also perform one or more (or all) functions of a Global State Aggregator as described in U.S. Provisional App. 63/513,735, titled “Global State Service,” referred to as Docket No. 23-0306p, filed on Jul. 14, 2023.

For media, in some implementations, the Area Zone Primary is configured to function as an audio sourcing device for itself and all of the Area Zone Secondaries within the Area Zone.

For control signaling, in some implementations, the Area Zone Primary communicates with each Area Zone Secondary to exchange commands, configuration information, events, and state information to implement playback, configuration, and control functions (e.g., volume, mute, playback start/stop, queue management, configuration management and updates) for the Area Zone.

In addition to exchanging commands, configuration information, events, and state information with each Area Zone Secondary within the Area Zone, each Area Zone Primary in some implementations is also configured to exchange commands, configuration information, events, and state information with (i) each (and every) other Area Zone Primary in the playback system and (ii) any controller device(s) or system(s) configured for controlling operation of the playback system. However, rather than exchanging commands, configuration information, events, and state information with each (and every) other Area Zone Primary in the playback system, in some embodiments each Area Zone Primary in some implementations is configured to exchange commands, configuration information, events, and state information with one or more Brokers (not every other Area Zone Primary) in the playback system. The use of Brokers in this an other manners is described in more detail in U.S. Provisional App. 63/513,735, titled “Global State Service,” referred to as Docket No. 23-0306p, filed on Jul. 14, 2023.

One example scenario that illustrates how an Area Zone Primary exchanges commands, configuration information, events, and state information with Area Zone Secondaries and/or controller device(s) and/or controller system(s) is where, after a playback entity configured as the Area Zone Primary receives a request for configuration or operational information about one or more playback entities within the Area Zone from a requesting device (e.g., a controller device, a controller system, or perhaps another playback entity in the playback system), the playback entity configured as the Area Zone Primary provides the requested information to the requesting device on behalf of the Area Zone.

For example, in response to a request for a listing of playback entities in the Area Zone received from a requesting device, the Area Zone Primary transmits a listing of playback entities within the Area Zone to the requesting device. In another example, in response to a request for configuration information about a particular Area Zone Secondary received from a requesting device, and to the extent that the Area Zone Primary does not already have the requested configuration information for the particular Area Zone Secondary, the Area Zone Primary obtains the requested configuration information from the Area Zone Secondary. And regardless of whether the Area Zone Primary already had the configuration information for the particular Area Zone Secondary or acquired the requested configuration information from the particular Area Zone Secondary, the Area Zone Primary provides the requested configuration information for the particular areas on secondary to the requesting device.

Additional details about area zone primaries consistent with some example embodiments are disclosed and described herein.

### C. Area Zone Secondary

An Area Zone Secondary is a logical or physical entity in the Area Zone that is not the Area Zone Primary for the Area Zone. In operation, each Area Zone Secondary within an Area Zone is configured to communicate with the Area Zone Primary to exchange commands, configuration information, events, and state information to implement playback, configuration, and control functions (e.g., volume, mute, playback start/stop, queue management, configuration management and updates) for the Area Zone.

As mentioned earlier, in normal operation, an Area Zone Secondary typically does not communicate with any other Area Zone Secondary within the Area Zone or any other playback entity within a playback system. However, an Area Zone Secondary in some instances may receive commands and/or inquiries from a controller device, and in some instances can establish a communication session with another Area Zone Secondary to exchange data in some circumstances described herein.

One example scenario that illustrates how an Area Zone Secondary exchanges commands, configuration information, events, and state information with its Area Zone Primary is where, after a playback entity configured as an Area Zone Secondary receives a request for configuration or operational information about one or more playback entities within the Area Zone from a requesting device (e.g., a controller device, a controller system, or perhaps another playback entity in the playback system), the playback entity configured as the Area Zone Secondary forwards the received request to the Area Zone Primary. In some instances, the Area Zone Primary responds to the requesting device to provide the requested information.

For example, in response to a request for a listing of playback entities in the Area Zone received from a requesting device, the Area Zone Secondary forwards the request to the Area Zone Primary, and the Area Zone Primary transmits a listing of playback entities within the Area Zone to the requesting device. In another example, in response to a request for configuration information about a particular Area Zone Secondary received from a requesting device (including a request about itself), the Area Zone Secondary forwards the request to the Area Zone Primary, and the Area Zone Primary provides the requested information to the requesting device.

Additional details about area zone secondaries consistent with some example embodiments are disclosed and described herein.

### D. Controller Devices

A controller device (sometimes referred to herein as a controller or a control device) is a computing device or computing system with one or more processors and tangible, non-transitory computer readable media storing program instructions executable by the one or more processors to execute the controller device features and functions described herein. In some scenarios, a controller device is a smartphone, tablet computer, laptop computer, desktop computer, smartwatch, or similar computing device configured to execute a software user interface for configuring and controlling playback entities within a playback system. In some scenarios, a controller device may include one or more cloud server systems configured to communicate with one or more playback entities to configure and control the playback system.

In operation, user inputs associated with commands for configuring and controlling playback entities within a playback system can take a variety of forms, including but not limited to (i) physical inputs (e.g., actuating physical controls like knobs, sliders, buttons and so forth) (ii) software user interface inputs (e.g., inputs on a touch screen or similar graphical user interface), (iii) voice inputs, (iv) inputs received from another playback entity in the playback system (e.g., in the form of signaling from the playback entity to the controller in connection with effectuating configuration and control commands) and/or (v) any other type of input in any other form now known or later developed that is sufficient for conveying commands for configuring and controlling playback entities.

Additional details about area controller devices consistent with some example embodiments are disclosed and described herein

### E. Hierarchical Control Plane for Command and Control Signaling

As mentioned above, one aspect of the Area Zone embodiments disclosed herein is a hierarchical control plane.

Exchanging command and control information via control plane implementations disclosed herein differs from prior command and control distribution schemes such as the ones disclosed in U.S. application Ser. No. 13/489,674, titled “Device Playback Failure Recovery and Redistribution,” filed on Jun. 6, 2012, and issued on Dec. 2, 2014, as U.S. Pat. No. 8,903,526, the entire contents of which are incorporated herein by reference. The '674 application describes a command and control distribution scheme where a confirmed communication list (CCL) is be generated to facilitate communication between playback devices within a playback system. In one example, the CCL is a list of all playback devices in a zone configuration, where the CCL is ordered according to an optimal routing using the least number of hops or transition points through the network between the playback devices. In another case, the CCL is generated without consideration of network routing metrics. In either case, command and control data is passed from playback device to playback device within the zone configuration following the order in the CCL in a linear or serial manner. In one example, a first playback device sends a command to a second playback device in the CCL, and the second playback device in the CCL sends the command to a third playback device in the CCL, and so on until the command reaches its destination (i.e., a playback device in the CCL). For commands to be processed by all playback devices in the zone configuration, the commands are routed from playback device to playback device in the order specified in the CCL until every playback device in the CCL has received the commands. This arrangement is simple to execute, provides reliable transmission of information from playback device to playback device, and tends to work quite well for zones with a few playback devices.

However, for Area Zones as well as other configurations with a lot of playback entities, the CCL-based approach can become impractical because it can take too long to distribute commands to a large number of playback entities or even to send a command to a single playback entity since every command is routed through the group on a serial, hop-by-hop basis according the CCL.

In contrast to the above-described CCL approach and flat control plane implementations where many (or all) playback entities within a playback system communicate directly with each other to exchange configuration and control information throughout the playback system, some Area Zone embodiments disclosed herein employ a hierarchical control plane where commands, configuration information, events, and state information are exchanged only between the Area Zone Primary and each Area Zone Secondary within the Area Zone. For playback systems that may include several Area Zones, the Area Zone Primaries may exchange commands, configuration information, events, and state information with each other.

In the Area Zone embodiments disclosed herein, and in contrast to flat, fully-meshed control plane implementations, the Area Zone Secondaries typically do not exchange commands, configuration information, events, and state information to each other via dedicated websocket connections (or similar communications links or sessions) with each other, except perhaps in a few rare instances described herein.

In some scenarios, any commands, configuration information, events, and state information to be sent from a first Area Zone Secondary to a second Area Zone Secondary are sent from the first Area Zone Secondary to the Area Zone Primary. The Area Zone Primary then, in turn, (i) processes the command(s), configuration information, event(s), and/or state information received from the first Area Zone Secondary and instructs and/or updates the second Area Zone Secondary accordingly, or (ii) forwards the command(s), configuration information, event(s), and/or state information to the second Area Zone Secondary, as necessary.

Some Area Zone embodiments additionally or alternatively employ a Configuration and Command (C&C) group (e.g., a multicast group) for distributing commands, configuration information, events, and state information to playback entities within the Area Zone.

In some instances, the Area Zone Primary creates the C&C group for the Area Zone (or joins the C&C group as a publisher), and provides information required to join and/or subscribe to the C&C group to each Area Zone Secondary. The Area Zone Secondaries join and/or subscribe to the C&C group to receive control information. In such embodiments, the Area Zone Primary publishes commands, configuration information, events, and state information to the C&C group, and each Area Zone Secondary subscribed to the C&C group receives the commands, configuration information, events, and state information that the Area Zone Primary publishes to the C&C group. In some embodiments, Area Zone Secondaries may also publish certain command, configuration, event, and state information to the Area Zone C&C group. In operation, each when an Area Zone Secondary receives a command via the C&C group that requires some action on behalf of the Area Zone Secondary, the Area Zone Secondary executes the received command.

Additional details about hierarchical control plane features and functionality for area zone configurations consistent with some example embodiments are disclosed and described herein.

### F. Media and Timing Distribution

Another aspect of some Area Zone embodiments disclosed herein is how audio content and playback timing are distributed to individual playback entities within the Area Zone. In some existing zone or playback group configurations, the playback device designated as the audio sourcing device is configured to transmit audio content and playback timing for the audio content to each other playback device in the zone or playback group via unicast transmissions from the audio sourcing device to each other playback device in the zone or playback group.

However, in some Area Zone embodiments disclosed herein, the Area Zone Primary is configured to transmit audio content and playback timing for the audio content to a media distribution group (e.g., a multicast group), and Area Zone Secondaries subscribe to the media group to receive the audio content and playback timing, e.g., each Area Zone Secondary joins the media multicast group and receives audio content and playback timing via the media multicast group.

Some embodiments employ a hybrid unicast/multicast approach where the Area Zone Primary is configured to (i) distribute audio content and playback timing via unicast transmissions to Area Zone Secondaries that are wirelessly connected to the playback system, e.g., via Wifi, Bluetooth, or other suitable wireless connection, and (ii) distribute audio content and playback timing via multicast transmissions to Area Zone Secondaries that are connected to the playback system via wired connections, e.g., Ethernet, Power over Ethernet (PoE), Universal Serial Bus (USB), or other suitable wired connection.

Some Area Zone embodiments employ a Media and Timing (M&T) group (e.g., a multicast group) for distributing audio content and playback timing to playback entities within the Area Zone. In some Area Zone embodiments, clock timing is also distributed to the playback entities within the Area Zone via the M&T group. In some instances, the Area Zone Primary creates the M&T group for the Area Zone (or joins the M&T group as a publisher), and provides information required to join and/or subscribe to the M&T group to each Area Zone Secondary. The Area Zone Secondaries join and/or subscribe to the M&T group to receive audio content, playback timing, and in some instances, clock timing. In such embodiments, the Area Zone Primary publishes the audio content, playback timing, and clock timing to the M&T group, and each Area Zone Secondary subscribed to the M&T group receives the audio content, playback timing, and clock timing that the Area Zone Primary publishes to the M&T group.

Additional details about media and timing data for area zone configurations and other hierarchical media network configurations consistent with some example embodiments are disclosed and described herein.

### G. Storing and Recalling Area Zone Configuration Information

Another aspect of some Area Zone embodiments disclosed herein includes the Area Zone configuration data and how the Area Zone configuration data is stored and recalled to activate an Area Zone configuration.

In contrast to some prior playback group configurations and zone configurations where every playback device maintains an up-to-date version of the group/zone configuration data, Area Zone configurations according to some embodiments include storing the Area Zone configuration information in a single Area Zone configuration package. In some instances, the Area Zone configuration package includes separate Area Zone configuration files for each playback entity in the Area Zone. In some instances, the area zone configuration package is stored at one or more of (i) the Area Zone Primary, (ii) a controller device, and/or (iii) a cloud server system.

The Area Zone configuration information in some embodiments includes information about the Area Zone configuration, including but not limited to one or more (or all) of (i) a name that identifies the Area Zone, (ii) the name of the playback entity that is to function as the Area Zone Primary once the Area Zone is activated, (iii) the name of each playback entity in the Area Zone (i.e., the name of each playback device, Multi-Player Playback Device, player, zone, and playback group in the Area Zone, as applicable), (iv) for Area Zones configured to play multichannel audio, a channel map that defines the channel or channels that each playback entity is configured to play once the Area Zone has been activated, including at least in some instances, which channel each output port of each playback entity is configured to play while the Area Zone is active, and (v) for individual playback entities, one or more configuration setting(s) that define certain Area Zone specific behavior of the playback entity while the Area Zone is active.

Examples of Area Zone specific behavior while the Area Zone is active include: (i) behavior of the playback entity in response to receiving a volume control command, a playback control command (e.g., play/pause/skip/etc.), and/or other user command via a physical interface on (or associated with) the playback entity, and (ii) behavior of the playback entity in response to receiving a voice command via an associated microphone.

Additional details about storing and recalling area zone configuration consistent with some example embodiments information are disclosed and described herein.

### H. Related Art

The above-described example configurations as well as additional and alternative example configurations are described in more detail herein. Aspects of the features and functions implemented in the example configurations disclosed herein differ from known implementations in several ways.

For example, with respect to streaming audio content and playback timing to individual playback devices, U.S. application Ser. No. 10/816,217, titled “System And Method For Synchronizing Operations Among A Plurality Of Independently Clocked Digital Data Processing Devices,” filed on Apr. 1, 2004, and issued on Jul. 31, 2012, as U.S. Pat. No. 8,234,395, describes, inter alia, independently-clocked playback devices that are configured to play audio content in synchrony with each other based on playback timing and clock timing information. However, U.S. application Ser. No. 10/816,217 does not describe aspects of the multi-tier hierarchical network architecture disclosed herein, including the hierarchical distribution of audio content, playback timing, clock timing, and/or configuration and control signaling in the manners described herein. Nor does it describe Area Zone configurations, Multi-Player Playback Devices, or player implementations and/or the features related thereto described herein. The entire contents of U.S. application Ser. No. 10/816,217 are incorporated herein by reference.

Similarly, with respect to groupwise control of groups of playback devices within a playback system, U.S. application Ser. No. 10/861,653, titled “Method And Apparatus For Controlling Multimedia Players In A Multi-Zone System,” filed on Jun. 5, 2004, and issued on Aug. 4, 2009, as U.S. Pat. No. 7,571,014, describes, inter alia, groupwise control of multiple playback devices, including groupwise volume control of playback devices configured within a group of playback devices configured to play audio content in synchrony with each other, sometimes referred to as a synchrony group. However, U.S. application Ser. No. 10/861,653 does not describe a multi-tier hierarchical network architecture having the features and characteristics disclosed herein, including the hierarchical distribution of audio content, playback timing, clock timing, and/or configuration and control signaling in the manners described herein.

Nor does it describe Area Zone configurations, Multi-Player Playback Devices, or player implementations and/or the features related thereto described herein. The entire contents of U.S. application Ser. No. 10/861,653 are incorporated herein by reference.

Other aspects of groupwise control of groups of playback devices are described in U.S. application Ser. No. 13/910,608, titled “Satellite Volume Control,” filed on Jun. 5, 2013, and issued on Sep. 6, 2016, as U.S. Pat. No. 9,438,193. For example, U.S. application Ser. No. 13/910,608 discloses, inter alia, controlling playback volume of grouped playback devices, including propagating a volume adjustment received via a first playback device to other playback devices that have been grouped with the first playback device. However, U.S. application Ser. No. 13/910,608 does not describe does not describe a multi-tier hierarchical network architecture having the features and characteristics disclosed herein, including the hierarchical distribution of audio content, playback timing, clock timing, and/or configuration and control signaling in the manners described herein. Nor does it describe the Area Zone configurations, Multi-Player Playback Devices, or player implementations and/or the features related thereto described herein, including but not limited to the configurable volume control features in some Area Zone embodiments.

Further, several earlier-filed applications describe aspects of specialized groupings of playback devices within a playback system. For example, U.S. application Ser. No. 13/013,740, titled “Controlling and grouping in a multi-zone media system,” filed on Jan. 25, 2011, and issued on Dec. 1, 2015, as U.S. Pat. No. 9,202,509, describes, inter alia, configuring and operating two playback devices in a “paired” configuration such as a “stereo pair” configuration, where one playback device is configured to play a right stereo channel of audio content and the other playback device is configured to play a left stereo channel of audio content. Similarly, U.S. application Ser. No. 13/083,499, titled “Multi-Channel Pairing In A Media System,” filed on Apr. 8, 2011, and issued on Jul. 22, 2014, as U.S. Pat. No. 8,788,080, describes, inter alia, configuring and operating multiple playback devices in a consolidated mode, where two or more playback devices can be grouped into a consolidated playback device which can then be further grouped with one or more other playback devices and/or one or more other consolidated playback devices. Further, U.S. application Ser. No. 13/632,731, titled, “Providing A Multi-Channel And A Multi-Zone Audio Environment,” filed on Oct. 1, 2012, and issued on Dec. 6, 2016, as U.S. U.S. Pat. No. 9,516,440, describes, inter alia, configuring playback devices to play different types of audio content (e.g., home theater audio vs. music) according to different playback timing arrangements (e.g., with low-latency vs. with ordinary latency).

However, U.S. application Ser. No. 13/013,740; Ser. No. 13/083,499; and Ser. No. 13/632,731 do not describe a multi-tier hierarchical network architecture having the features and characteristics disclosed herein, including the hierarchical distribution of audio content, playback timing, clock timing, and/or configuration and control signaling in the manners described herein. Nor do they describe the Area Zone configurations, Multi-Player Playback Devices, or player implementations and/or the features related thereto described herein, including but not limited to the configurable volume control features in some Area Zone embodiments. The entire contents of U.S. application Ser. No. 13/013,740; Ser. No. 13/083,499; and Ser. No. 13/632,731 are incorporated herein by reference.

Additionally, several other advancements over time have improved the overall functionality and usability of playback devices configured in groups for synchronous playback of audio content.

For example, with respect to persistent configuration capabilities, U.S. application Ser. No. 13/489,674, titled, “Device Playback Failure Recovery and Redistribution,” filed on Jun. 6, 2012, and issued on Dec. 2, 2014, as U.S. Pat. No. 8,903,526, discloses, inter alia, persistent storage of playback device settings, including group membership and playback responsibility, so that playback devices are able to automatically reconfigure themselves as part of a playback network after temporarily losing connectivity or playback device restarts.

And with respect to managing groups of playback devices configured for groupwise playback of audio content, U.S. application Ser. No. 14/042,001, titled “Coordinator Device for Paired or Consolidated Players,” filed on Dep. 30, 2013, and issued on Mar. 15, 2016, as U.S. Pat. No. 9,288,596, and U.S. application Ser. No. 14/041,989, titled “Group Coordinator Device Selection,” filed on Sep. 30, 2013, and issued on May 16, 2017, as U.S. Pat. No. 9,654,545 disclose, inter alia, certain techniques whereby individual playback devices configured to operate in a groupwise manner decide which playback device should function as a group coordinator for the group of playback devices.

U.S. application Ser. No. 14/988,524, titled, “Multiple-Device Setup,” filed Jan. 5, 2016, and issued May 28, 2019, as U.S. Pat. No. 10,303,422, discloses, inter alia, techniques for adding several new playback devices to a playback system at the same time, including, in scenarios when two or more of the same type of playback devices are detected during setup, causing one of the two or more playback devices to emit a sound that enables a user to identify the one playback device in connection with playback system configuration and setup.

U.S. application Ser. No. 16/119,516, titled, “Media Playback System with Virtual Line-In,” filed on Aug. 31, 2018, and issued as on Oct. 22, 2019, as U.S. Pat. No. 10,452,345, and U.S. application Ser. No. 16/119,642, titled, “Interoperability Of Native Media Playback System With Virtual Line-In,” filed on Aug. 31, 2018, and issued on May 12, 2020, as U.S. Pat. No. 10,649,718, (both of which claim priority to U.S. Prov. App. 62/672,020, titled “Media Playback System with Virtual Line-In,” filed on May 15, 2018, and now expired) describe, inter alia, scenarios where one playback device in one playback system coordinates aspects of playback and control of another playback device in a different playback system in connection with facilitating interoperability between to two different playback systems.

U.S. application Ser. No. 16/415,783, titled, “Wireless Multi-Channel Headphone Systems and Methods,” filed on May 17, 2019, and issued on Nov. 16, 2021, as U.S. Pat. No. 11,178,504, describes, inter alia, a surround sound controller and one or more wireless headphones that switch between operating in various modes that have different latency characteristics. For example, in a first mode, the surround sound controller uses a first Modulation and Coding Scheme (MCS) to transmit first surround sound audio information to a first pair of headphones, and in a second mode, the surround sound controller uses a second MCS to transmit (a) the first surround sound audio information to the first pair of headphones and (b) second surround sound audio information to a second pair of headphones.

However, U.S. application Ser. No. 13/489,674; Ser. No. 14/042,001; Ser. No. 14/041,989; Ser. No. 14/988,524; Ser. No. 16/119,516; Ser. No. 16/119,642; 62/672,020; and Ser. No. 16/415,783 do not describe a multi-tier hierarchical network architecture having the features and characteristics disclosed herein, including the hierarchical distribution of audio content, playback timing, clock timing, and/or configuration and control signaling in the manners described herein. Nor do they disclose playback devices that are configured to perform the specific functions of the primary and secondary playback devices that enable the features corresponding to technical benefits of the disclosed multi-tier hierarchical network architecture examples. They also do not describe the Area Zone configurations, Multi-Player Playback Devices, or player implementations and/or the features related thereto described herein, including but not limited to the configurable volume control features in some Area Zone embodiments. The entire contents of U.S. application Ser. No. 13/489,674; Ser. No. 14/042,001; Ser. No. 14/041,989; Ser. No. 14/988,524; Ser. No. 16/119,516; Ser. No. 16/119,642; 62/672,020; and Ser. No. 16/415,783 are incorporated herein by reference.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

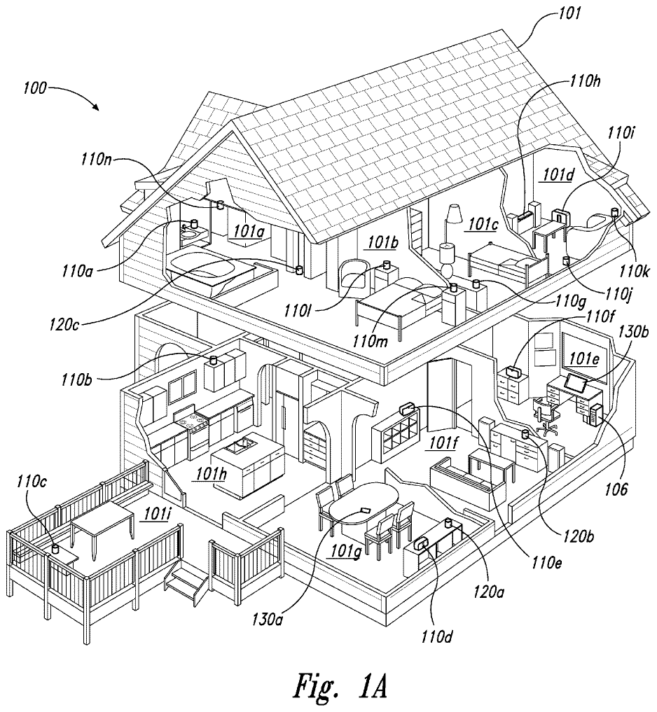

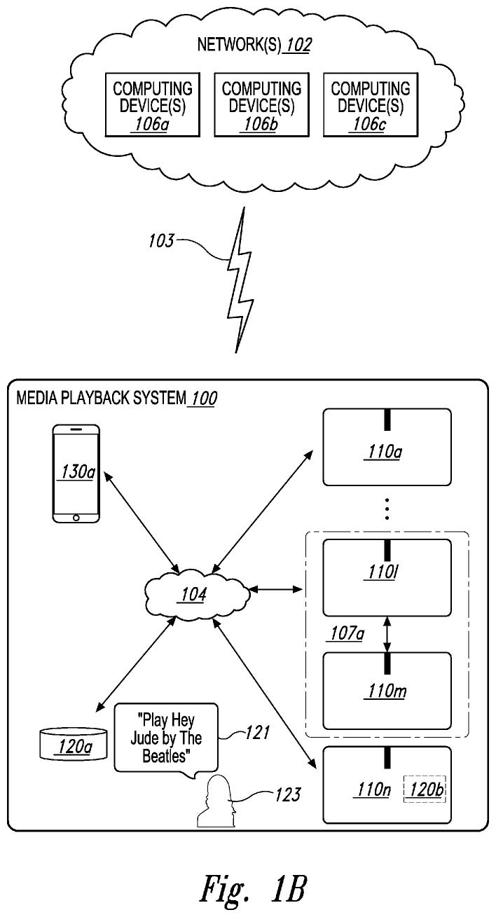

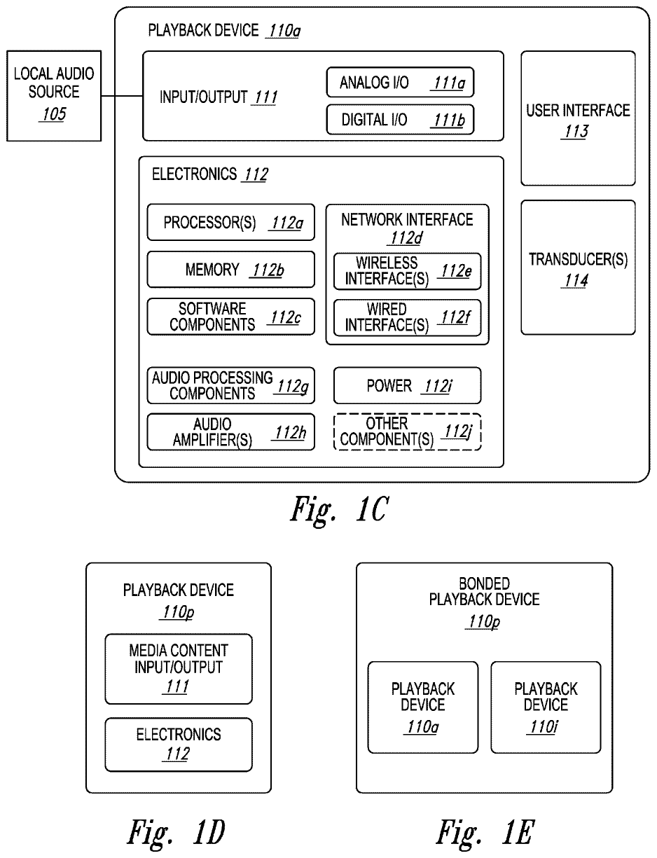

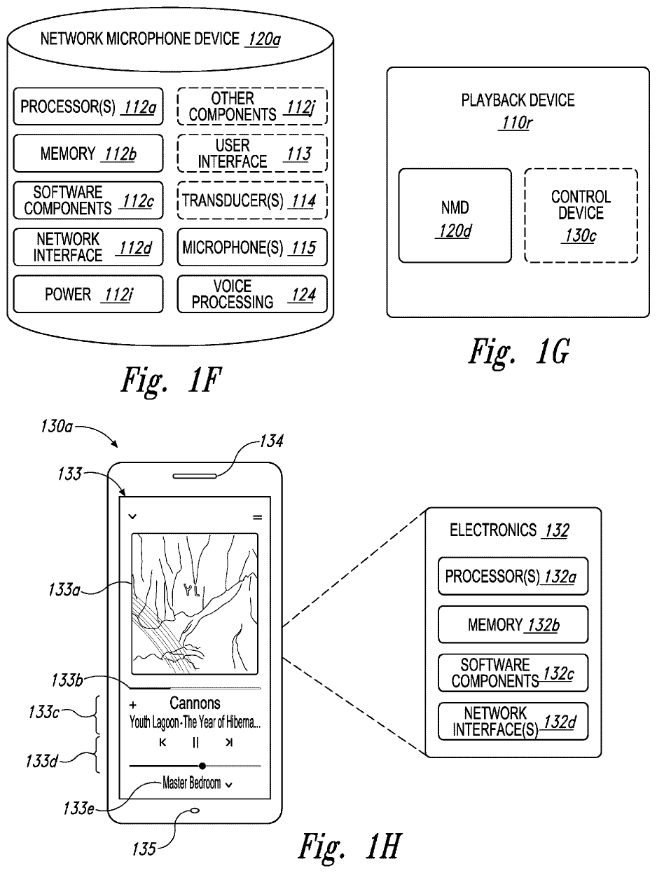

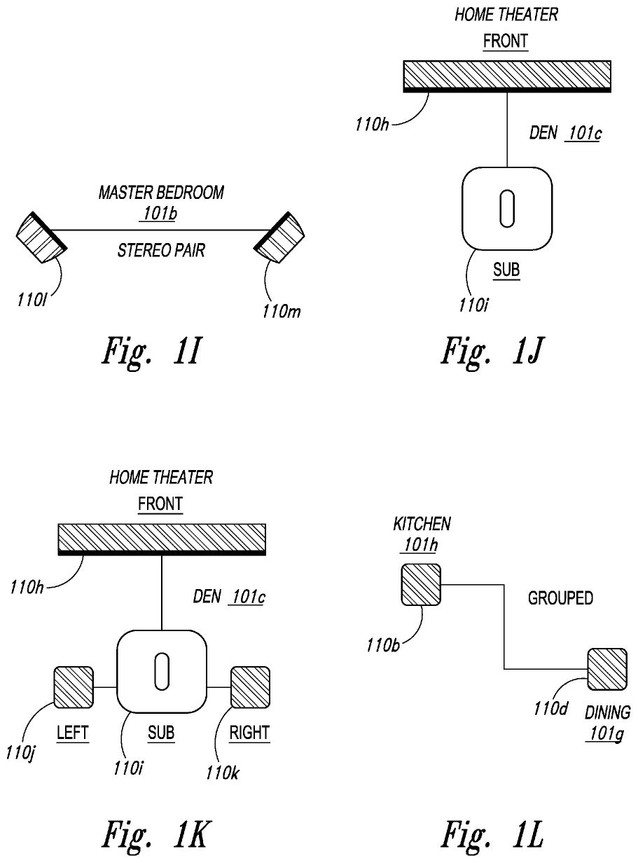

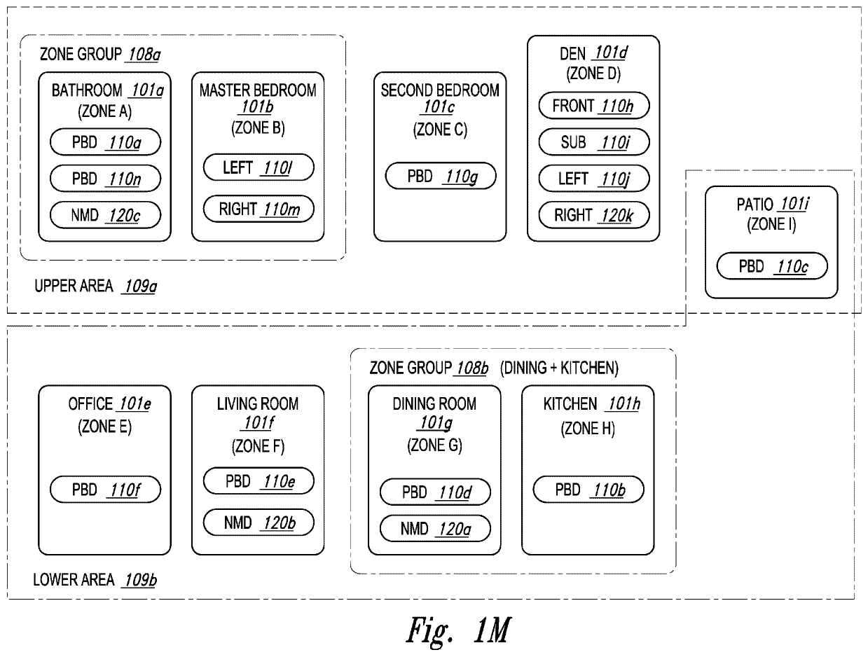

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular example configurations of the disclosed technology.

Accordingly, other example configurations can have other details, dimensions, angles and features without departing from the spirit or scope of the disclosure. In addition, those of ordinary skill in the art will appreciate that further example configurations of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices (“NMDs”), 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some example configurations, a playback device includes one or more transducers or speakers powered by one or more amplifiers. In other example configurations, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some example configurations, an NMD is a stand-alone device configured primarily for audio detection. In other example configurations, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain example configurations, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some example configurations, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various example configurations of the disclosure are described in greater detail below with respect to FIGS. 1B-1L.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain example configurations and examples are described below in the context of a home environment, the technologies described herein may be implemented in other types of environments. In some example configurations, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

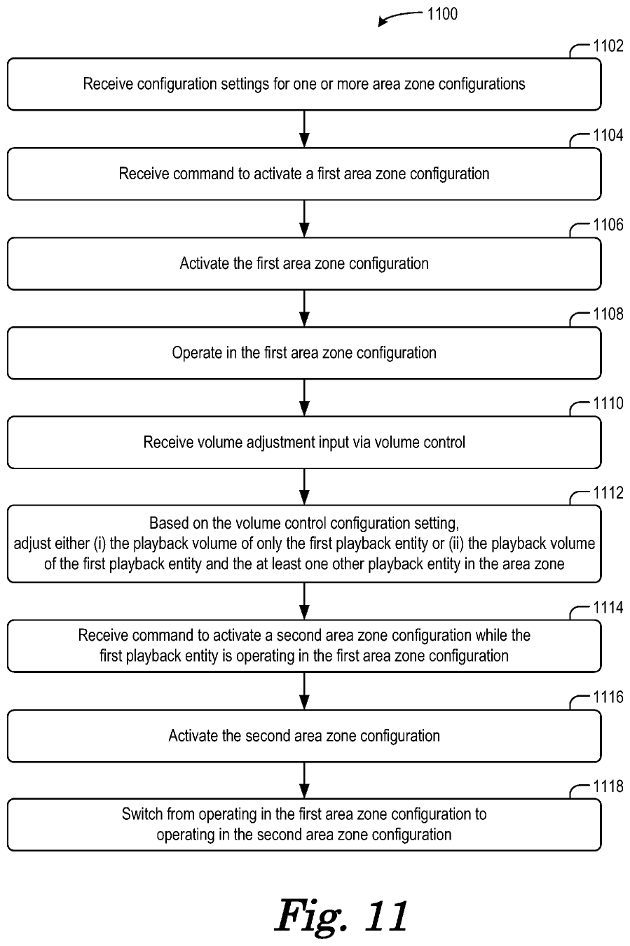

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 1101 and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to, for example, FIGS. 1B and 1E and 11-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### A. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communications links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some example configurations, the cloud network 102 is further configured to receive data (e.g. voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some example configurations, one or more of the computing devices 106 comprise modules of a single computer or server. In certain example configurations, one or more of the computing devices 106 comprise one or more modules, computers, and/or servers. Moreover, while the cloud network 102 is described above in the context of a single cloud network, in some example configurations the cloud network 102 comprises a plurality of cloud networks comprising communicatively coupled computing devices. Furthermore, while the cloud network 102 is shown in FIG. 1B as having three of the computing devices 106, in some example configurations, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some example configurations, the network 104 comprises a dedicated communication network that the media playback system 100 uses to transmit messages between individual devices and/or to transmit media content to and from media content sources (e.g., one or more of the computing devices 106). In certain example configurations, the network 104 is configured to be accessible only to devices in the media playback system 100, thereby reducing interference and competition with other household devices. In other example configurations, however, the network 104 comprises an existing household communication network (e.g., a household WiFi network). In some example configurations, the links 103 and the network 104 comprise one or more of the same networks. In some aspects, for example, the links 103 and the network 104 comprise a telecommunication network (e.g., an LTE network, a 5G network). Moreover, in some example configurations, the media playback system 100 is implemented without the network 104, and devices comprising the media playback system 100 can communicate with each other, for example, via one or more direct connections, PANs, telecommunication networks, and/or other suitable communications links.

In some example configurations, audio content sources may be regularly added or removed from the media playback system 100. In some example configurations, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some example configurations, for example, the media content database is stored on one or more of the playback devices 110, network microphone devices 120, and/or control devices 130.

In the illustrated embodiment of FIG. 1B, the playback devices 1101 and 110m comprise a group 107a. The playback devices 1101 and 110m can be positioned in different rooms in a household and be grouped together in the group 107a on a temporary or permanent basis based on user input received at the control device 130a and/or another control device 130 in the media playback system 100. When arranged in the group 107a, the playback devices 1101 and 110m can be configured to play back the same or similar audio content in synchrony from one or more audio content sources. In certain example configurations, for example, the group 107a comprises a bonded zone in which the playback devices 1101 and 110m comprise left audio and right audio channels, respectively, of multi-channel audio content, thereby producing or enhancing a stereo effect of the audio content.

In some example configurations, the group 107a includes additional playback devices 110. In other example configurations, however, the media playback system 100 omits the group 107a and/or other grouped arrangements of the playback devices 110. Additional details regarding groups and other arrangements of playback devices are described in further detail below with respect to FIG. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some example configurations, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

### B. Suitable Playback Devices

FIG. 1C is a block diagram of the playback device 110a comprising an input/output 111. The input/output 111 can include an analog I/O 111a (e.g., one or more wires, cables, and/or other suitable communications links configured to carry analog signals) and/or a digital I/O 111b (e.g., one or more wires, cables, or other suitable communications links configured to carry digital signals). In some example configurations, the analog I/O 111 a is an audio line-in input connection comprising, for example, an auto-detecting 3.5 mm audio line-in connection. In some example configurations, the digital I/O 111b comprises a Sony/Philips Digital Interface Format (S/PDIF) communication interface and/or cable and/or a Toshiba Link (TOSLINK) cable. In some example configurations, the digital I/O 111b comprises an High-Definition Multimedia Interface (HDMI) interface and/or cable. In some example configurations, the digital I/O 111b includes one or more wireless communications links comprising, for example, a radio frequency (RF), infrared, WiFi, Bluetooth, or another suitable communication protocol. In certain example configurations, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communications link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain example configurations, one or more of the playback devices 110, NMDs 120, and/or control devices 130 comprise the local audio source 105. In other example configurations, however, the media playback system omits the local audio source 105 altogether. In some example configurations, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B)), amplify the received audio, and output the amplified audio for playback via one or more of the transducers 114. In some example configurations, the playback device 110a optionally includes one or more microphones 115 (e.g., a single microphone, a plurality of microphones, a microphone array) (hereinafter referred to as “the microphones 115”). In certain example configurations, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some example configurations, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some example configurations, the operations further include causing the playback device 110a to send audio information to another one of the playback devices 110a and/or another device (e.g., one of the NMDs 120). Certain example configurations include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some example configurations, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some example configurations, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain example configurations, the network interface 112d includes the wired interface 112f and excludes the wireless interface 112e. In some example configurations, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some example configurations, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain example configurations, one or more of the audio processing components 112g can comprise one or more subcomponents of the processors 112a. In some example configurations, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some example configurations, for example, the amplifiers 112h include one or more switching or class-D power amplifiers. In other example configurations, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain example configurations, the amplifiers 112h comprise a suitable combination of two or more of the foregoing types of power amplifiers. Moreover, in some example configurations, individual ones of the amplifiers 112h correspond to individual ones of the transducers 114. In other example configurations, however, the electronics 112 includes a single one of the amplifiers 112h configured to output amplified audio signals to a plurality of the transducers 114. In some other example configurations, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some example configurations, the transducers 114 can comprise a single transducer. In other example configurations, however, the transducers 114 comprise a plurality of audio transducers. In some example configurations, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain example configurations, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example configurations disclosed herein. Additionally, one of ordinary skilled in the art will appreciate that a playback device is not limited to the examples described herein or to SONOS product offerings. In some example configurations, for example, one or more playback devices 110 comprises wired or wireless headphones (e.g., over-the-ear headphones, on-ear headphones, in-ear earphones). In other example configurations, one or more of the playback devices 110 comprise a docking station and/or an interface configured to interact with a docking station for personal mobile media playback devices. In certain example configurations, a playback device may be integral to another device or component such as a television, a lighting fixture, or some other device for indoor or outdoor use. In some example configurations, a playback device omits a user interface and/or one or more transducers. For example, FIG. 1D is a block diagram of a playback device 110p comprising the input/output 111 and electronics 112 without the user interface 113 or transducers 114.

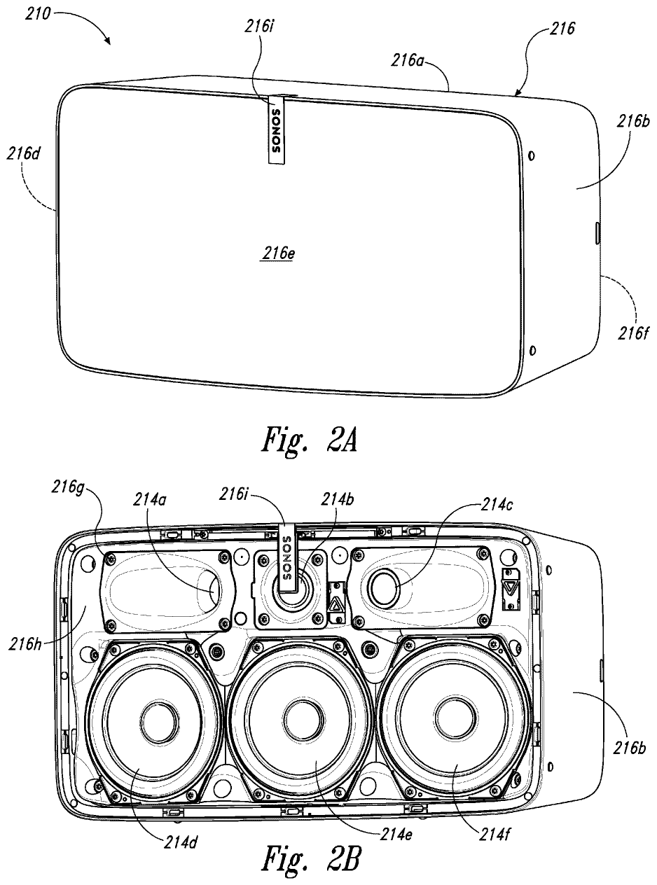

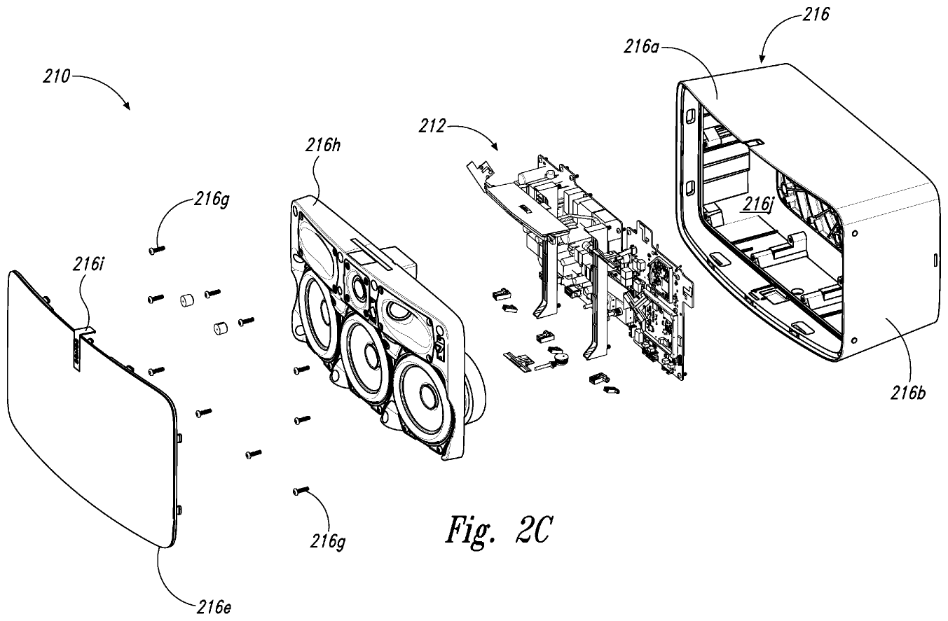

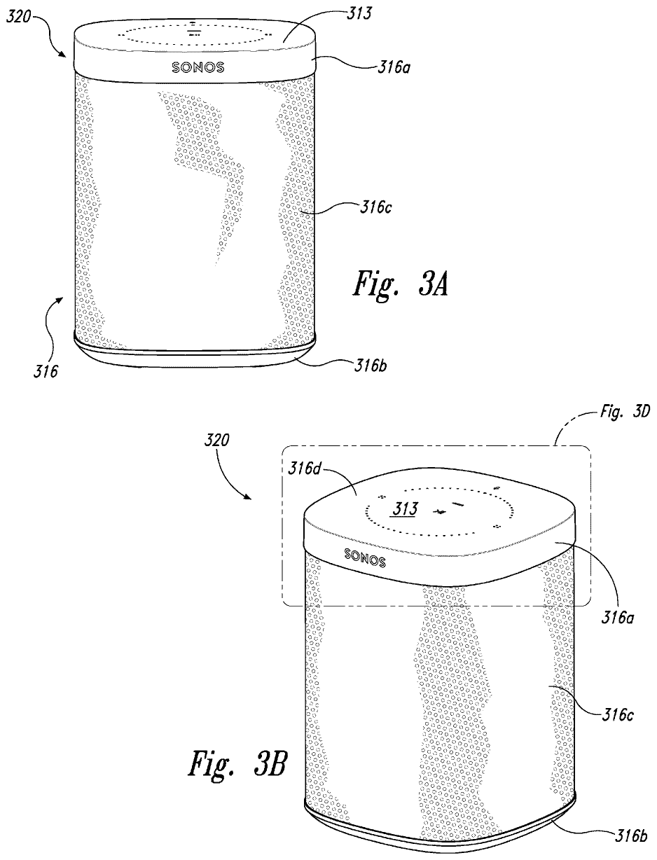

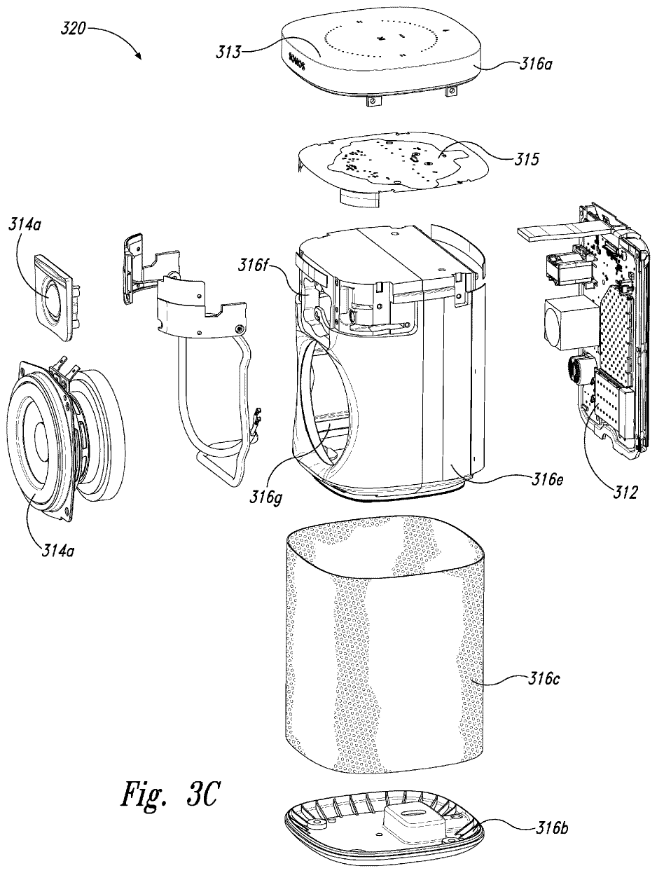

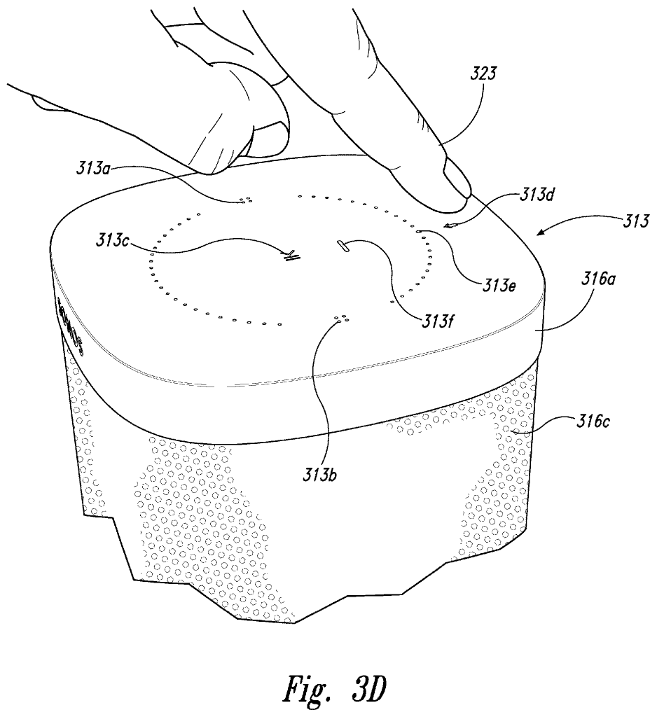

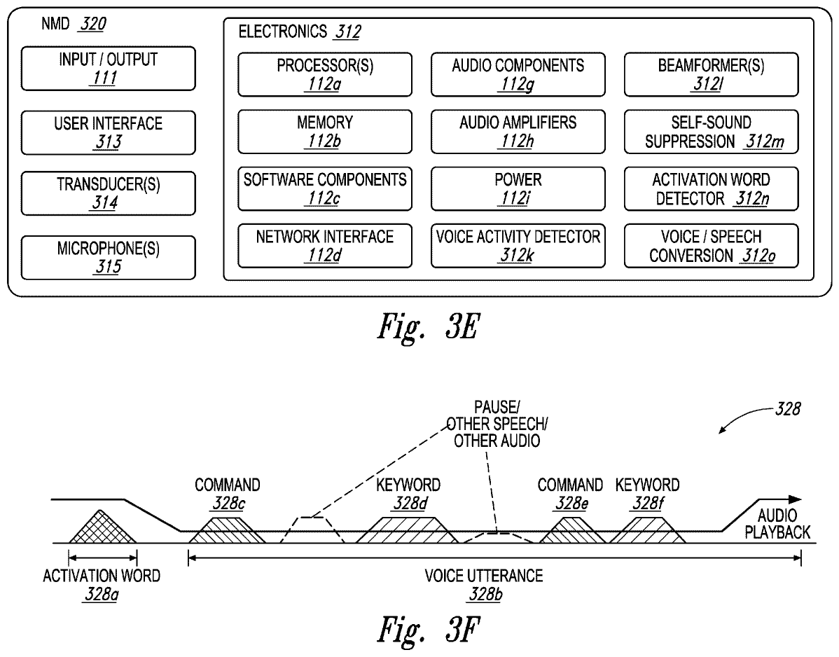

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some example configurations, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 1101 and 110m of FIG. 1B). In some example configurations, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some example configurations, the bonded playback device 110q includes additional playback devices and/or another bonded playback device. Additional playback device example configurations are described in further detail below with respect to FIGS. 2A-3D.

### C. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some example configurations, the NMD 120a is configured as a media playback device (e.g., one or more of the playback devices 110), and further includes, for example, one or more of the audio processing components 112g (FIG. 1C), the transducers 114, and/or other playback device components. In certain example configurations, the NMD 120a comprises an Internet of Things (IOT) device such as, for example, a thermostat, alarm panel, fire and/or smoke detector, etc. In some example configurations, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some example configurations, the NMD 120a includes additional components (e.g., one or more sensors, cameras, thermometers, barometers, hygrometers).

In some example configurations, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other example configurations, however, the playback device 110r receives commands from another control device (e.g., the control device 130a of FIG. 1B). Additional NMD example configurations are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE ® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

### D. Suitable Control Devices

FIG. 1H is a partially schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some example configurations, the control device 130a comprises, for example, a tablet (e.g., an iPad™) , a computer (e.g., a laptop computer, a desktop computer), and/or another suitable device (e.g., a television, an automobile audio head unit, an IoT device). In certain example configurations, the control device 130a comprises a dedicated controller for the media playback system 100. In other example configurations, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some example configurations, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others. Additional description of zones and groups can be found below with respect to FIG. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some example configurations, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some example configurations, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some example configurations the control device 130a is configured as an NMD (e.g., one of the NMDs 120), receiving voice commands and other sounds via the one or more microphones 135.

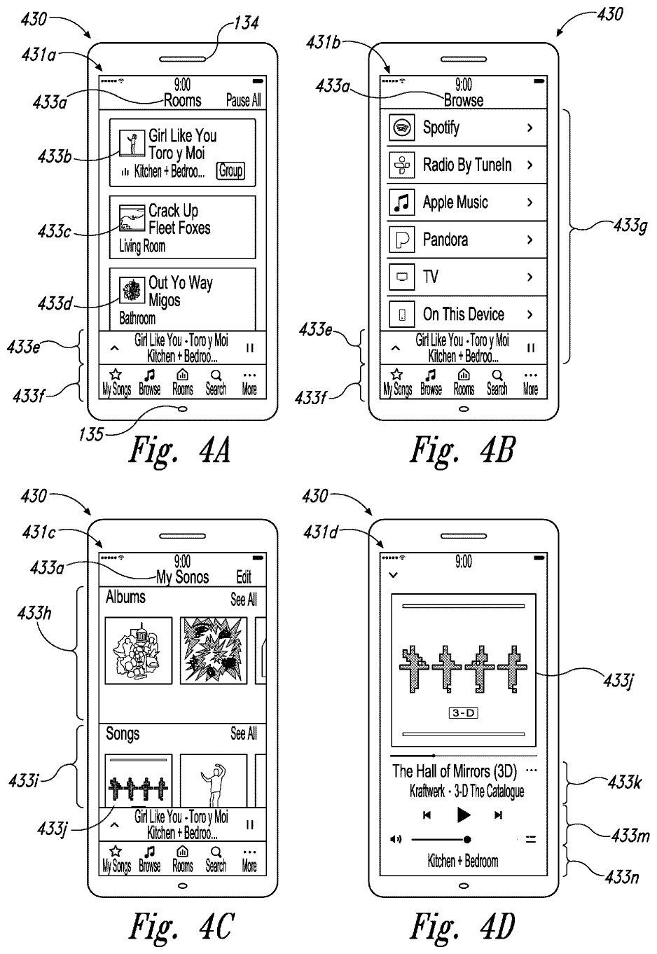

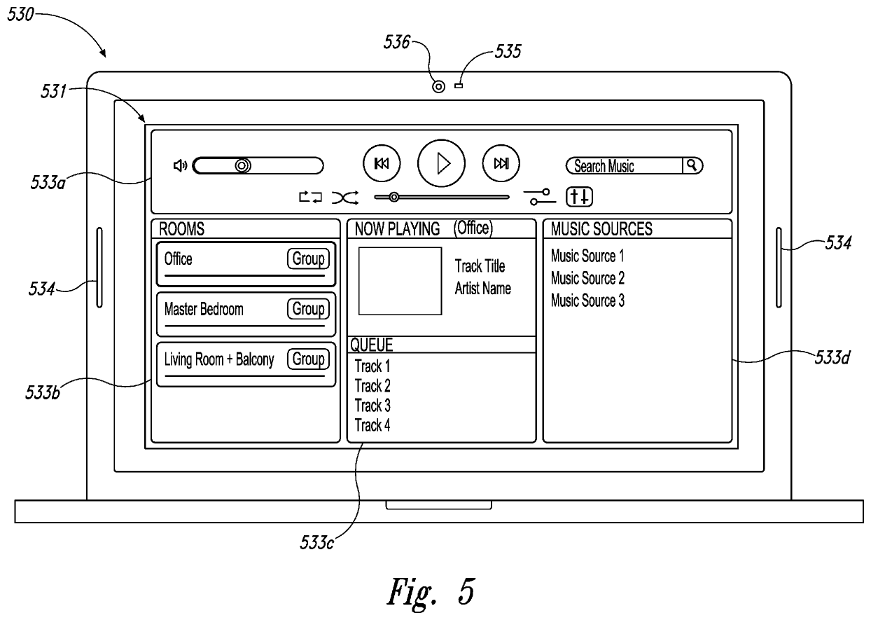

The one or more microphones 135 can comprise, for example, one or more condenser microphones, electret condenser microphones, dynamic microphones, and/or other suitable types of microphones or transducers. In some example configurations, two or more of the microphones 135 are arranged to capture location information of an audio source (e.g., voice, audible sound) and/or configured to facilitate filtering of background noise. Moreover, in certain example configurations, the control device 130a is configured to operate as playback device and an NMD. In other example configurations, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones. Additional control device example configurations are described in further detail below with respect to FIGS. 4A-4D and 5.

### E. Suitable Playback Device Configurations

FIGS. 1-1 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 1101 (e.g., a left playback device) can be bonded to the playback device 1101 (e.g., a left playback device) to form Zone A. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110g and 110h can be merged to form a merged group or a zone group 108b. The merged playback devices 110g and 110h may not be specifically assigned different playback responsibilities. That is, the merged playback devices 110h and 110i may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1-I, the playback devices 1101 and 110m may be bonded so as to produce or enhance a stereo effect of audio content. In this example, the playback device 1101 may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured render low frequencies. When unbonded, however, the Front device 110h can be configured render a full range of frequencies. As another example, FIG. 1K shows the Front and SUB devices 110h and 110i further bonded with Left and Right playback devices 110j and 110k, respectively. In some implementations, the Right and Left devices 110j and 102k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n the master bathroom have the single UI entity of Zone A. In one embodiment, the playback devices 110a and 110n may each output the full range of audio content each respective playback devices 110a and 110n are capable of, in synchrony.

In some example configurations, an NMD is bonded or merged with another device so as to form a zone. For example, the NMD 120b may be bonded with the playback device 110e, which together form Zone F, named Living Room. In other example configurations, a stand-alone network microphone device may be in a zone by itself. In other example configurations, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group.

For example, Zone Group 108b can have be assigned a name such as “Dining+Kitchen”, as shown in FIG. 1M. In some example configurations, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some example configurations, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones AD, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some example configurations, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion 216c, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) is configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214 d-f (e.g., mid-woofers, woofers, midrange speakers) can be configured output sound at frequencies lower than the transducers 214a-c (e.g., sound waves having a frequency lower than about 2 kHz). In some example configurations, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other example configurations, however, the playback device 210 includes more than six transducers (e.g., nine, ten). Moreover, in some example configurations, all or a portion of the transducers 214 are configured to operate as a phased array to desirably adjust (e.g., narrow or widen) a radiation pattern of the transducers 214, thereby altering a user's perception of the sound emitted from the playback device 210.

In the illustrated embodiment of FIGS. 2A-2C, a filter 216i is axially aligned with the transducer 214b. The filter 216i can be configured to desirably attenuate a predetermined range of frequencies that the transducer 214b outputs to improve sound quality and a perceived sound stage output collectively by the transducers 214. In some example configurations, however, the playback device 210 omits the filter 216i. In other example configurations, the playback device 210 includes one or more additional filters aligned with the transducers 214b and/or at least another of the transducers 214.

FIGS. 3A and 3B are front and right isometric side views, respectively, of an NMD 320 configured in accordance with example configurations of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 316 are configured to received sound via the apertures 316d and produce electrical signals based on the received sound. In the illustrated embodiment, a frame 316e (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other example configurations, however, the NMD 320 includes a single transducer, or more than two (e.g., two, five, six) transducers. In certain example configurations, the NMD 320 omits the transducers 314a and 314b altogether.

Electronics 312 (FIG. 3C) includes components configured to drive the transducers 314a and 314b, and further configured to analyze audio information corresponding to the electrical signals produced by the one or more microphones 315. In some example configurations, for example, the electronics 312 comprises many or all of the components of the electronics 112 described above with respect to FIG. 1C. In certain example configurations, the electronics 312 includes components described above with respect to FIG. 1F such as, for example, the one or more processors 112a, the memory 112b, the software components 112c, the network interface 112d, etc. In some example configurations, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control). A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some example configurations, the user interface 313 includes additional or fewer control surfaces and illuminators. In one embodiment, for example, the user interface 313 includes the first indicator 313e, omitting the second indicator 313f.

Moreover, in certain example configurations, the NMD 320 comprises a playback device and a control device, and the user interface 313 comprises the user interface of the control device Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some example configurations, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain example configurations, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 3121, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some example configurations, however, one or more of the components 312k-312o are subcomponents of the processors 112a.

The beamforming and self-sound suppression components 3121 and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal.

Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise.

The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first-and third-party activation word detection algorithms are known and commercially available. For instance, operators of a voice service may make their algorithm available for use in third-party devices. Alternatively, an algorithm may be trained to detect certain activation words. In some example configurations, the activation word detector 312n runs multiple activation word detection algorithms on the received audio simultaneously (or substantially simultaneously). As noted above, different voice services (e.g. AMAZON's ALEXA®, APPLE's SIRI®, or MICROSOFT's CORTANA®) can each use a different activation word for invoking their respective voice service. To support multiple services, the activation word detector 312n may run the received audio through the activation word detection algorithm for each supported voice service in parallel.

The speech/text conversion components 3120 may facilitate processing by converting speech in the voice input to text. In some example configurations, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include a activation word portion 328a and a voice utterance portion 328b. In some example configurations, the activation word 557a can be a known activation word, such as “Alexa,” which is associated with AMAZON's ALEXA®. In other example configurations, however, the voice input 328 may not include a activation word. In some example configurations, a network microphone device may output an audible and/or visible response upon detection of the activation word portion 328a. In addition or alternately, an NMB may output an audible and/or visible response after processing a voice input and/or a series of voice inputs.

The voice utterance portion 328b may include, for example, one or more spoken commands (identified individually as a first command 328c and a second command 328e) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some example configurations, the media playback system 100 is configured to temporarily reduce the volume of audio content that it is playing while detecting the activation word portion 557a. The media playback system 100 may restore the volume after processing the voice input 328, as shown in FIG. 3F. Such a process can be referred to as ducking, examples of which are disclosed in U.S. patent application Ser. No. 15/438,749, incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433e includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A).

Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selections a graphical representation 433j (FIG. 4C), the control device 430 can be configured to begin play back of audio content corresponding to the graphical representation 433j and output a fourth user interface display 431d fourth user interface display 431d includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533b, a playback zone region 533c, a playback queue region 533d, and a media content source region 533e. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some example configurations, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some example configurations, the control device 530 includes other interactions and implementations for grouping and ungrouping zones via the user interface 531. In certain example configurations, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some example configurations, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some example configurations, for example, a playlist can be added to a playback queue, in which information corresponding to each audio item in the playlist may be added to the playback queue. In some example configurations, audio items in a playback queue may be saved as a playlist. In certain example configurations, a playback queue may be empty, or populated but “not in use” when the playback zone or zone group is playing continuously streaming audio content, such as Internet radio that may continue to play until otherwise stopped, rather than discrete audio items that have playback durations. In some example configurations, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

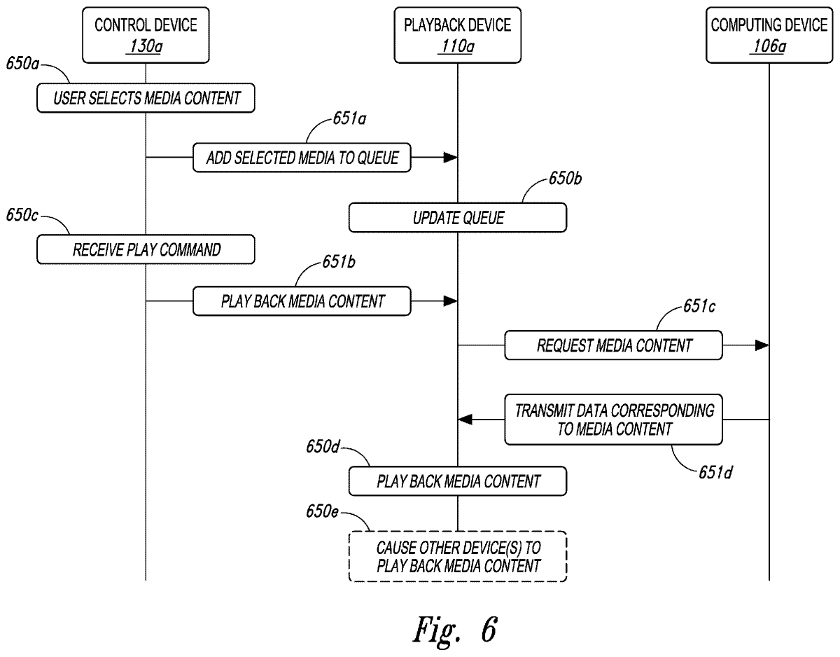

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the first computing device 106a requesting the selected media content. The first computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650e, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the first computing device 106a, and begin playback of the selected media content in response to a message from the playback device 110a such that all of the devices in the group play back the selected media content in synchrony.

### IV. Overview of Example Configurations

Playback systems according to some example configurations disclosed herein are configured to operate in a multi-tier hierarchical network architecture comprising one or more audio sourcing devices, a playback system coordinator, and one or more playback groups, where each playback group includes a primary playback device and one or more secondary playback devices. In operation, the functions performed by the primary playback device and the secondary playback devices enable the hierarchical distribution of audio content, playback timing, clock timing, and network configuration and control signaling that enables independent playback groups to play audio content together in a groupwise manner, including in synchrony with each other. Functions performed by the primary playback device and the secondary playback devices also facilitate groupwise control of individual playback groups via each playback group's primary playback device.

Further, in some example configurations, playback devices within a playback group are additionally configured to determine which playback device should function as the primary playback device for the playback group, which effectively also determines which playback devices will function as secondary playback devices in the playback group. In some example configurations, individual playback devices are configured to store their particular playback configuration settings in persistent memory so that the playback device can more quickly resume its operating role in the hierarchical network architecture after a power outage, network outage, or other disruption to the operation of a playback group or playback system comprising several playback groups.

Additionally, some embodiments disclosed herein provide enhanced flexibility and scalability over existing types of grouped configurations via the introduction of several new concepts including but not limited to (i) a new type of grouping referred to herein as an “Area Zone” which implements a new type of hierarchical control plane to streamline signaling between and among playback entities within the Area Zone, individually or in combination in some embodiments with multicast audio distribution to playback entities within the Area Zone, (ii) a new type of playback device referred to herein as a Multi-Player Playback Device that includes one or more processors, tangible, non-transitory computer readable media and a plurality (e.g., up to eight, ten, twelve, or even more) configurable audio outputs, where the new Multi-Player Playback Device is configurable to implement from one to several logical “players,” and (iii) a new type of logical player implemented by a Multi-Player Playback Device.

The new Area Zone configurations, individually or in combination with the new Multi-Player Playback Devices and logical players, can be particularly advantageous in larger playback system implementations, including but not limited to implementations having multi-tier hierarchical network architectures according to some embodiments disclosed herein.

For example, the hierarchical control plane configuration, individually or in combination with distributing content and playback timing via multicast transmissions, employed by some Area Zone embodiments described herein can be more efficient than traditional approaches that rely on a flat, fully-meshed control plane and distributing audio content and playback timing via unicast transmissions, especially in playback systems involving very large numbers of playback devices, logical players, zones, and playback groups. And with respect to audio distribution, at least for scenarios where the Area Zone Primary transmits the audio content and playback timing to the media multicast group (rather than all of the Area Zone Secondaries), the Area Zone Primary should, in practice, need to transmit less data across the network as compared to configurations where the audio sourcing device is configured to transmit the audio content and playback timing to individual playback devices via separate unicast transmissions.

### V. Technical Features

In some example configurations, at least some aspects of the technical solutions derive from the technical structure and organization of the audio content, the playback timing, and the reference clock timing information, including: (A) how an individual audio sourcing device uses reference clock timing information to generate system playback timing for audio content that the audio sourcing device distributes to individual primary playback devices within the playback system, (B) how an individual primary playback device uses the system playback timing received from the audio sourcing device and the reference clock timing to generate group playback timing for the primary playback device's playback group, (C) how an individual primary playback device uses the group playback timing to play audio content in synchrony with both (i) other primary playback devices in the playback system and (ii) the secondary playback devices that are in the individual primary playback device's playback group; and (D) how an individual secondary playback device uses the group playback timing and clock timing information received from a primary playback device to play audio content in a groupwise manner with both (i) the primary playback device of the secondary playback device's playback group and (ii) the other secondary playback devices in the secondary playback device's playback group.

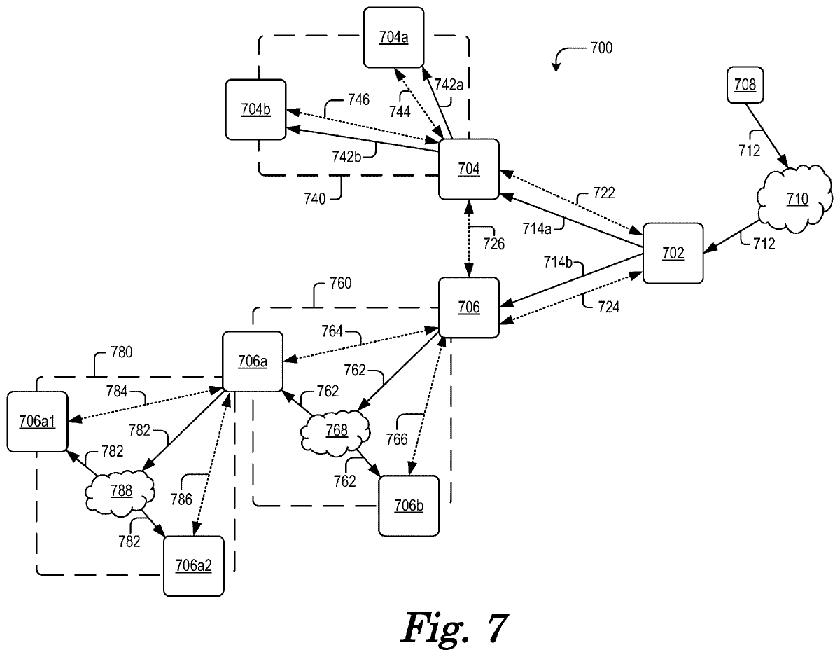

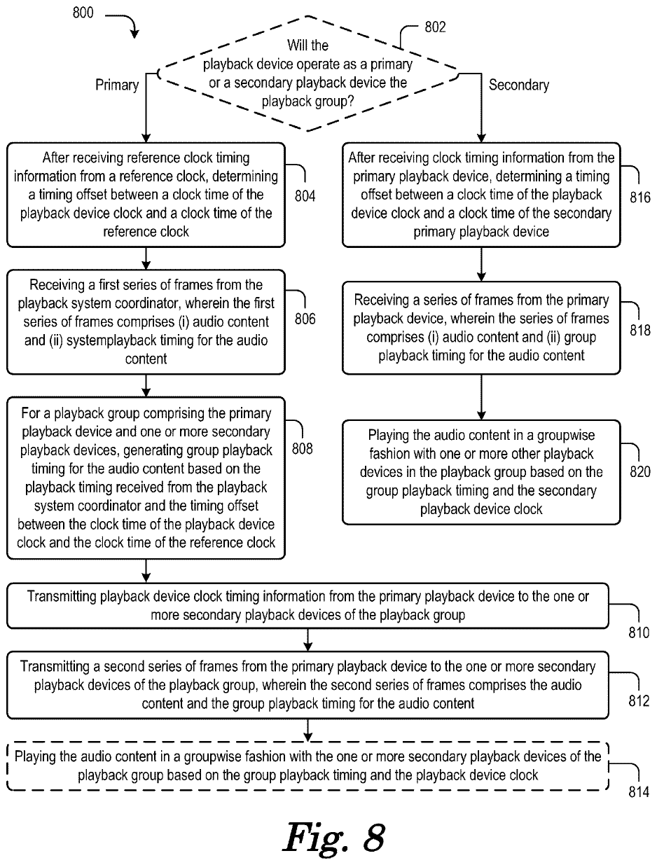

In further example configurations, at least some aspects of the technical solutions derive from the technical structure and organization of the audio content, the playback timing, and the reference clock timing information, including: (i) how an Area Zone Primary (when operating as an audio sourcing device) uses reference clock timing information to generate playback timing for audio content that the Area Zone Primary distributes to individual Area Zone Secondaries, (ii) how an Area Zone Primary uses the playback timing to play audio content in synchrony with Area Zone Secondaries; and (iii) how Area Zone Secondaries use the playback timing and clock timing information received from the Area Zone Primary to play audio content in a groupwise manner with both (a) the Area Zone Primary and (b) the other Area Zone Secondaries within the Area Zone Therefore, to aid in understanding certain aspects of the disclosed technical solutions, certain technical details of the audio content, system playback timing, group playback timing, and reference clock timing information, as well as how the various playback devices generate and/or use system playback timing, group playback timing, and clock timing information to play audio content in a groupwise manner are set forth below. Except where noted, the technical details of the audio content, system and group playback timing, and reference clock timing described herein, as well as how each is generated and used in a multi-tier hierarchical playback system architecture (including implementations with and without Area Zones), are the same or substantially the same for all the examples shown and described with reference to FIGS. 7 and 8, 9A-B, 10, and 11.

### A. Audio Content

The audio content referred to herein may be any type of audio content now known or later developed. For example, in some configurations, the audio content includes any one or more of: (i) streaming music or other audio obtained from a streaming media service, such as Spotify, Pandora, Sonos Radio, or other streaming media services; (ii) streaming music or other audio from a local music library, such as a music library stored on a laptop computer, desktop computer, smartphone, tablet, music server, or other computing device or system now known or later developed; (iii) audio content associated with video content, such as audio content associated with a television program or movie received from any of a streaming video service, or any other source of audio-visual media content now known or later developed; (iv) text-to-speech or other audible information from a voice assistant service (VAS), such as Amazon Alexa, Google Assistant, Sonos Voice Control, or other VAS services now known or later developed; (v) audio content from alarms and alerts, such as smoke alarms, fire alarms, doorbells, or other types of devices and/or systems configured to generate alarms and/or alerts now known or later developed; (vi) audio content that is generated and/or triggered to play from or based on an interaction with an Internet of Things (IOT) device, such as internet enabled home appliances, security systems, thermostats, door locks/door openers, lights, photo frames, sensors, and/or any other IOT device now known or later developed that is configured to generate audio and/or cause audio to be generated; (vi) audio from a home automation/control device (or home control application running on a computing device) such as an Amazon Echo/Echo Dot, Google Nest/Nest Mini, Control4 Neeo Remote, Crestron Smart Control, and/or any other home automation/control device or system, and/or (vii) audio content from a public address (PA) or paging system, telephone, video phone, video/teleconferencing system or other application configured to allow users to communicate with each other via audio and/or video.

### B. Audio Source

An audio source is any system, device, or application that generates, provides, or otherwise makes available any of the aforementioned audio content to an audio sourcing device, including but not limited to a playback device, a smartphone, a tablet computer, a smartwatch, a network server, a content service provider, a home appliance, a security system, industrial equipment, tools, a home control/automation system, or other computing system or device now known or later developed that is suitable for providing audio content to an audio sourcing device.

### C. Audio Sourcing Devices and Playback System Coordinators

An audio sourcing device is any network device that receives or otherwise obtains audio content from an audio source for processing and distribution (as described herein) to one or more playback devices (i.e., a playback group) in a playback system. Examples of a playback group include a synchrony group, a paired configuration, a stereo pair configuration, a home theater group, an Area Zone or any other grouping of two or more playback devices configured to play audio content together in a groupwise manner. As mentioned above, in some example configurations, the audio sourcing device may itself generate audio content in some scenarios, and in such scenarios, the audio source and the audio sourcing device may be the same device and/or application.

In some example configurations, an audio sourcing device (which in some example configurations may be a playback device, e.g., a playback system coordinator, primary playback device, secondary playback device, or Area Zone Primary) obtains any of the aforementioned types of audio content from an audio source via an interface of the audio sourcing device, e.g., one of the audio sourcing device's network interfaces, a “line-in” digital or analog interface, a digital audio interface, a “virtual line-in” interface (e.g., a software layer virtual abstraction that enables third party devices/IOT devices to connect wirelessly to the audio sourcing device to provide audio to the audio sourcing device for processing (and distribution, if applicable)), a network interface (e.g., a WiFi or Bluetooth interface) or any other interface suitable for receiving audio content in digital or analog format now known or later developed.

In some example configurations, the audio sourcing device additionally or alternatively itself may generate the audio content. In some example configurations, the audio sourcing device obtains any of the aforementioned types of audio content via one or more of a Wireless Local Area Network (WLAN) interface or a Personal Area Network (PAN) link (e.g., a Bluetooth or other PAN link) from an audio source, e.g., an audio streaming service, another playback device, a smartphone, a tablet computer, a smartwatch, or other computing device now known or later developed that is suitable for providing audio content to the audio sourcing device.

In some example configurations, audio sourcing device functions and playback system coordinator functions may be performed by the same networked computing.

For example, in some configurations, a playback system coordinator is a playback device configured to perform all the functions of an audio sourcing device was well as performing other management and control functions for a playback system, including but not necessarily limited to adding and/or removing primary playback devices from the playback system, processing commands for the playback group (e.g., volume up, volume down, play, pause, stop, etc.), and other playback system control and management functions. In some example configurations, a playback system coordinator additionally plays audio content in a groupwise manner with the one or more playback groups (i.e., one or more primary playback devices and the one or more secondary playback devices in the playback group with the primary playback device) in the playback system.

In some example configurations, the audio sourcing device may be a device different than a playback device. For example, in some configurations where the audio sourcing device and the audio source are the same, the audio sourcing device may be any of the types of audio sources described above.

In some example configurations of the multi-tier network architecture described herein, the audio sourcing device transmits the processed audio content to all the primary playback devices (but not the secondary playback devices) in the playback system that are configured to play audio based on the audio content.

In some example configurations, the audio sourcing device transmits the processed audio content to all the primary playback devices in a playback system (either via an individual unicast transmission, a multicast transmission, or a broadcast transmission)—even primary playback devices that may not be configured to play audio based on that audio content.

In some example configurations, the audio sourcing device transmits particular audio content to a particular multicast network address, and each primary playback device configured to play audio based on that particular audio content receives that particular audio content via that particular multicast address. In operation, receiving audio content via a particular multicast address in some example configurations requires a primary playback device to join or subscribe to a multicast group corresponding to that particular multicast address. As explained further herein, in some multi-tier hierarchical network configurations, the audio sourcing device (which may a playback device and/or a playback system coordinator) provides the audio content and system playback timing corresponding to the audio content to individual primary playback devices, and the individual primary playback devices provide the audio content and group playback timing to individual secondary playback devices.

In some example configurations, the audio sourcing device receives audio content from an audio source in digital form, e.g., via an incoming stream of packets or frames. In some example configurations, individual packets or frames in the incoming stream have a sequence number or other identifier that specifies an ordering of the packets within the incoming stream. In operation, the audio sourcing device uses the sequence number or other identifier to detect missing packets or frames and/or to reassemble the packets or frames of the incoming stream in the correct order before performing further processing. In some example configurations, the sequence number or other identifier that specifies the ordering of the packets or frames is or at least comprises a timestamp indicating a time when the packet or frame was created. The packet/frame creation time is sometimes used as a sequence number based on an assumption that packets/frames are created in the order in which they should be subsequently played out.

For example, in some example configurations, individual packets from an audio source may include both a timestamp and a sequence number. The timestamp is typically used to place the incoming packets of audio content in the correct order, and the sequence number is typically used to detect packet losses (i.e., missing packets). In operation, the sequence numbers increase by one for each Real-time Transport Protocol (RTP) packet transmitted from the audio source, and timestamps increase by the time “covered” by an RTP packet. In instances where a portion of audio content is split across multiple RTP packets, multiple RTP packets can have the same timestamp.

In some example configurations, the audio sourcing device does not change the sequence number or identifier of a received packet during processing. In some example configurations, the audio sourcing device (i) reorders at least a first set of packets in a first incoming packet stream received from an audio source (an inbound stream) based on each packet's sequence identifier, (ii) extracts audio content from the received packets, (iii) reassembles a bitstream of audio content from the received packets, and (iv) then repacketizes the reassembled bitstream into a second set of packets (an outbound stream), where packets in the second set of packets have sequence numbers and/or timestamps that differ from the sequence numbers and/or timestamps of the packets in the first set of packets (or first stream). The audio content in this outbound stream is sometimes referred to herein as processed audio content.

In some example configurations, individual packets in the second stream (i.e., the outbound stream) are a different length (i.e., shorter or longer) than individual packets in the first stream (i.e., the inbound stream). In some example configurations, reassembling a bitstream from the incoming packet stream and then subsequently repacketizing the reassembled bitstream into a different set of packets facilitates uniform processing and/or transmission of the processed audio content by the audio sourcing device and uniform processing by the primary playback devices that receive the processed audio content from the audio sourcing device.

However, for some delay-sensitive audio content, reassembly and repacketization may be undesirable, and therefore, in some example configurations, the audio sourcing device may not perform reassembly and repacketization for some (or all) audio content that it receives before distributing the audio content to individual primary playback devices. In such embodiments, the audio sourcing device distributes the delay-sensitive audio content to primary playback devices with the same packetization as it was received by the audio sourcing device, with either (i) system playback timing appended to the packets of audio content as overhead or (ii) system playback timing provided separately from the packets of audio content and associated with the audio content (e.g., by providing timestamping data in the system playback timing information that enables a primary playback device to match up received system playback timing with corresponding packets of audio content).

### D. System Playback Timing

As mentioned above, one of the functions performed by an audio sourcing device is to generate system playback timing for audio content. As explained herein, system playback timing that is generated by an audio sourcing device is different than group playback timing that is generated by a primary playback device.

In some configurations, system playback timing corresponds to playback timing for particular audio content that is generated by an audio sourcing device and distributed to one or more primary playback devices, and where an individual primary playback device uses the system playback for that particular audio content to generate group playback timing for that particular audio content. In scenarios where two different playback groups (e.g., a first group and a second group) may be configured to play different audio content (e.g., first content and second content), the system playback timing for the first content (i.e., the first system playback timing) is different than system playback timing for the second content (i.e., the second system playback timing). In this manner, two different streams of audio content may each have their own corresponding system playback timing, even if the same audio sourcing device is generating the two different sets of system playback timing corresponding to the two different streams of audio content.

In some example configurations, individual primary playback devices use the system playback timing generated by the audio sourcing device to generate group playback timing for a playback group. In operation, the primary playback device and the secondary playback devices in the primary playback device's playback group use the group playback timing (which is based on the system playback timing) to play audio based on the audio content in a groupwise manner.

In some example configurations, the audio sourcing device transmits system playback timing separately from the processed audio content. In some example configurations, the audio sourcing device transmits the system playback timing to all the primary playback devices in a playback system by transmitting the system playback timing to a multicast network address for the system playback timing, and all the primary playback devices in the playback system receive the system playback timing via that multicast address associated with the system playback timing. In some example configurations, the audio sourcing device transmits the system playback timing to each primary playback device by transmitting the system playback timing to each primary playback device's unicast network address.

In some example configurations, the audio sourcing device generates system playback timing for individual frames (or packets) of processed audio content. As mentioned earlier, the processed audio content is packaged in a series of frames (or packets) where individual frames (or packets) comprise a portion of the audio content. In some example configurations, the system playback timing for the audio content includes a system playback time for each frame (or packet) of audio content. In operation, the system playback timing for an individual frame (or packet) may be (and sometimes is) included within the frame (or packet), e.g., in the header of the frame (or packet), in an extended header of the frame (or packet), and/or in the payload portion of the frame (or packet).

In some example configurations, the system playback time for an individual frame (or packet) is identified within a timestamp or other indication where the timestamp (or other indication) represents a time to play the one or more portions of audio content within that individual frame (or packet).

In operation, when the system playback timing for an individual frame (or packet) is generated, the system playback timing for that individual frame (or packet) is a future time relative to a current clock time of a reference clock at the time that the system playback timing for that individual frame (or packet) is generated. In some instances, the reference clock is a clock at the audio sourcing device (which may be the playback system coordinator in some example configurations or an Area Zone Primary in other example configurations).

### E. Group Playback Timing

One of the functions performed by a primary playback device (including an Area Zone Primary in some Area Zone implementation examples) is to generate group playback timing for audio content that the primary playback device provides to individual secondary playback devices within the primary playback device's playback group. As explained herein, group playback timing that is generated by a primary playback device is different than the system playback timing that is generated by the audio sourcing device. In some example configurations, individual primary playback devices and individual secondary playback devices use the group playback timing to play audio based on the audio content in a groupwise manner with other playback devices in a playback group (and sometimes with other playback groups).

In some example configurations, the primary playback device transmits group playback timing to secondary playback devices separately from the processed audio content that the primary playback device transmits to secondary playback devices. In some example configurations, the primary playback device transmits the group playback timing to all the secondary playback devices in the primary playback device's playback group by transmitting the group playback timing to a multicast network address for the group playback timing, and all the secondary playback devices in the playback group receive the group playback timing via that multicast address associated with the group playback timing. In some example configurations, the primary playback device transmits the group playback timing to each secondary playback device by transmitting the group playback timing to each secondary playback device's unicast network address.

Some example configurations may additionally use Subgroup Playback Timing. For example, in some instances a secondary playback device (in a playback group) may be additionally configured to operate as a subgroup primary device for a subgroup comprising one or more tertiary playback devices. In some such scenarios, the secondary playback device (configured as the subgroup primary for the subgroup) receives the group playback timing from the primary playback device, generates subgroup playback timing for the subgroup, and transmits the subgroup playback timing to the tertiary playback devices in the subgroup.

In practice, a secondary playback device configured as a subgroup primary device for a subgroup may generate subgroup playback timing for its subgroup based on group playback timing received from a group primary playback device in any of the ways described herein that a primary playback device generates group playback timing for its playback group based on system playback timing received from the audio sourcing device. Additionally, a secondary playback device configured as a subgroup primary device for a subgroup may distribute subgroup playback timing to its subgroup of tertiary playback devices in any of the ways described herein that a primary playback device distributes group playback timing to its playback group of secondary playback devices.

In some example configurations, the primary playback device generates group playback timing for individual frames (or packets) of processed audio content. As mentioned earlier, in some examples, the processed audio content is packaged in a series of frames (or packets) where individual frames (or packets) comprise a portion of the audio content. In some configurations, the group playback timing for the audio content includes a group playback time for each frame (or packet) of audio content. In some configurations, the group playback timing for an individual frame (or packet) is included within the frame (or packet), e.g., in the header of the frame (or packet), in an extended header of the frame (or packet), and/or in the payload portion of the frame (or packet).

In some example configurations, the group playback time for an individual frame (or packet) is identified within a timestamp or other indication. In such example configurations, the timestamp (or other indication) represents a time for the primary playback device and the secondary playback devices in the playback group to play the one or more portions of audio content within that individual frame (or packet).

The group playback timing for an individual frame (or packet) is (or corresponds to) the system playback timing for that individual frame (or packet) adjusted by a timing offset corresponding to the difference between (i) the reference clock that the audio sourcing device used to generate the system playback timing and (ii) a clock at the primary playback device that the primary playback device uses for generating group playback timing (and in some instances, also for playing audio content). This clock at the primary playback device that the primary playback device uses for generating group playback timing (and perhaps also for playing audio content) is sometimes referred to herein as the primary playback device clock.

In some scenarios, the primary playback device may add a further timing advance to the group playback timing. For example, in some configurations, the group playback timing for an individual frame (or packet) is (or corresponds to) the system playback timing for that individual frame (or packet) adjusted by (i) a timing offset corresponding to the difference between (a) the reference clock that the audio sourcing device used to generate the system playback timing and (b) the primary playback device clock, and (ii) a group timing advance that corresponds to a future time relative to the current clock time of the primary playback device clock. Adding an additional group timing advance when generating the group playback timing may in some instances better enable the playback devices in the playback group to play the audio content together in a groupwise fashion, particularly when the group playback timing without the additional group timing advance may not provide much time for the secondary playback devices to receive, process, and play the audio content according to the group playback timing without the additional group timing advance added by the primary playback device.

However, in situations where the primary playback device adds the additional group timing advance when generating the group playback timing, the playback group may play the audio content slightly later than playback devices in other playback groups where the primary playback devices may not have added an additional group timing advance when generating the group playback timing for those playback groups.

Similarly, if different primary playback devices in different playback groups add additional group timing advances of differing durations when generating the group playback timing for their respective playback groups, then the playback devices within those different playback groups may play the audio content at slightly different times compared to each other. In other words, the playback devices in the different playback groups may not play the audio content together in as closely of a synchronized fashion as they otherwise might had the playback devices not added the additional group timing advances when generating the group playback timing for those playback groups.

Nevertheless, for playback systems having large numbers of playback devices, and in particular, where different playback groups may not be physically close to each other (and thus, a listener is unlikely to hear audio played by the different groups at the same time), very tight synchronization of playback among different playback groups is not as important as very tight synchronization of playback among the playback devices within an individual group. More particularly, in such playback system configurations, tight synchronization of playback by all of the playback devices in a single playback group is often more important than tight synchronization of playback by different playback groups.

In some instances, a primary playback device may be configured to determine whether to include an additional group timing advance with the group playback timing based on several factors.

First, in some configurations, a primary playback device can determine whether including an additional group timing advance with the group playback timing may help facilitate groupwise playback of the audio content by the members of the playback group.

For example, if the playback devices within the playback group are able to satisfactorily play the audio content in a groupwise fashion based on the group playback timing without an additional group timing advance, then the primary playback device may determine not to include any additional group timing advance with the group playback timing. But if one or more playback devices within the playback group are having difficulty receiving and processing the audio content in sufficient time to play the audio content according to the group playback timing, then the primary playback device may conclude that including an additional group timing advance with the group playback timing might be helpful to facilitate better groupwise playback of the audio by the playback group.

Once the primary playback device has determined that including an additional group timing advance with the group playback timing might be helpful to facilitate better groupwise playback of the audio by the playback group, the primary playback device can then determine whether to (i) include the additional group timing advance with the group playback timing for the playback group or (ii) inform the audio sourcing device that the audio sourcing device should increase the timing advance that the audio sourcing device uses to generate the system playback timing transmitted to all of the primary playback devices.

The primary playback device may consider several factors to determine whether to include the additional group timing advance with the group playback timing or inform the audio sourcing device to increase the timing advance that the audio sourcing device uses to generate the system playback timing.

One factor may include whether the primary playback device's playback group is playing the same audio content as a physically adjacent playback group such that slight differences in playback by the primary playback device's playback group and the physically adjacent playback group may be problematic or at least undesirable. In some configurations, the primary playback device may have (or otherwise obtain) information about other playback groups and the audio content being played by those other playback groups via exchanging messaging with other primary playback devices within the playback system and/or perhaps with a playback system coordinator and/or a playback system controller device.

Another factor may include the physical distance between the primary playback device's playback group and any physically adjacent playback group that may be playing the same audio content. In some configurations, the primary playback device may have (or otherwise obtain) information about the physical distance between the primary playback device's playback group and one or more physically adjacent playback groups via exchanging messaging with the other primary playback devices within the playback system and/or perhaps with a playback system coordinator and/or a playback system controller device. In some instances, network metrics such as receive power levels and/or round trip transmission delay may help the primary playback device determine whether one or more physically adjacent playback groups are sufficiently close (or not) such that differences (even if in some instances slight differences) in playback times between the primary playback device's playback group and any of the one or more physically adjacent playback groups might be undesirable.

In addition to the physical distance between the primary playback device's playback group and any physically adjacent playback group that may be playing the same audio content, some examples may additionally consider physical distance between individual playback devices within a playback group that may be playing the same audio content. In some configurations, the primary playback device may have (or otherwise obtain) information about the physical distance between individual playback devices within a playback group via exchanging messaging with the playback devices within the playback group and/or perhaps a playback system controller device. In some instances, network metrics such as receive power levels and/or round trip transmission delay may help the primary playback device determine whether one or more physically adjacent playback devices are sufficiently close (or not) such that differences (even if in some instances slight differences) in playback times between the physically adjacent playback devices might be undesirable. For example, very tight synchronization of audio playback by any two or more individual playback devices within a playback group may not be critical in scenarios where the individual playback devices are located sufficiently far from each other such that a listener would be unable to detect slight differences in the playback times of the individual playback devices.

If the primary playback device determines that including the additional group timing advance in the group playback timing for the playback group would cause undesirable differences in playback times between the primary playback device's playback group and any one or more physically adjacent playback groups, then the primary playback device may decide to inform the audio sourcing device that the audio sourcing device should increase the timing advance that the audio sourcing device uses to generate the system playback timing transmitted to all of the primary playback devices (i.e., rather than including the additional group timing advance with the group playback timing that the primary playback device distributes to the playback group).

In some examples of configurations where a primary playback device is configured to play the audio content, the primary playback device will play the portion(s) of the particular audio content within an individual frame (or packet) based on the group playback time specified by the group playback timing for that individual frame (or packet). In such configurations, the primary playback device will play audio based on the audio content within an individual frame when the primary playback device clock reaches the group playback time for that individual frame indicated by the group playback time.

### F. Reference Clock Timing Information

The audio sourcing devices disclosed and described herein use reference clock timing information to generate system playback timing for audio content. In some Area Zone embodiments where the Area Zone Primary is configured as the audio sourcing device for the Area Zone, the Area Zone Primary is configured to use reference clock timing to generate playback timing for audio content.

In some example configurations, each primary playback device in the playback system uses the same reference clock timing information from the same reference clock to generate group playback timing for its respective playback group.

In some example configurations, an audio sourcing device uses reference clock timing from a reference clock (e.g., a device clock, a digital-to-audio converter clock, a playback time reference clock, or any other clock) to generate system playback timing for audio content that the audio sourcing device receives or otherwise obtains from an audio source. The reference clock can be a “local” clock at the audio sourcing device or a “remote” clock at a separate network device, e.g., a dedicated playback system clock, another playback device, a computing device, or another network device configured to provide clock timing for use by an audio sourcing device to generate system playback timing. In some example scenarios, the playback system is configured to obtain clock timing from a “remote” clock at a network device via a Wide Area Network (WAN). In some scenarios, the reference clock may comprise a virtual clock that generates reference timing according to a software process and/or perhaps with reference to a physical device clock.

In some example configurations, the device that generates the reference clock timing also transmits the reference clock timing to (i) all the audio sourcing devices that need to use the reference clock timing for generating system playback timing and (ii) all the primary playback devices that need to use the reference clock timing to generate group playback timing for their respective playback groups based on the system playback timing. In some example configurations, the device that generates the reference clock timing transmits the reference clock timing to a multicast network address, and (i) audio sourcing devices configured to generate system playback timing receive the reference clock timing via that multicast address and (ii) primary playback devices configured to use the reference clock timing to generate group playback timing also receive the reference clock timing via that multicast address. In some example configurations, the device that generates the reference clock timing alternatively transmits the reference clock timing to each unicast network address of each other device that uses the reference clock timing, i.e., each audio sourcing device and each primary playback device in the playback system. In some configurations, the device that generates the reference clock timing may (i) transmit the reference clock timing to a multicast address via which one or more audio sourcing devices and/or primary playback devices obtain the reference clock timing and (ii) transmit the reference clock timing to or more unicast network addresses of one or more other audio sourcing devices and/or primary playback devices.

In some example configurations, an individual primary playback device configured to generate group playback timing for its playback group based on the system playback timing and the reference clock timing and play audio content in groupwise manner with its playback group determines one or more of (i) a difference between the reference clock time and a clock time of a clock at the primary playback device (and/or vice versa), (ii) a difference between the clock rate of the reference clock and the clock rate of the clock at the primary playback device (and/or vice versa), and (iii) whether and the extent to which the clock rate of the reference clock has drifted relative to the clock rate of the clock at the primary playback device (and/or vice versa). In some example configurations, each primary playback device uses its own determined difference between the clock times, clock rates, and/or clock drift to or more (i) create group playback timing by adjusting the system playback timing to account for the timing difference(s), (ii) use the group playback timing to play audio based on the audio content, and/or (iii) in connection with using the group playback timing to play the audio, adjust a sample rate of the audio content to be played.

For example, with respect to playing audio by the primary playback device, some example configurations include a primary playback device using the determined difference(s) between the reference clock timing and the primary playback device clock timing to facilitate one or both of (i) dropping one or more samples of audio content, e.g., not playing the dropped samples, thus effectively skipping those samples, and/or (ii) adding one or more samples of audio content, e.g., injecting small periods of silence (typically less than 15-20 milliseconds) during playback of the audio by the primary playback device. By adjusting the sample rate of the audio content to be played by the primary playback device based on differences in clock times, clock rates, and/or clock drift between the reference clock and the primary playback device clock, the primary playback device can in some instances facilitate the synchronous playback process by helping to account for the differences in the clock times, clock rates, and/or clock drift between the reference clock and the primary playback device clock.

### G. Generating System Playback Timing by the Audio Sourcing Device

In some example configurations, for an individual stream of audio content, the audio sourcing device (which may be an Area Zone Primary in some Area Zone implementations): (i) generates system playback timing for the audio content based on clock timing from the reference clock (which may be either a local clock at the audio sourcing device or a clock at another network device separate from the audio sourcing device, e.g., a dedicated reference clock for a playback system), and (ii) transmits the generated system playback timing to individual primary playback devices in the playback system. In some example configurations, when generating system playback timing for an individual frame (or packet) of audio content, the audio sourcing device adds a “timing advance” to the current clock time of the reference clock that the audio sourcing device is using for generating the system playback timing.

In some example configurations, the “timing advance” is based on an amount of time that is greater than or equal to the sum of (i) the network transit time required for frames and/or packets comprising audio content transmitted from the audio sourcing device (e.g., a playback system coordinator or other sourcing device) to arrive at the primary playback device(s), (ii) the amount of time required for all the primary playback devices to process received frames/packets from the audio sourcing device, generate group playback timing, and distribute the processed audio content and group playback timing to the secondary playback devices in their playback groups, and (iii) the amount of time required for the secondary playback devices to receive and process frames/packets from the primary playback device and play the audio based on the audio content and the group playback timing for the playback group.

In some example configurations, the audio sourcing device (which may be an Area Zone Primary in some examples) individually or in combination with one or more other networked computing devices determines a timing advance by sending one or more test messages to individual primary playback devices, and then receiving test response messages back from the individual primary playback devices. The test response messages that an individual primary playback device transmits to the audio sourcing device may include the results of a similar test/response message exchange between the primary playback device and the secondary playback devices within the primary playback device's playback group. In some example configurations, the audio sourcing device and the primary playback devices negotiate (or otherwise individually or in combination determine) a timing advance via multiple test and response messages.

In some example configurations with more than two primary playback devices (which may be Area Zone Secondaries in some examples), the audio sourcing device (which may be an Area Zone Primary in some examples) determines a timing advance by exchanging test and response messages with all of the primary playback devices in the playback system, and then setting a timing advance that is sufficient for the primary playback device having the longest total of network transmit time and packet processing time to determine and distribute group playback timing to the secondary playback devices in its respective playback group.

In some example configurations, the timing advance is one of less than about 100 milliseconds, less than about 50 milliseconds, less than about 20-30 milliseconds, or less than about 10-20 milliseconds.

In operation, the timing advance used for the system playback timing in some of the disclosed multi-tier hierarchical architectures may be greater than the timing advance that would be used in a typical flat architecture. But because the primary playback devices determine processing and latency requirements for their own playback group (via exchanging test/response messaging with the secondary playback devices within their playback group) and incorporate those requirements when exchanging test/response messaging with the audio sourcing device, the audio sourcing device can determine the timing advance required for the system playback timing by exchanging test/response messaging just with the primary playback devices rather than having to exchange test/response messaging with all of the playback devices within the playback system. By distributing some aspects of the timing advance determination process to primary playback devices, the audio sourcing device in some instances can determine a timing advance (and in some instances, determine an adjusted timing advance) more quickly than in scenarios where the audio sourcing device has to coordinate with every playback device in the playback system to determine (and update) the timing advance used for generating playback timing.

In some example configurations, the timing advance remains constant after being determined, or at least constant for the duration of a playback session or perhaps constant during playback of an individual item of audio content (e.g., an individual track, an individual audio message, or similar item of content). In other example configurations, the audio sourcing device can change the timing advance in response to a request from a primary playback device indicating that a greater timing advance is required or a shorter timing advance would be sufficient.

For example, a greater timing advance may be required in situations where the primary playback device is not receiving packets from the audio sourcing device in sufficient time to generate the group playback timing and then distribute the audio content and group playback timing to the secondary playback devices in its playback group in time for all the secondary playback devices in the playback group to play audio in a groupwise fashion with each other based on the group playback timing. Similarly, a shorter timing advance may be sufficient in situations where individual primary playback devices (and/or the secondary playback devices in the playback groups) are buffering more packets comprising portions of audio content than necessary to provide consistent, reliable audio playback.

In some example configurations, the audio sourcing device may additionally generate Forward Error Correction (FEC) data based on the audio content and system playback timing, and stream the FEC data along with the audio content and the system playback timing to individual primary playback devices in the playback system which, in turn, can use the FEC data to correct errors in the audio content and system playback timing received from the audio sourcing device. Aspects of generating FEC data and streaming FEC data with audio content and playback timing are described in more detail in U.S. Provisional App. 63/377,967, titled “Playback Systems with Dynamic Forward Error Correction,” referred to as Docket No. 22-0401p (0403973), filed on Sep. 30, 2022, the entire contents of which are incorporated herein by reference.

### H. Generating Group Playback Timing by a Primary Playback Device

Some functions performed by the primary playback device include generating group playback timing for a playback group, and distributing the group playback timing to the secondary playback devices in its playback group. In some Area Zone examples, the Area Zone Primary is a primary playback device and each Area Zone Secondary is a secondary playback device.

In some scenarios, an individual primary playback device generates group playback timing for audio content based on (i) the system playback timing received from the audio sourcing device and (ii) a “timing offset.” In some examples, an individual primary playback device determines the “timing offset” based the difference between the reference clock time and a clock time of a local clock at the primary playback device (and/or vice versa). In some examples, the local clock at the primary playback device (sometime referred to herein as the primary playback device clock) comprises any of a hardware clock, a software clock, digital-to-analog converter clock, or any other suitable clock or clocking application. In some examples, an individual primary playback device determines its timing offset in an ongoing manner on a regular or semi-regular basis so that, over time, the timing offset that the primary playback device uses to generate the group playback timing is a fairly accurate representation of a current (or at least near current) difference between the reference clock and the primary playback device clock.

In operation, an individual primary playback device generates group playback timing (specific to its playback group) for individual frames (or packets) of audio content by adding the “timing offset” to the system playback timing for each received frame (or packet) comprising portions of audio content. With this approach, the primary playback device converts the system playback timing for the received audio content into “group” playback timing for the primary playback device and all of the secondary playback devices in the primary playback device's playback group. Because each primary playback device calculates its own “timing offset,” each primary playback device's determined “group” playback timing for an individual frame is specific to that particular primary playback device, and by extension, to the other secondary playback devices within that primary playback device's playback group. But because each primary playback device's “timing offset” is based on the same reference clock (i.e., the reference clock that the audio sourcing device used to generate the system playback timing), each playback group's “group” playback timing is still relative to the same reference clock and the same system playback timing. And because each playback group's group playback timing is derived from the same reference clock and the same system playback timing, individual playback devices in each playback group can use their group playback timing to play audio content in a groupwise manner with each other and with playback devices in other playback groups.

Nevertheless, each playback group's individual group playback timing may differ slightly from each other based on, for example, one or more of (i) slight differences in timing advances that may be used by different primary playback devices when generating group playback timing to accommodate different playback group topologies, (ii) slight differences in clock rates between the different primary playback device clocks of the different primary playback devices that may cause slight differences in group playback timing between different playback groups, (iii) differences arising from how often (or not) individual primary playback devices update their “timing offset” relative to the reference clock used by the audio sourcing device to generate the system playback timing for particular audio content that each primary playback device uses to generate the group playback timing for its playback group, and/or (iv) other factors that may contribute to slight differences between different group playback timing generated by different primary playback devices for different playback groups.

But while attempting to coordinate groupwise playback of the same audio content by a large number of playback devices organized into several playback groups where each playback group has slightly different group playback timing may run counter to conventional wisdom, in some instances (e.g., based on proximity of individual playback groups and/or playback devices playing the same audio content as described herein), some configurations disclosed herein are able to play the same audio content in a groupwise manner (including in synchrony with each other) in a manner that is satisfactory for listeners despite slight differences that may exist between the group playback timing used by different playback devices within different playback groups to play that same audio content.

In some example configurations, the primary playback device may additionally generate FEC data based on the audio content and group playback timing, and stream the FEC data along with the audio content and the group playback timing to individual secondary playback devices in the playback group which, in turn, can use the FEC data to correct errors in the audio content and group playback timing received from the primary playback device. Aspects of generating FEC data and streaming FEC data with audio content and playback timing are described in more detail in U.S. Provisional App. 63/377,967, titled “Playback Systems with Dynamic Forward Error Correction,” referred to as Docket No. 22-0401p (0403973), filed on Sep. 30, 2022, the entire contents of which are incorporated herein by reference.

### I. Generating Subgroup Playback Timing by a Secondary Playback Device

Some functions performed by a secondary playback device include operating as a subgroup primary for a subgroup of a playback group. In the context of the present disclosure, a secondary playback device that is configured to operate as a subgroup primary for a subgroup is referred to herein as a subgroup primary.

Some functions performed by a subgroup primary include (i) generating subgroup playback timing for a subgroup and (ii) distributing the subgroup playback timing to the tertiary playback devices in its subgroup.

In some scenarios, an individual subgroup primary generates subgroup playback timing for audio content based on (i) the group playback timing received from the primary playback device of the playback group of which the subgroup primary is a member, and (ii) a “timing offset.” In some examples, an individual subgroup primary determines the “timing offset” based the difference between the primary playback device clock and a clock time of a local clock at the subgroup primary (and/or vice versa). In some examples, the local clock at the subgroup primary (sometime referred to herein as the subgroup primary clock) comprises any of a hardware clock, a software clock, digital-to-analog converter clock, or any other suitable clock or clocking application. In some examples, an individual subgroup primary determines its timing offset in an ongoing manner on a regular or semi-regular basis so that, over time, the timing offset that the subgroup primary uses to generate the subgroup playback timing is a fairly accurate representation of a current (or at least near current) difference between the subgroup primary clock and the primary playback device clock.

In operation, an individual subgroup primary device generates subgroup playback timing (specific to its subgroup) for individual frames (or packets) of audio content by adding the “timing offset” to the group playback timing for each received frame (or packet) comprising portions of audio content. With this approach, the subgroup primary converts the group playback timing for the received audio content into “subgroup” playback timing for the subgroup primary and all of the tertiary playback devices in the subgroup primary's subgroup. Because each subgroup primary calculates its own “timing offset,” each subgroup primary's determined “subgroup” playback timing for an individual frame is specific to that particular subgroup primary, and by extension, to the other tertiary playback devices within that subgroup primary's subgroup.

For a playback group comprising several subgroups (and thus several subgroup primary devices), because each subgroup primary's “timing offset” is based on the same primary playback device clock (i.e., the local clock at the primary playback device that the primary playback device used to generate the group playback timing), each subgroup primary's “subgroup” playback timing is relative to the same primary playback device clock and the same group playback timing. Further, because each subgroup's subgroup playback timing is derived from the same primary playback device clock and the same group playback timing, individual tertiary playback devices in each subgroup can use the subgroup playback timing to play audio content in a groupwise manner with each other and with (i) other tertiary playback devices in other subgroups within the same playback group and (ii) other playback groups.

Nevertheless, each subgroup's individual subgroup playback timing may differ slightly from each other based on, for example, one or more of (i) slight differences in timing advances that may be used by different subgroup primaries when generating subgroup playback timing to accommodate different subgroup topologies, (ii) slight differences in clock rates between the different subgroup primary clocks of the different subgroup primary devices that may cause slight differences in subgroup playback timing between different subgroups, (iii) differences arising from how often (or not) individual subgroup primary devices update their “timing offset” relative to the primary playback device clock used by the primary playback device to generate the group playback timing for particular audio content that each subgroup primary device uses to generate the subgroup playback timing for its subgroup, and/or (iv) other factors that may contribute to slight differences between different subgroup playback timing generated by different subgroup primary devices for different subgroups within a playback group.

But while attempting to coordinate groupwise playback of the same audio content by a large number of playback devices organized into several playback groups (and subgroups) where each playback group has slightly different group playback timing (and where each subgroup has slightly different subgroup timing) may run counter to conventional wisdom, in some instances (e.g., based on proximity of individual playback groups, subgroups, and/or playback devices playing the same audio content as described herein), some configurations disclosed herein are able to play the same audio content in a groupwise manner (including in synchrony with each other) in a manner that is satisfactory for listeners despite slight differences that may exist between the group playback timing and subgroup playback timing used by different playback devices within different playback groups and subgroups, respectively, to play that same audio content.

In some example configurations, the subgroup primary device may additionally generate FEC data based on the audio content and subgroup playback timing, and stream the FEC data along with the audio content and the subgroup playback timing to individual tertiary playback devices in the subgroup which, in turn, can use the FEC data to correct errors in the audio content and subgroup playback timing received from the subgroup primary device. Aspects of generating FEC data and streaming FEC data with audio content and playback timing are described in more detail in U.S. Provisional App. ______, titled “Playback Systems with Dynamic Forward Error Correction,” referred to as Docket No. 22-0401p (0403973), filed on Sep. 30, 2022, the entire contents of which are incorporated herein by reference.

### J. Playing Audio Based on Group Playback Timing by a Primary Playback Device

In some instances, the primary playback device additionally uses the generated group playback timing to play audio in a groupwise manner with (i) the secondary playback devices in its playback group and (ii) other playback groups formed from other primary playback devices and the secondary playback devices in their corresponding playback groups. In some Area Zone examples, the Area Zone Primary is a primary playback device and each Area Zone Secondary is a secondary playback device.

To play an individual frame (or packet) of the audio content, an individual primary playback device plays a portion(s) of audio corresponding to the audio content in the individual frame (or packet) when the primary playback device clock (i.e., the clock that the individual primary playback device is using to play the audio content) reaches the “group” playback time for that individual frame (or packet) specified in the group playback timing.

Some example configurations may additionally or alternatively include the primary playback device adjusting the sample rate of audio content based one or more timing differences between the primary playback device clock and the reference clock in connection with groupwise playback of the audio content. In some example configurations, in addition to determining the difference between the primary playback device clock and the reference clock (and/or vice versa), the primary playback device may additionally determine any of (i) a difference between the clock rate of the primary playback device clock and the reference clock (and/or vice versa), and (iii) whether and the extent to which the clock rate of the primary playback device clock has drifted relative to the clock rate of the reference clock (and/or vice versa).

For example, in some configurations, individual primary playback devices use one or more of the determined difference(s) between the primary playback device clock and the reference clock to facilitate one or both of (i) dropping one or more samples of audio content, e.g., not playing the dropped samples, thus effectively skipping those samples, and/or (ii) adding one or more samples of audio content, e.g., injecting small periods of silence (typically less than 15-20 milliseconds) during playback. By adjusting the sample rate of the audio content to be played based on differences in one or more of the clock times, clock rates, and/or clock drift between the primary playback device clock and the reference clock, individual primary playback devices can in some instances facilitate the synchronous playback process by helping to account for the differences in one or more of the clock times, clock rates, and/or clock drift between the reference clock and the primary playback device clock.

In particular, if the primary playback device clock is running faster than the reference clock (i.e., the clock rate of the primary playback device is greater than the clock rate of the reference clock), then the primary playback device may need to inject a small period of silence during playback of an individual frame of audio content to account for the clock rate difference. Conversely, if the primary playback device clock is running slower than the reference clock (i.e., the clock rate of the primary playback device clock is less than the clock rate of the reference clock), then the primary playback device may need to drop (not play) one or more audio samples during playback of an individual frame of audio content to account for the clock rate difference.

In this manner, adjusting the sample rate by adding short “silent” samples or dropping audio samples during playback enables the primary playback device account for minor fluctuations (or drift) in the clock rates. In some situations, making slight adjustments to the sample rate in this manner enables the primary playback devices to maintain high-quality synchronous playback without having to set new timing offsets when playing audio content based on group playback timing (which is based on the system playback timing received from the audio sourcing device), which could be more disruptive to playback in some instances as compared to minor sample rate adjustments.

### K. Playing Audio Based on Group Playback Timing by a Secondary Playback Device

As mentioned above, an individual primary playback device transmits audio content and group playback timing for the audio content to individual secondary playback devices within the primary playback device's playback group. And each secondary playback device in the primary playback device's playback group (i) receives the audio content and the group playback timing from the primary playback device and (ii) uses the group playback timing to play the audio content in a groupwise manner with the other playback devices in the playback group. In some Area Zone examples, the Area Zone Primary is a primary playback device and each Area Zone Secondary is a secondary playback device.

In operation, an individual secondary playback device (i) receives the frames (or packets) comprising the portions of the audio content from the primary playback device, (ii) receives the group playback timing for the audio content from the primary playback device (e.g., in the frame and/or packet headers of the frames and/or packets comprising the portions of the audio content or perhaps separately from the frames and/or packets comprising the portions of the audio content), and (iii) receives primary playback device clock timing information from the primary playback device.

The secondary playback device uses the primary playback device clock timing to determine a “timing offset.” The “timing offset” determined by the secondary playback device is different than the “timing offset” that the primary playback device used to generate the group playback timing. The “timing offset” determined by the second playback device corresponds to the difference between the primary playback device clock and a clock time of a local clock at the secondary playback device (and/or vice versa). In some examples, the local clock at the secondary playback device (sometime referred to herein as the secondary playback device clock) comprises any of a hardware clock, a software clock, digital-to-analog converter clock, or any other suitable clock or clocking application. In some examples, an individual secondary playback device determines its timing offset in an ongoing manner on a regular or semi-regular basis so that, over time, the timing offset that the secondary playback device uses for playback is a fairly accurate representation of a current (or at least near current) difference between the secondary playback device clock and the primary playback device clock.

To play an individual frame (or packet) of the audio content with the playback devices in its playback group, an individual secondary playback device plays the portion(s) of audio content in the individual frame (or packet) when the local clock that the secondary playback device uses for audio playback (i.e., the secondary playback device clock) reaches the group playback time specified in the group playback timing for that individual frame (or packet), as adjusted by the “timing offset” between the secondary playback device clock and the primary playback device clock.

Because each secondary playback device plays frames (or packets) comprising portions of the audio content according to the group playback timing as adjusted by its own “timing offset” relative to the primary playback device clock, and because the primary playback device that provides the group playback timing also generated the group playback timing for those frames (or packets) relative to the primary playback device clock, then each secondary playback device plays the same frames (or packets) comprising the same portions of the audio content in synchrony with all of the other secondary playback devices, i.e., at the same time or at substantially the same time.

Some example configurations may additionally or alternatively include the secondary playback device adjusting the sample rate of audio content based one or more timing differences between the secondary playback device clock and the primary playback device clock in connection with groupwise playback of the audio content. In some example configurations, in addition to determining the difference between the secondary playback device clock and the primary playback device clock (and/or vice versa), the secondary playback device may additionally determine any of (i) a difference between the clock rate of the secondary playback device clock and the primary playback device clock (and/or vice versa), and (iii) whether and the extent to which the primary playback device clock has drifted relative to the clock rate of the secondary playback device clock (and/or vice versa).

For example, in some configurations, individual secondary playback devices use one or more of the determined difference(s) between the secondary playback device clock and the primary playback device clock to facilitate one or both of (i) dropping one or more samples of audio content, e.g., not playing the dropped samples, thus effectively skipping those samples, and/or (ii) adding one or more samples of audio content, e.g., injecting small periods of silence (typically less than 15-20 milliseconds) during playback. By adjusting the sample rate of the audio content to be played based on differences in one or more of the clock times, clock rates, and/or clock drift between the secondary playback device clock and the primary playback device clock, individual secondary playback devices can in some instances facilitate the synchronous playback process by helping to account for the differences in one or more of the clock times, clock rates, and/or clock drift between the secondary playback device clock and the primary playback device clock.

In particular, if the secondary playback device clock is running faster than the primary playback device clock (i.e., the clock rate of the secondary playback device clock is greater than the clock rate of the primary playback device clock), then the secondary playback device may need to inject a small period of silence during playback of an individual frame of audio content to account for the clock rate difference. Conversely, if the secondary playback device clock is running slower than the primary playback device clock (i.e., the clock rate of the secondary playback device clock is less than the clock rate of the primary playback device clock), then the secondary playback device may need to drop (not play) one or more audio samples during playback of an individual frame of audio content to account for the clock rate difference.

In this manner, adjusting the sample rate by adding short “silent” samples or dropping audio samples during playback enables the secondary playback device account for minor fluctuations in the clock rates. In some situations, making slight adjustments to the sample rate in this manner enables the secondary playback devices to maintain high-quality synchronous playback without having to set new timing offsets when playing audio content based on group playback timing received from the primary playback device, which could be more disruptive to playback in some instances as compared to minor sample rate adjustments.

L. Playing Audio based on Subgroup Playback Timing by a Tertiary Playback Device

As mentioned above, an individual subgroup primary transmits audio content and subgroup playback timing for the audio content to individual tertiary playback devices within the subgroup primary's subgroup. Each tertiary playback device in the subgroup primary's subgroup (i) receives the audio content and the subgroup playback timing from the subgroup primary and (ii) uses the subgroup playback timing to play the audio content in a groupwise manner with the other playback devices in the subgroup. In some Area Zone examples, the Area Zone Primary may be configured as a subgroup primary playback device and each Area Zone Secondary may be configured as a tertiary playback device.

In operation, an individual tertiary playback device (i) receives the frames (or packets) comprising the portions of the audio content from the subgroup primary, (ii) receives the subgroup playback timing for the audio content from the subgroup primary (e.g., in the frame and/or packet headers of the frames and/or packets comprising the portions of the audio content or perhaps separately from the frames and/or packets comprising the portions of the audio content), and (iii) receives subgroup primary clock timing information from the subgroup primary.

The tertiary playback device uses the subgroup primary clock timing to determine a “timing offset.” The “timing offset” determined by the tertiary playback device is different than both (i) the “timing offset” that the subgroup primary used to generate the subgroup playback timing and (ii) the “timing offset” that the primary playback device used to generate the group playback timing on which the subgroup timing is based. The “timing offset” determined by the tertiary playback device corresponds to the difference between the subgroup primary clock and a clock time of a local clock at the tertiary playback device (and/or vice versa). In some examples, the local clock at the tertiary playback device (sometime referred to herein as the tertiary playback device clock) comprises any of a hardware clock, a software clock, digital-to-analog converter clock, or any other suitable clock or clocking application. In some examples, an individual tertiary playback device determines its timing offset in an ongoing manner on a regular or semi-regular basis so that, over time, the timing offset that the tertiary playback device uses for playback is a fairly accurate representation of a current (or at least near current) difference between the tertiary playback device clock and the subgroup primary clock.

To play an individual frame (or packet) of the audio content with the playback devices in its subgroup, an individual tertiary playback device plays the portion(s) of audio content in the individual frame (or packet) when the local clock that the tertiary playback device uses for audio playback (i.e., the tertiary playback device clock) reaches the subgroup playback time specified in the subgroup playback timing for that individual frame (or packet), as adjusted by the “timing offset” between the tertiary playback device clock and the subgroup primary clock.

Because each tertiary playback device (in a subgroup) plays frames (or packets) comprising portions of the audio content according to the subgroup playback timing as adjusted by its own “timing offset” relative to the subgroup primary clock, and because the subgroup primary that provides the subgroup playback timing also generated the subgroup playback timing for those frames (or packets) relative to the subgroup primary clock, then each tertiary playback device plays the same frames (or packets) comprising the same portions of the audio content in synchrony with all of the other tertiary playback devices in the subgroup, i.e., at the same time or at substantially the same time.

Some example configurations may additionally or alternatively include the tertiary playback device adjusting the sample rate of audio content based one or more timing differences between the tertiary playback device clock and the subgroup primary clock in connection with groupwise playback of the audio content. In some example configurations, in addition to determining the difference between the tertiary playback device clock and the subgroup primary clock (and/or vice versa), the tertiary playback device may additionally determine any of (i) a difference between the clock rate of the tertiary playback device clock and the subgroup primary clock (and/or vice versa), and (iii) whether and the extent to which the subgroup primary clock has drifted relative to the clock rate of the tertiary playback device clock (and/or vice versa).

For example, in some configurations, individual tertiary playback devices use one or more of the determined difference(s) between the tertiary playback device clock and the subgroup primary clock to facilitate one or both of (i) dropping one or more samples of audio content, e.g., not playing the dropped samples, thus effectively skipping those samples, and/or (ii) adding one or more samples of audio content, e.g., injecting small periods of silence (typically less than 15-20 milliseconds) during playback. By adjusting the sample rate of the audio content to be played based on differences in one or more of the clock times, clock rates, and/or clock drift between the tertiary playback device clock and the subgroup primary clock, individual tertiary playback devices can in some instances facilitate the synchronous playback process by helping to account for the differences in one or more of the clock times, clock rates, and/or clock drift between the tertiary playback device clock and the subgroup primary clock.

In particular, if the tertiary playback device clock is running faster than the subgroup primary clock (i.e., the clock rate of the tertiary playback device clock is greater than the clock rate of the subgroup primary clock), then the tertiary playback device may need to inject a small period of silence during playback of an individual frame of audio content to account for the clock rate difference. Conversely, if the tertiary playback device clock is running slower than the subgroup primary clock (i.e., the clock rate of the tertiary playback device clock is less than the clock rate of the subgroup primary clock), then the tertiary playback device may need to drop (not play) one or more audio samples during playback of an individual frame of audio content to account for the clock rate difference.

In this manner, adjusting the sample rate by adding short “silent” samples or dropping audio samples during playback enables the tertiary playback device account for minor fluctuations in the clock rates. In some situations, making slight adjustments to the sample rate in this manner enables the tertiary playback devices to maintain high-quality synchronous playback without having to set new timing offsets when playing audio content based on subgroup playback timing received from the subgroup primary, which could be more disruptive to playback in some instances as compared to minor sample rate adjustments.

M. Area Zone Primary performing Audio Sourcing Device Functions

As mentioned earlier, in some embodiments, an Area Zone Primary performs the audio sourcing device function for its Area Zone. The audio sourcing device functions include receiving or otherwise obtaining audio content from an audio source for processing and distribution (as described herein) to one or more playback entities within the Area Zone.

In some example configurations, the Area Zone Primary obtains any of the aforementioned types of audio content from an audio source via an interface, e.g., one of the Area Zone Primary's network interfaces, a “line-in” digital or analog interface, a digital audio interface, a “virtual line-in” interface (e.g., a software layer virtual abstraction that enables third party devices/IOT devices to connect wirelessly to the Area Zone Primary to provide audio to the Area Zone Primary for processing (and distribution, if applicable)), a network interface (e.g., a WiFi or Bluetooth interface) or any other interface suitable for receiving audio content in digital or analog format now known or later developed.

In some example configurations, the Area Zone Primary obtains any of the aforementioned types of audio content via one or more of a Wireless Local Area Network (WLAN) interface or a Personal Area Network (PAN) link (e.g., a Bluetooth or other PAN link) from an audio source, e.g., an audio streaming service, another playback device, a smartphone, a tablet computer, a smartwatch, or other computing device now known or later developed that is suitable for providing audio content to the Area Zone Primary.

In some example embodiments, the Area Zone Primary transmits particular audio content to a particular multicast network address, and each Area Zone Secondary receives that particular audio content via that particular multicast address. In operation, receiving audio content via a particular multicast address in some example configurations requires an Area Zone Secondary to join or subscribe to a multicast group corresponding to that particular multicast address.

In some example configurations, the Area Zone Primary receives audio content from an audio source in digital form, e.g., via an incoming stream of packets or frames. In some example configurations, individual packets or frames in the incoming stream have a sequence number or other identifier that specifies an ordering of the packets within the incoming stream. In operation, the Area Zone Primary uses the sequence number or other identifier to detect missing packets or frames and/or to reassemble the packets or frames of the incoming stream in the correct order before performing further processing. In some example configurations, the sequence number or other identifier that specifies the ordering of the packets or frames is or at least comprises a timestamp indicating a time when the packet or frame was created. The packet/frame creation time is sometimes used as a sequence number based on an assumption that packets/frames are created in the order in which they should be subsequently played out.

For example, in some example configurations, individual packets from an audio source may include both a timestamp and a sequence number. The timestamp is typically used to place the incoming packets of audio content in the correct order, and the sequence number is typically used to detect packet losses (i.e., missing packets). In operation, the sequence numbers increase by one for each Real-time Transport Protocol (RTP) packet transmitted from the audio source, and timestamps increase by the time “covered” by an RTP packet. In instances where a portion of audio content is split across multiple RTP packets, multiple RTP packets can have the same timestamp.

In some example configurations, the Area Zone Primary does not change the sequence number or identifier of a received packet during processing. In some example configurations, the Area Zone Primary (i) reorders at least a first set of packets in a first incoming packet stream received from an audio source (an inbound stream) based on each packet's sequence identifier, (ii) extracts audio content from the received packets, (iii) reassembles a bitstream of audio content from the received packets, and (iv) then repacketizes the reassembled bitstream into a second set of packets (an outbound stream), where packets in the second set of packets have sequence numbers and/or timestamps that differ from the sequence numbers and/or timestamps of the packets in the first set of packets (or first stream).

In some example configurations, individual packets in the second stream (i.e., the outbound stream) are a different length (i.e., shorter or longer) than individual packets in the first stream (i.e., the inbound stream). In some example configurations, reassembling a bitstream from the incoming packet stream and then subsequently repacketizing the reassembled bitstream into a different set of packets facilitates uniform processing and/or transmission of the processed audio content by the Area Zone Primary and uniform processing by the Area Zone Secondaries.

However, for some delay-sensitive audio content, reassembly and repacketization may be undesirable, and therefore, in some example configurations, the Area Zone Primary may not perform reassembly and repacketization for some (or all) audio content that it receives before distributing the audio content to individual Area Zone Secondaries. In such embodiments, the Area Zone Primary distributes the delay-sensitive audio content to Area Zone Secondaries with the same packetization as it was received by the Area Zone Primary, with either (i) playback timing appended to the packets of audio content as overhead or (ii) playback timing provided separately from the packets of audio content and associated with the audio content (e.g., by providing timestamping data in the playback timing information that enables an Area Zone Secondary to match up received playback timing with corresponding packets of audio content).

### VI. Example Multi-tier Hierarchical System Architectures

FIG. 7 shows a multi-tier hierarchical system 700 according to some example configurations. Multi-tier hierarchical system 700 includes several playback devices. The playback devices shown and described with reference to FIG. 7 are the same as or similar to any of the playback devices disclosed and described herein.

The multi-tier hierarchical system 700 includes an audio sourcing device 702. In some configurations, the audio sourcing device 702 is or comprises a playback device. In other configurations, the audio sourcing device 702 may be a computing device different than a playback device. The audio sourcing device 702 may be the same as or similar to any of the audio sourcing devices disclosed and described herein. In some configurations device 702 is a playback system coordinator configured to perform any (or perhaps all) of the audio sourcing device functions disclosed and described herein.

FIG. 7 shows system 700 as having a single audio sourcing device 702 for ease of illustration. However, other examples may include several audio sourcing devices. Similarly, FIG. 7 shows the audio sourcing device 702 (i) obtaining a single stream of audio content 712 from a single audio source 708, (ii) generating system playback timing for that single stream of audio content, and (iii) distributing the single stream of audio content and system playback timing to every primary playback device in system 700.

However, in other example configurations, an individual audio sourcing device may (i) obtain several streams of audio content from one or more audio sources, (ii) generate separate system playback timing for each stream of audio content, and (iii) distribute each separate stream of audio content and system playback timing to one or more primary playback devices within the playback system, including perhaps sending different sets of one or more separate streams (of audio content and system playback timing) to different primary playback devices within the playback system. Aspects of distributing and processing several streams of audio content from one or more audio sources are described in more detail in U.S. Provisional App. ______, titled “Multichannel Content Distribution,” referred to as Docket No. 22-0207p (0400042), filed on Sep. 30, 2022, the contents of which are incorporated herein by reference.

The multi-tier hierarchical system 700 includes two playback groups 740 and 760 and one subgroup 780. The multi-tier hierarchical system 700 shows two playback groups 740 and 760 for illustration purposes only. In practice, typical multi-tier hierarchical system implementations may include many more than two playback groups. Similarly, the multi-tier hierarchical system 700 shows one subgroup 780 for illustration purposes only. In practice, a playback group may include several subgroups.

Playback group 740 includes primary playback device 704 and secondary playback devices 704a and 704b. Primary playback device 704 may be the same as any of the primary playback devices disclosed and described herein. Similarly, secondary playback devices 704a and 704b may be the same as or similar to any of the secondary playback devices disclosed described herein.

Playback group 760 includes primary playback device 706 and secondary playback devices 706a and 706b. Primary playback device 706 may be the same as any of the primary playback devices disclosed and described herein. Similarly, secondary playback devices 706a and 706b may be the same as or similar to any of the secondary playback devices disclosed described herein.

Playback group 740 includes two secondary playback devices 704a and 704b, and playback group 760 includes two secondary playback devices 706a and 706b for illustration purposes only. In practice, typical playback group implementations may include many more than two secondary playback devices.

Subgroup 780 includes secondary playback device 706a and tertiary playback devices 706a1 and 706a2. Secondary playback device 706a is configured to operate as a subgroup primary for subgroup 780. Tertiary playback devices 706a1 and 706a2 may be the same as or similar to any of the playback devices disclosed described herein.

In operation, the functions that a playback device (e.g., secondary playback device 706a) performs while configured to operate as the subgroup primary for a subgroup (e.g., subgroup 780) are similar to the functions that a playback device performs while configured to a operate as a primary playback device for a playback group.

The arrows in FIG. 7 illustrate how data flows between individual playback devices within the playback system. The data flows shown in FIG. 7 are independent of the underlying network infrastructure via which playback devices transmit the data among each other. For example, the network infrastructure supporting the transmission of data between two playback devices within the playback system 700 shown in FIG. 7 can be any type of network infrastructure now known or later developed that is suitable for transmitting data between playback devices.

In some example configurations, the network infrastructure supporting the data transmissions shown in FIG. 7 comprises any one or more of (i) any type of wired network infrastructure now known or later developed that is suitable for transmitting data between and among playback devices and/or (ii) any type of wireless network infrastructure now known or later developed that is suitable for transmitting data between and among playback devices.

### A. Audio Sourcing Device to Primary Playback Device Communications

FIG. 7 shows aspects of communications between the audio sourcing device 702 and the primary playback devices 704 and 706.

In the example configuration depicted in FIG. 7, audio sourcing device 702 is configured to obtain audio content 712 from audio source 708 via a wide area network 710.

The audio source 708 maybe the same as or similar to any of the audio sources disclosed and described herein.

Although FIG. 7 depicts audio source 708 as providing audio content 712 via a wide area network connection 710, in other configurations, audio source 708 may reside on the same local area network (LAN) as the audio sourcing device 702. In still further example configurations, audio source 708 maybe a component of audio sourcing device 702. In some example configurations, audio source 708 may be connected to one of the primary playback devices 704 and 706, and the audio sourcing device 702 may obtain audio from the audio source 708 via the primary playback device to which the audio source is connected. In other example configurations, audio source 708 may be a component of primary playback device 704 or primary playback device 706, or perhaps a component of a different playback device.

As mentioned earlier, in some configurations, audio sourcing device 702 comprises or is a component of a playback system coordinator that is configured to both (i) distribute audio content and system playback timing to primary playback devices 704 and 706 in the playback system, and (ii) control other aspects of the playback system operation.

In operation, audio sourcing device 702 receives the audio content 712 and processes the audio content 712 in the manner described herein, i.e., arranging received packets based upon timestamps, extracting audio content from the received packets, repackaging the extracted audio content into frames, and so on.

Audio sourcing device 702 also uses reference clock timing to generate system playback timing for the audio content extracted from the audio data 712 received from the audio source 708, and generates a series of frames (or packets) comprising the extracted audio content and system playback timing in any of the manners described herein.

In the example configuration shown in FIG. 7, the audio sourcing device 702 comprises the reference clock. However, in other configurations, a computing device separate from the audio sourcing device 702 may comprise the reference clock and provide reference clock timing information to the audio sourcing device 702 and the primary playback devices 704 and 706.

After generating frames (or packets) comprising the audio content and the system playback timing for the audio content, audio sourcing device 702 transmits a data stream of the frames (or packets) comprising the audio content and system playback timing to each of the primary playback devices 704 and 706 within the playback system 700. For example, as shown in FIG. 7, audio sourcing device 702 transmits data stream 714a (comprising audio content and system playback timing) to primary playback device 704 via a unicast transmission, and audio sourcing device 702 transmits data stream 714b (comprising audio content and system playback timing) to primary playback device 706.

In the example configuration shown in FIG. 7, audio sourcing device 702 transmits the audio content and system playback timing via a unicast transmission to primary playback device 704, and audio sourcing device 702 transmits the audio content and system playback timing via a separate unicast transmission to primary playback device 706. However, in other configurations, audio sourcing device 702 may instead transmit the audio content and the system playback timing to a multicast address corresponding to a multicast group for the audio content and system playback timing. In such configurations, primary playback device 704 and primary playback device 706 each subscribe to the multicast group for the audio content and system playback timing, and both primary playback device 704 and primary playback device 706 receive the audio content and system playback timing via the multicast address corresponding to the multicast group.

As shown in FIG. 7, audio sourcing device 702 does not transmit audio content and system playback timing directly to secondary playback devices in playback groups 740 and 760. Instead, as described in more detail herein, primary playback device 704 transmits audio content and playback timing (i.e., group playback timing for playback group 740) to the secondary playback devices within playback group 740, and primary playback device 706 transmits audio content and playback timing (i.e., group playback timing for playback group 760) to the secondary playback devices within playback group 760.

In addition to transmitting audio content and system playback timing to the primary playback devices 704 and 706, the audio sourcing device 702 also exchanges configuration and control messaging 722 and 724 with the primary playback devices 704 and 706. The primary playback devices 704 and 706 also exchange configuration and control messaging 726 with each other.

For example, the configuration and control messaging 722, 724, 726 exchanged between and among the primary playback devices 704 and 706 and the audio sourcing device 702 includes (i) messaging relating to network latency and packet processing times upon which the audio sourcing device 702 determines the timing advance that it uses for generating the system playback timing, (ii) reference clock timing information that (a) the primary playback device 704 uses for determining its timing offset relative to the reference clock (i.e., between the clock at the primary playback device 704 and the reference clock at the audio sourcing device 702) that the primary playback device 704 in turn uses for generating group playback timing for playback group 740 (which is based on the system playback timing received from the audio sourcing device 702), (b) the primary playback device 706 uses for determining its timing offset relative to the reference clock (i.e., between the clock at the primary playback device 706 and the reference clock at the audio sourcing device 702) that the primary playback device 706 in turn uses for generating group playback timing for playback group 760 (which is based on the system playback timing received from the audio sourcing device 702), (iii) messaging relating to current network conditions experienced by the audio sourcing device 702 and the primary playback devices 704 and 706, (iv) messaging relating to current operating status information for the primary playback devices 704 and 706 and the audio sourcing device 702, and/or (vi) any other configuration and control messaging.

In some configurations, the configuration and control messaging 722, 724, 726 exchanged between and among the primary playback devices 704 and 706 and the audio sourcing device 702 enables individual primary playback devices to perform certain functions on behalf of the secondary playback devices within that individual primary playback device's playback group. For example, the primary playback device in some scenarios may be configured to repackage the audio content and group playback timing into a format more easily processed by the secondary devices, e.g., by (i) decompressing and/or decoding the audio content for one or more secondary playback devices in the playback group so that each such secondary playback device does not need to decompress and/or decode the audio content, and (ii) generating individualized playback timing for one more individual secondary playback devices in the playback group by incorporating each secondary playback device's specific “timing offset” into the individualized playback timing generated and transmitted to that individual secondary playback device so that that individual secondary playback device can play the audio content according to its individualized playback timing received from the primary playback device rather than determining its own individualized playback timing based on the group playback timing and its own individual “timing offset” relative to the primary playback device. Configuring the primary playback device to perform these and perhaps other functions on behalf of secondary playback devices within the playback group may in some instances enable playback groups to be implemented with lower-cost secondary playback devices having fewer processing capabilities than implementations where the playback groups are implemented with fully-featured secondary playback devices. Aspects of one playback device performing certain functions on behalf of another playback device are described in U.S. application Ser. No. 17/508,028, titled “Techniques for Enabling Interoperability between Media Playback Systems,” filed on Oct. 22, 2021, and currently pending. The entire contents of U.S. application Ser. No. 17/508,028 are incorporated herein by reference.

However, as shown in FIG. 7, audio sourcing device 702 does not transmit any configuration and control messaging directly to secondary playback devices in playback groups 740 and 760. Instead, as described in more detail herein, primary playback device 704 exchanges configuration and control messaging with the secondary playback devices in playback group 740, and primary playback device 706 exchanges configuration and control messaging with the secondary playback devices in playback group 760.

### B. Primary Playback Device to Secondary Playback Device Communications

FIG. 7 shows aspects of communications between and among primary playback devices and secondary playback devices within playback groups 740 and 760. For illustration purposes, playback group 740 is configured differently than playback group 760 in that playback group 740 is configured for unicast distribution of audio content and group playback timing whereas playback group 760 is configured for multicast distribution of audio content and group playback timing. However, in some configurations, playback groups could be configured more similarly to each other rather than differently from each other.

i. Unicast Playback Group

Playback group 740 includes primary playback device 704 and secondary playback devices 704a and 704b. As mentioned above, playback group 740 is depicted with only two secondary playback devices but in practice, a typical playback group could have more than two secondary playback devices, and in some instances, many more than two secondary playback devices.

Primary playback device 704 transmits audio content and group playback timing to secondary playback devices 704a and 704b. In operation, primary playback device 704 generates group playback timing for the playback group 740 according to the group playback timing generation procedures described above.

In the example shown in FIG. 7, primary playback device 704 transmits data stream 742a comprising audio content and group playback timing via a unicast transmission to secondary playback device 704a, and primary playback device 704 transmits data stream 742b comprising audio content and group playback timing via a unicast transmission to secondary playback device 704b. However, primary playback device 704 could alternatively transmit audio content and group playback timing to secondary playback devices 704a and 704b via one or more multicast (e.g., as in playback group 760) and/or broadcast transmissions instead.

In addition to the audio content and group playback timing, primary playback device 704 also exchanges (i) configuration and control messaging 744 with secondary playback device 704a, and (ii) configuration and control messaging 746 with secondary playback device 704b.

For example, the configuration and control messaging 744 exchanged between the primary playback device 704 and the secondary playback device 704a includes messaging relating to network latency and packet processing times relative to the secondary playback device 704a. The primary playback device 704 uses data relating to network latency and packet processing relative to the secondary playback device 704a in connection with the messaging 722 that (i) the primary playback device 704 exchanges with the audio sourcing device 702 and (ii) on which the audio sourcing device 702 bases the timing advance that the audio sourcing device 702 uses for generating the system playback timing.

The configuration and control messaging 744 exchanged between and the primary playback device 704 and the secondary playback device 704a also includes clock timing information for the primary playback device clock. Recall that the primary playback device clock is or comprises a clock (e.g., hardware, software, or other suitable clock) at the primary playback device 704 that the primary playback device 704 uses for generating the group playback timing, and in some instances, also uses for playing audio content in a groupwise fashion with the other playback devices in the playback group 740.

In operation, the secondary playback device 704a uses the clock timing information for the primary playback device clock to determine the timing offset between the primary playback device clock and a clock at the secondary playback device 704a that the secondary playback device 704a uses for playing audio content (sometimes referred to herein as the secondary playback device clock). As explained above, the secondary playback device 704a uses this determined timing offset (i.e., between the primary playback device clock and the secondary playback device clock) to adjust the group playback timing that it receives from the primary playback device 704 in connection with playing audio based on the audio content and the group playback timing received from the primary playback device 704. In particular, the secondary playback device 704a adds its timing offset to the group playback timing to generate its own local playback timing for the audio content received from the primary playback device 704. To play an individual frame of audio content, the secondary playback device 704a plays the audio in the individual frame when the time of the secondary playback device clock reaches the local playback time (i.e., the group playback time adjusted by the secondary playback device's 704a timing offset) for that frame of audio content.

In some configurations, the secondary playback device 704a additionally adjusts the sample rate of the audio content based one or more timing differences between the secondary playback device clock (at 704a) and the primary playback device clock (at 704) in connection with playing the audio content. As explained earlier, in addition to determining the difference between the secondary playback device clock and the primary playback device clock (and/or vice versa), the secondary playback device 704a may additionally determine any of (i) a difference between the clock rate of the secondary playback device clock (at 704a) and the primary playback device clock (at 704) (and/or vice versa), and (iii) whether and the extent to which the clock rate of the primary playback device clock (at 704) has drifted relative to the clock rate of the secondary playback device clock (at 704a) (and/or vice versa). If the secondary playback device 704a determines that the secondary playback device clock (at 704a) is running faster than the primary playback device clock (at 704) (i.e., the clock rate of the secondary playback device clock (at 704a) is greater than the clock rate of the primary playback device clock (at 740)), then the secondary playback device 704a may inject a small period of silence during playback of an individual frame of audio content to account for the clock rate difference. Conversely, if the secondary playback device clock (at 704a) is running slower than the primary playback device clock (at 704) (i.e., the clock rate of the secondary playback device clock is less than the clock rate of the primary playback device clock), then the secondary playback device 704a may drop (not play) one or more audio samples during playback of an individual frame of audio content to account for the clock rate difference.

The configuration and control messaging 744 exchanged between and the primary playback device 704 and the secondary playback device 704a may also include (i) messaging relating to current network conditions experienced by the secondary playback device 704a and the primary playback device 704, (ii) messaging relating to current operating status information for the primary playback device 704 and the secondary playback device 704a, (iii) playback control commands for the secondary playback device 704a such as volume control and/or track playback start/stop/pause, and/or (iv) any other configuration and control messaging.

As mentioned above, primary playback device 704 also exchanges configuration and control messaging 746 with secondary playback device 704b.

For example, similar to the configuration and control messaging 744 exchanged between the primary playback device 704 and the secondary playback device 704a, the configuration and control messaging 746 exchanged between the primary playback device 704 and the secondary playback device 704b includes messaging relating to network latency and packet processing times relative to the secondary playback device 704b. The primary playback device 704 uses data relating to network latency and packet processing relative to the secondary playback device 704b in connection with the messaging 722 that (i) the primary playback device 704 exchanges with the audio sourcing device 702 and (ii) on which the audio sourcing device 702 bases the timing advance that the audio sourcing device 702 uses for generating the system playback timing.

More specifically, the primary playback device 704 uses the network latency and processing time information obtained from messaging 744 exchanged with secondary playback device 704a and messaging 746 exchanged with playback device 704b in connection with providing network latency and processing times (for the playback group 740) to audio sourcing device 702 via messaging stream 722. And the audio sourcing device 702 uses the network latency and processing time information for the playback group 740 (in combination with similar network latency and processing time information for playback group 760) to help determine (including determining and/or updating on an ongoing basis) the timing advance that the audio sourcing device 702 will use to generate the system playback timing for the audio content that that audio sourcing device 702 provides to the primary playback devices 704 and 706.

And similar to the configuration and control messaging 744 exchanged between the primary playback device 704 and the secondary playback device 704a, the configuration and control messaging 746 exchanged between and the primary playback device 704 and the secondary playback device 704b also includes clock timing information for the primary playback device clock. Recall that the primary playback device clock is or comprises a clock (e.g., hardware, software, or other suitable clock) at the primary playback device 704 that the primary playback device 704 uses for generating the group playback timing, and in some instances, also uses for playing audio content in a groupwise fashion with the other playback devices in the playback group 740.

In operation, the secondary playback device 704b uses the clock timing information for the primary playback device clock (at 704) to determine the timing offset between the primary playback device clock (at 704) and a clock at the secondary playback device 704b that the secondary playback device 704b uses for playing audio content (sometimes referred to herein as the secondary playback device clock). As explained above with reference to the secondary playback devices generally and second playback device 704a in particular, the secondary playback device 704b uses this determined timing offset (i.e., between the primary playback device clock (at 704) and the secondary playback device clock (at 704b)) to adjust the group playback timing that the secondary playback device 704b receives from the primary playback device 704 in connection with playing audio based on (i) the audio content and (ii) the group playback timing received from the primary playback device 704. In particular, the secondary playback device 704b adds its timing offset to the group playback timing to generate its own local playback timing for the audio content received from the primary playback device 704. To play an individual frame of audio content, the secondary playback device 704b plays the audio content in the individual frame when the time of the secondary playback device clock reaches the local playback time (i.e., the group playback time adjusted by the secondary playback device's 704b timing offset) for that frame of audio content.

In some configurations, the secondary playback device 704b additionally or alternatively adjusts the sample rate of the audio content based one or more timing differences between the secondary playback device clock (at 704b) and the primary playback device clock (at 740) in connection with playing the audio content in the same way as described above with reference to secondary playback device 704a.

And like the configuration and control messaging 744 exchanged between and the primary playback device 704 and the secondary playback device 704a, the configuration and control messaging 746 exchanged between and the primary playback device 704 and the secondary playback device 704b may also include (i) messaging relating to current network conditions experienced by the secondary playback device 704b and the primary playback device 704, (ii) messaging relating to current operating status information for the primary playback device 704 and the secondary playback device 704b, (iii) playback control commands for the secondary playback device 704b such as volume control and/or track playback start/stop/pause, and/or (iv) any other configuration and control messaging.

For example, with respect to playback control commands for the secondary playback devices 704a and 704b such as volume control and/or track playback start/stop/pause, some configurations include the primary playback device 704 controlling the volume of secondary playback devices 704a and 704b via the command and control messaging 744 and 746 between the primary playback device 704 and the secondary playback devices 704a and 704b, respectively.

In some instances, the primary playback device 704 generates the volume control commands for the secondary playback devices 704a and 704b, and sends those generated volume control commands to the secondary playback devices 704a and 704b within the configuration and control signaling 744 and 746, respectively. In other instances, the primary playback device 704 relays volume control commands received from a playback system controller to the secondary playback devices 704a and 704b. For example, instead of generating the volume control commands, the primary playback device 704 receives one or more volume control commands for one or both of the secondary playback device 704a and/or 704b from a playback system controller (or perhaps another controller device), and the primary playback device 704 relays (e.g., forwards) the command(s) to the appropriate secondary playback device.

In some scenarios, when the primary playback device 704 receives a group volume adjustment command (i.e., a command to adjust the playback volume of the entire playback group 740 in a groupwise manner, e.g., volume up/down, mute, and so on), the primary playback device 704 in some configurations generates and transmits individual volume adjustment commands to the secondary playback devices 704a and 704b based on the group volume adjustment command. In some instances, the individual volume adjustment commands sent to the individual secondary playback devices 704a and 704b include group command timing similar to the group playback timing. In operation, the secondary playback devices 704a and 704b execute their respective volume adjustment commands received from the primary playback device 704 based on the command timing, thereby effectuating groupwise volume control of the playback group 740.

ii. Multicast Playback Group

Playback group 760 includes primary playback device 706 and secondary playback devices 706a and 706b. As mentioned above, playback group 760 is depicted with only two secondary playback devices but in practice, a typical playback group could have more than two secondary playback devices, and in some instances, many more than two secondary playback devices.

Primary playback device 706 transmits audio content and group playback timing to secondary playback devices 706a and 706b. In operation, primary playback device 706 generates group playback timing for the playback group 760 according to any of the group playback timing generation procedures described herein.

In contrast to playback group 740, audio content and group playback timing for playback group 760 is distributed within the playback group 760 via a multicast scheme. In particular, rather than transmitting separate unicast streams comprising audio content and group playback timing to each secondary playback device individually as with playback group 740, the primary playback device 706 for playback group 760 instead transmits (multicasts) one stream 762 comprising audio content and group playback timing to a multicast address for a multicast group 768, where secondary playback devices 706a and 706b are members of the multicast group 768. Because both secondary playback devices 706a and 706b are members of the multicast group 768, both secondary playback devices 706a and 706b are able to receive the audio content and group playback timing via the same stream 762 that is multicast by the primary playback device 706. However, primary playback device 706 could alternatively transmit audio content and group playback timing to secondary playback devices 706a and 706b via individual unicast transmissions (e.g., as in playback group 740) and/or broadcast transmissions instead.

In addition to the audio content and group playback timing, primary playback device 706 also exchanges (i) configuration and control messaging 764 with secondary playback device 706a, and (ii) configuration and control messaging 766 with secondary playback device 706b.

In operation, the configuration and control messaging 746 exchanged between the primary playback device 706 and the secondary playback device 706a (and the configuration and control messaging 766 exchanged between the primary playback device 706 and the secondary playback device 706b) is substantially the same as the configuration and control messaging 744 and 746 described with reference to playback group 740.

For example, just like the secondary playback devices 704a and 704b in playback group 740 exchanged configuration and control messaging 744 and 746 with primary playback device 704, respectively, to share network latency and processing times, to determine timing offsets (i.e., timing differences between secondary playback device clocks and the primary playback device clock), and control volume and playback in a groupwise fashion, the secondary playback devices 706a and 706b in playback group 760 similarly exchange configuration and control messaging 764 and 766 with primary playback device 706, respectively, to share network latency and processing times, to determine timing offsets (i.e., timing differences between secondary playback device clocks and the primary playback device clock), and to control volume and playback in a groupwise fashion in the same or substantially the same way. Thus, the details relating to sharing network latency and processing times, sharing clock timing information (e.g., primary playback clock time) for determining timing offsets (and the use of timing offsets, clock rate differences, and/or clock drift in connection with playing audio in a groupwise manner), and groupwise control of volume and playback are not repeated again here.

However, the configuration and control messaging 764 and 766 exchanged between the secondary playback devices 706a and 706b and the primary playback device 706 in playback group 760 additionally includes messaging for managing aspects of the multicast group 768 via which the primary playback device 706 distributes the audio content and group playback timing to the secondary playback devices 706a and 706b. For example, messaging for managing aspects of the multicast group 768 may include messaging relating to joining the multicast group 768, leaving the multicast group 768, updating information for the multicast group 768, and/or any other function relating to managing and operating the multicast group 768.

### C. Subgroup Primary to Tertiary Playback Device Communications

Subgroup 780 includes subgroup primary 706a (which is a secondary playback device within playback group 760) and tertiary playback devices 706a1 and 706a2. As mentioned above, subgroup 780 is depicted with only two tertiary playback devices but in practice, a typical subgroup could have more than two tertiary playback devices, and in some instances, many more than two tertiary playback devices.

Subgroup primary 706a transmits audio content and subgroup playback timing to tertiary playback devices 706a1 and 706a2. In operation, subgroup primary 706a generates subgroup playback timing for the subgroup 780 according to any of the subgroup playback timing generation procedures described herein.

Audio content and subgroup playback timing for subgroup 780 is distributed within the subgroup 780 via a multicast scheme. However, in other scenarios, audio content and subgroup playback timing could be distributed within a subgroup via a unicast scheme similar to the unicast distribution scheme shown and described with reference to playback group 740.

In subgroup 780, rather than transmitting separate unicast streams comprising audio content and group playback timing to each tertiary playback device individually, the subgroup primary 706a for subgroup 780 instead transmits (multicasts) one stream 782 comprising audio content and subgroup playback timing to a multicast address for a multicast group 788, where tertiary playback devices 706a1 and 706a2 are members of the multicast group 788. Because both tertiary playback devices 706a1 and 706a2 are members of the multicast group 788, both tertiary playback devices 706a1 and 706a2 are able to receive the audio content and subgroup playback timing via the same stream 782 that is multicast by the subgroup primary 706a. However, subgroup primary 706a could alternatively transmit audio content and subgroup playback timing to tertiary playback devices 706a1 and 706a2 via individual unicast transmissions (e.g., similar to the scheme shown and described with reference to playback group 740) and/or broadcast transmissions instead.

In addition to the audio content and group playback timing, subgroup primary 706a also exchanges (i) configuration and control messaging 784 with tertiary playback device 706a1, and (ii) configuration and control messaging 786 with tertiary playback device 706a2.

In operation, the configuration and control messaging 786 exchanged between the subgroup primary 706a and the tertiary playback device 706a2 (and the configuration and control messaging 784 exchanged between the subgroup primary 706a and the tertiary playback device 706a1) is substantially the same as the configuration and control messaging 764 and 744 described with reference to playback group 760.

For example, just like the secondary playback devices 706a and 706b in playback group 760 exchanged configuration and control messaging 764 and 766 with primary playback device 706, respectively, to share network latency and processing times, to determine timing offsets (i.e., timing differences between secondary playback device clocks at 706a and 706b and the primary playback device clock at 706), and control volume and playback in a groupwise fashion, the tertiary playback devices 706al and 706a2 in subgroup 780 similarly exchange configuration and control messaging 786 and 784 with subgroup primary 706a, respectively, to share network latency and processing times, to determine timing offsets (i.e., timing differences between tertiary playback device clocks and the subgroup primary clock), and to control volume and playback in a groupwise fashion in the same or substantially the same way. Thus, the details relating to sharing network latency and processing times, sharing clock timing information (e.g., subgroup primary clock time) for determining timing offsets between the subgroup primary 706a and the tertiary playback devices 706a1, 706a2 (and the use of timing offsets, clock rate differences, and/or clock drift in connection with playing audio in a groupwise manner), and groupwise control of volume and playback are not repeated again here.

Additionally, because the subgroup primary 706a distributes the audio content and subgroup playback timing 782 to the tertiary playback devices 706a1, 706a2 via a multicasting scheme, the configuration and control messaging 786 and 784 exchanged between the tertiary playback devices 706a1 and 706a2 and the subgroup primary 706a in subgroup 780 also includes messaging for managing aspects of the multicast group 788 via which the subgroup primary 706a distributes the audio content and subgroup playback timing to the tertiary playback devices 706a1 and 706a2. For example, messaging for managing aspects of the multicast group 788 may include messaging relating to joining the multicast group 788, leaving the multicast group 788, updating information for the multicast group 788, and/or any other function relating to managing and operating the multicast group 788.

### D. Primary Playback Device Selection

In some example configurations, playback devices within a playback group are additionally configured to determine which playback device should function as the primary playback device for the playback group. By determining which playback device should function as the primary playback device for the playback group, selecting a primary playback device effectively also determines which playback devices will function as secondary playback devices in the playback group.

The ability to self-organize a playback group by selecting a primary playback device can be advantageous both when initially setting up a playback system as well as scenarios where networking and/or power disruptions may cause at least temporary playback network or playback group instabilities.

In some instances, self-organization is facilitated by individual playback devices that are configured to store their particular playback configuration settings in persistent memory so that the playback device can more quickly resume its operating role in the hierarchical network architecture after a disruption.

For example, if playback devices 704, 704a, and 704b each store an indication of their membership in playback group 740 in their respective persistent memories, then when attempting to recover stable playback group operations after an interruption, each of the playback devices 704, 704a and 704b will at least know their playback group membership in playback group 740.

In some example configurations, each of the playback devices 704, 704a and 704b could perhaps additionally store further configuration details in persistent memory. For example, in situations where the playback devices 704, 704a and 704b each store their playback roles, then restart may be simple. Each playback device can resume its prior role in the playback group before the disruption (i.e., primary playback device or secondary playback device).

However, if the disruption was caused by a failure of the playback device that was previously performing the primary playback device role, then some example configurations include playback devices selecting a new primary playback device.

Some ways to select a primary playback device for the playback group 740 are based on the hardware MAC addresses of the individual playback devices within the playback group 740.

For example, once the playback devices within the playback group 740 are able to communicate with each other, the playback devices can nominate the playback device having the lowest MAC address (or alternatively the highest MAC address) as the prospective primary playback device. In some example configurations, once an individual playback device has been nominated as the prospective primary playback device, this first nominated playback device can assess whether it has (i) satisfactory network connectivity with all of the other playback devices within the playback group 740, (ii) satisfactory network connectivity with the audio sourcing device 702, and (iii) sufficient data processing capability to perform the primary playback device role for the playback group 740.

If the first nominated playback device determines that it has the satisfactory network connectivity and sufficient data processing capability to perform the primary playback device role for the playback group 740, then the first nominated playback device assumes the primary playback device role for the playback group 740. But if the first nominated playback device determines that it lacks either the sufficient network connectivity or sufficient data processing capability to perform the primary playback device role for the playback group 740, then the first nominated playback device can inform the other playback devices within the playback group 740 that it is unable to assume the primary playback device role.

After the first nominated playback device has informed the other playback devices within the playback group 740 that it is unable to assume the primary playback device role for the playback group 740, the playback device having the next highest MAC address (or alternatively next lowest MAC address) can then be nominated as the prospective primary playback device.

Once nominated, this second nominated playback device similarly determines whether it has satisfactory network connectivity and sufficient computing resources to function as the primary playback device for the playback group 740. And if the second nominated playback device determines that it has satisfactory network connectivity and sufficient computing resources, then the second nominated playback device will assume the primary playback device role for the playback group 740. But if not, the process can continue by nominating another playback device which performs the networking and computing assessments to determine whether it is capable to perform the primary playback device role until a playback device with satisfactory network connectivity and sufficient computing resources to perform the primary playback device role is identified.

Although the example described above uses MAC addresses to nominate playback devices as potential primary playback devices, other example configurations may nominate playback devices based on different information such as the playback device name, the playback device type, the playback device age, or the playback device serial number.

Similarly, other example configurations may rely on different nomination procedures, such as random number generation, greatest processing capabilities, best network metrics, or other selection mechanisms suitable for selecting a primary playback device for a playback group. Further, other example configurations may use combinations of one or more of the above-listed metrics to initially nominate a playback device as the perspective primary playback device for the playback group 740.

Although the primary playback device selection procedures are described above with reference to playback group 740 for illustration purposes, the playback devices within playback group 760 can follow the same or similar primary playback device selection procedures to select a primary playback device upon playback group startup or recovery from a playback group or playback system disruption.

### E. Subgroup Primary Selection

The ability to self-organize a subgroup by selecting a subgroup primary can be advantageous for many (and perhaps all) of the same reasons that the ability to self-organize a playback group by selecting a primary playback device, e.g., when initially setting up a playback system as well as scenarios where networking and/or power disruptions may cause at least temporary playback network or subgroup instabilities.

In operation, playback devices configured as tertiary playback devices within a subgroup can communicate among themselves to select a subgroup primary for the subgroup in substantially the same way that secondary playback devices within a playback group communicate among themselves to select a primary playback device for the playback group.

For example, in some configurations, individual tertiary playback devices with a subgroup coordinate among themselves to determine which tertiary playback device should operate as the subgroup primary for the subgroup based on one or more of (i) a measure of network latency between each tertiary playback device in the subgroup and the primary playback device of the playback group comprising the subgroup, (ii) a measure of transmission signal quality between each tertiary playback device in the subgroup and the primary playback device of the playback group comprising the subgroup, (iii) a measure of network latency between each tertiary playback device in the subgroup and each other tertiary playback device in the subgroup, (iv) a measure of transmission signal quality between each tertiary playback device in the subgroup and each other tertiary playback device in the subgroup, (v) a measure of each tertiary playback device's computing resources available for performing subgroup primary functions, and/or (vi) each tertiary playback device's media access control (MAC) address.

Because some metrics for selecting a subgroup primary are related to aspects of the primary playback device of the playback group comprising the subgroup, some subgroup primary selection methods may require a playback group to complete its primary playback selection process before the subgroup can begin its subgroup primary selection process.

### VI. Example Methods Relating to Hierarchical Playback System Architectures

FIG. 8 shows a method 800 according to some example configurations. Method 800 may be performed by any of the playback devices disclosed and described herein.

In method 800, method blocks 804 through 814 relate to functions performed by a playback device that is configured to operate as a primary playback device within a playback group, and method blocks 816 through 820 relate to functions performed by a playback device that is configured to operate as a secondary playback device with the playback group.

Optional method block 802 includes aspects of determining whether the playback device will function as a primary playback device or a secondary playback device with the playback group.

### A. Primary Playback Device Determination

Optional method block 802 includes a playback device determining whether the playback device will operate as the primary playback device for a playback group or a secondary playback device in the playback group. In operation, the playback device may determine whether it will operate as the primary playback device for a playback group according to any of the primary playback device selection and/or determination methods disclosed or described herein.

Method block 802 is optional in that, in some examples, a playback device may be configured to operate as a primary playback device (or configured to operate as a secondary playback device), and the playback device will operate according to its configuration without needing to make any determination as to its role in the playback system.

In other configurations, the playback device may be configured to operate as a primary playback device (or secondary playback device) in a playback group, but then some disruption, interruption, or other change in the configuration or operation of the playback group and/or playback system may create a scenario where it may be advantageous for the playback device to reconsider its playback role in a playback group.

When the playback device determines that it will operate as the primary playback device for a playback group, method 800 advances to block 804. But when the playback device determines that it will operate as a secondary playback device for the playback group (or if the playback device does not determine that it will operate as the primary playback device for the playback group because some other playback device is already functioning as the primary playback device for the playback group), then method 800 advances to block 816.

In some configurations, the playback device determining whether it will operate as the primary playback device for the playback group at optional block 802 includes the playback device coordinating with one or more (or all) of the other playback devices in the playback group to determine which playback device should operate as the primary playback device for the playback group.

In some instances, the determination of which playback device should operate as the primary playback device for the playback group is based on one or more of (i) a measure of network latency between each playback device in the playback group and the playback system coordinator (e.g., configured to perform audio sourcing device functions), (ii) a measure of transmission signal quality between each playback device in the playback group and the playback system coordinator, (iii) a measure of network latency between each playback device in the playback group and each other playback device in the playback group, (iv) a measure of transmission signal quality between each playback device in the playback group and each other playback device in the playback group, (v) a measure of each playback device's computing resources available for performing primary playback device functions, (vi) each playback device's media access control (MAC) address, and/or (v) any combination of the above-listed factors.

### B. Primary Playback Device Operation

Method blocks 804 through 814 correspond to functions performed by a playback device while the playback device is configured to operate as a primary playback device for the playback group comprising two or more playback devices.

Method block 804 includes, after the primary playback device has received reference clock timing information from a reference clock, the primary playback device determining a timing offset between a clock time of the primary playback device clock and a clock time of the reference clock. The reference clock may be the same as or similar to any of the reference clock examples disclosed and described herein. For example, in some configurations, the reference clock comprises one of (i) a clock at the playback system coordinator or (ii) a playback system clock.

For illustration purposes and ease of explanation, in the context of example method 800, a playback system coordinator (i) comprises the reference clock and (ii) performs the audio sourcing device functions. However, as described previously, in other configurations, the reference clock functionality, the audio sourcing device functionality, and/or the playback system coordinator functionality may be performed by separate networked computing devices.

In some configurations, determining the timing offset at method block 804 includes the primary playback device exchanging clock timing messaging with the playback system coordinator (which includes the reference clock).

For example, in some configurations, the primary playback device first receives an indication of a current clock time (t₁) of the reference clock at the playback system coordinator that the playback system coordinator uses to generate system playback timing. For ease of discussion, the reference clock that playback system coordinator uses to generate system playback timing is referred to as the playback system coordinator clock in this example.

Second, after receiving the indication of a current clock time (t₁) of the playback system coordinator clock, the primary playback device (i) records a receipt time (t₂) of the primary playback device clock of when the primary playback device received the indication of the current clock time (t₁) of the playback system coordinator clock.

Third, the primary playback device transmits a delay request message to the playback system coordinator. In some instances, the delay request message comprises an identifier corresponding to the delay request message. This identifier facilitates correlation of the delay messages transmitted to the playback system coordinator with corresponding delay responses received from the playback system coordinator.

Fourth, the primary playback device receives a delay request response from the playback system coordinator in response to the delay request message. The delay response comprises an indication of a time (t₃) when the playback system coordinator transmitted the delay request response to the primary playback device. After receiving the delay request response from the playback system coordinator, the primary playback device records a receipt time (t₄) of the primary playback device clock of when the primary playback device received the delay request response from the playback system coordinator. Next, the primary playback devices calculates the timing offset between the primary playback device clock and the playback system coordinator clock based on t₁, t₂, t₃, and t₄. In some configurations, the primary playback device calculates the timing offset according to the equation ((t₂−t₁)+(t₄−t₃))/2.

Next, method 800 advances to block 806 which includes the playback device receiving a first series of frames from the playback system coordinator. The first series of frames comprises (i) audio content and (ii) system playback timing for the audio content. As mentioned earlier, in the context of example method 800, the playback system coordinator is configured to perform the audio sourcing device functions, including (i) sourcing audio content, (ii) generating system playback timing for the audio content, and (iii) transmitting frames comprising audio content and system playback timing to primary playback devices within the playback system.

In operation, the audio content may be any type of audio content disclosed and described herein. Similarly, the system playback timing is the same as or similar to the system playback timing previously disclosed and described herein. For example, in some configurations, the playback timing generated by the playback system coordinator for an individual portion of audio content in the first series of frames is (or comprises) a future time that is a first duration of time ahead of a current clock time of the reference clock (at the playback system controller in example method 800) at the time that the playback system coordinator generated the system playback timing for that individual portion of audio content.

In some example configurations, the primary playback device receives the first series of frames from the playback system coordinator via one of or more of (i) a multicast transmission from the playback system coordinator via a wireless Local Area Network (LAN), (ii) a unicast transmission from the playback system coordinator via the wireless LAN, (iii) a multicast transmission from the playback system coordinator via a wired LAN, and/or (iv) a unicast transmission from the playback system coordinator via the wired LAN.

Next method 800 advances to block 806, which includes the primary playback device generating group playback timing for its playback group. The group playback timing for the audio content is based on the system playback timing received from the playback system coordinator and the timing offset between the clock time of the primary playback device clock and the clock time of the reference clock (at the playback system coordinator) that was determined at method block 804. In operation, the primary playback device may generate the group playback timing according to any of the group playback timing generation methods disclosed herein.

Next, method 800 advances to block 810, which includes the primary playback device transmitting its playback device clock timing information (the primary playback device clock timing) to the one or more secondary playback devices of the playback group.

The primary playback device clock timing is the same clock timing that the primary playback device uses for generating the group playback timing. Recall that the secondary playback devices use the primary playback device clock timing to determine their own individual timing offsets relative to the primary playback device clock, thereby enabling the secondary playback devices to play the audio content based on the group playback timing in a groupwise fashion with all of the other playback devices within the playback group.

Method 800 next advances to block 812, which includes the primary playback device transmitting a second series of frames to the one or more secondary playback devices of the playback group. The second series of frames that the primary playback device transmits to the one or more secondary playback devices of the playback group in method block 812 is different than the first series of frames that the primary playback device received from the playback system coordinator in method block 806. The second series of frames that the primary playback device transmits to the one or more secondary playback devices of the playback group in method block 812 comprises the audio content and the group playback timing for the audio content (rather than the system playback timing).

In operation, the primary playback device may generate the group playback timing according to any of the group playback timing generation methods disclosed herein.

For example, in some configurations, the group playback timing for an individual frame (or packet) is (or corresponds to) the system playback timing for that individual frame (or packet) adjusted by the timing offset corresponding to the difference between (i) the reference clock that the playback system coordinator (performing the audio sourcing device function) used to generate the system playback timing and (ii) a clock at the primary playback device (i.e., the primary playback device clock).

In other example configurations, and as described previously herein, the group playback timing for an individual frame (or packet) is (or corresponds to) the system playback timing for that individual frame (or packet) adjusted by (i) the timing offset corresponding to the difference between (a) the reference clock that the playback system coordinator used to generate the system playback timing and (b) the clock at the primary playback device, and (ii) a group timing advance that corresponds to a future time relative to the current clock time of the primary playback device. Adding an additional group timing advance when generating the group playback timing may in some instances better enable the playback devices in the playback group play the audio content together in a groupwise fashion, particularly when the group playback timing without the additional group timing advance may not provide much time for the secondary playback devices to receive, process, and play the audio content according to the group playback timing absent the additional group timing advance added by the primary playback device.

In some example configurations, the primary playback device transmitting the second series of frames from the primary playback device to the one or more secondary playback devices of the playback group at method block 812 includes the primary playback device transmitting the second series of frames to the one or more secondary playback devices of the playback group via one or more of (i) a multicast transmission to the one or more secondary playback devices via the wireless Local Area Network (LAN), (ii) a unicast transmission to the one or more secondary playback devices via the wireless LAN, (iii) a multicast transmission to the one or more secondary playback devices via a wired LAN, and/or (iv) a unicast transmission to the one or more secondary playback devices via the wired LAN.

Method 800 next advances to optional block 814, which includes the primary playback device playing the audio content in a groupwise fashion with the one or more secondary playback devices of the playback group based on the group playback timing and the primary playback device clock. Method block is 814 is optional because the primary playback device may not necessarily play the audio content in all configurations. But in example configurations where the primary playback device is configured to play the audio content in the groupwise fashion with the other playback devices in the playback group, the primary playback device plays the audio content based upon the group playback timing and the primary playback device clock according to any of the playback methods disclosed herein. For example, in some configurations, the primary playback device playing the audio content in the groupwise fashion with the one or more secondary playback devices of the playback group based on the group playback timing and the playback device clock at block 814 includes the primary playback device playing the audio content in synchrony with the one or more secondary playback devices of the playback group (and also perhaps with the playback system coordinator and/or other playback devices in the playback system) based on the group playback timing and the primary playback device clock.

Some embodiments of method 800 additionally include the primary playback device controlling or at least facilitating the control of certain playback group functions while the playback device is configured as the primary playback device for the playback group.

For example, in some configurations, the primary playback device is configured to receive, process, and/or execute group control messages and/or commands from one or both of (i) the playback system coordinator and/or (ii) a controller device (e.g., a smartphone, tablet, laptop, or other computing device) running a playback system control application.

In some examples, the primary playback device receives a playback command from either the playback system coordinator or from a controller device configured to control the playback system. And after receiving the playback command (or perhaps in response to receiving the playback command), the primary playback device transmits one or more group commands to the one or more secondary playback devices of the playback group to effectuate the playback command. In some instances, the playback command received by the primary playback device (and the corresponding group command generated by the primary playback device) comprises and/or corresponds to at least one of (i) a volume adjustment command, (ii) a start audio playback command, (iii) a stop audio playback command, or (iv) a pause audio playback command.

In some instances, the group command(s) sent to the individual secondary playback devices include group command timing similar to the group playback timing. In operation, the secondary playback devices execute functions corresponding to the group commands received from the primary playback device based on group command timing corresponding to the group commands, thereby effectuating groupwise execution of the playback command by the playback devices within the playback group.

### C. Secondary Playback Device Operation

Method blocks 816 through 820 correspond to functions performed by a playback device while the playback device is configured to operate as a secondary playback device for a playback group comprising two or more playback devices.

Method block 816 includes the secondary playback device determining a timing offset between a clock time of the secondary playback device clock and a clock time of the primary playback device clock based on primary playback device clock timing received from the primary playback device of the playback group of which the secondary playback device is a member.

In some configurations, determining the timing offset at method block 816 includes the secondary playback device exchanging clock timing messaging with the primary playback device. For example, in some configurations, the secondary playback device first receives an indication of a current clock time (t₁) of the primary playback device clock.

Second, after receiving the indication of the current clock time (t₁) of the primary playback device clock, the secondary playback device (i) records a receipt time (t₂) of the secondary playback device clock of when the secondary playback device received the indication of the current clock time (t₁) of the primary playback device clock.

Third, the secondary playback device transmits a delay request message to the primary playback device. In some instances, the delay request message comprises an identifier corresponding to the delay request message. This identifier facilitates correlation of the delay messages transmitted to the primary playback device with corresponding delay responses received from the primary playback device.

Fourth, the secondary playback device receives a delay request response from the primary playback device in response to the delay request message. The delay request response comprises an indication of a time (t₃) when the primary playback device transmitted the delay request response. After receiving the delay request response from the primary playback device, the secondary playback device records a receipt time (t₄) of the secondary playback device clock of when the secondary playback device received the delay request response from the primary playback device. Next, the secondary playback devices calculates the timing offset between the secondary playback device clock and the primary playback device clock based on t₁, t₂, t₃, and t₄. In some configurations, the secondary playback device calculates the timing offset according to the equation ((t₂−t₁)+(t₄−t₃))/2.

Next, method 800 advances to method block 818, which includes the secondary playback device receiving a series of frames from the primary playback device. The series of frames comprises (i) audio content and (ii) group playback timing for the audio content.

In some configurations, the secondary playback device receiving the series of frames comprising the audio content and the group playback timing from the primary playback device at method block 818 includes the secondary playback device receiving the series of frames via one or more of (i) a multicast transmission from the primary playback device via a wireless Local Area Network (LAN), (ii) a unicast transmission from the primary playback device via the wireless LAN, (iii) a multicast transmission from the primary playback device via a wired LAN, and/or (iv) a unicast transmission from the primary playback device via the wired LAN.

Next, method 800 advances to method block 820, which includes the secondary playback device playing the audio content in a groupwise fashion with one or more other playback devices within the playback group (including perhaps the primary playback device) based on the group playback timing and the secondary playback device clock. In operation, the secondary playback device may play the audio content based on the group playback timing and the secondary playback device clock according to any of the audio playback procedures disclosed and described herein.

For example, in some configurations, the secondary playback device playing the audio content at method block 820 includes the secondary playback device: (i) generating local playback timing for the audio content based on the group playback timing received at method block 818 and the timing offset (between the secondary playback device clock and the primary playback device clock) determined at method block 816; and (ii) playing the audio content in a groupwise fashion with one or more playback devices of the playback group based on the local playback timing and the secondary playback device clock.

In some example configurations, the secondary playback playing the audio content at method block 820 may additionally include the secondary playback device (i) generating sample-rate adjusted audio content by adjusting a sample rate of at least a portion of the audio content received at method block 818 to compensate for a difference between a clock rate of the secondary playback device clock and a clock rate of the primary playback device clock, at least when the clock rate of the secondary playback device clock differs from the clock rate of the primary playback device clock, and (ii) playing the sample-rate adjusted audio content in synchrony with one or more playback devices of the playback group based on the secondary playback device clock and the group playback timing information for the audio content.

VII. Example System Configurations with Area Zones

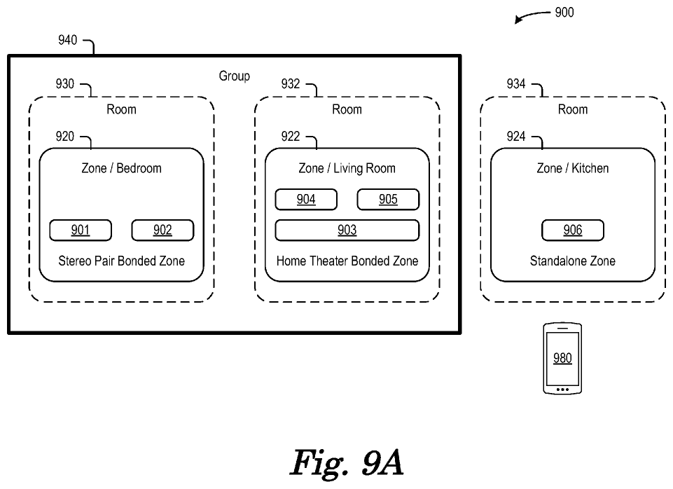

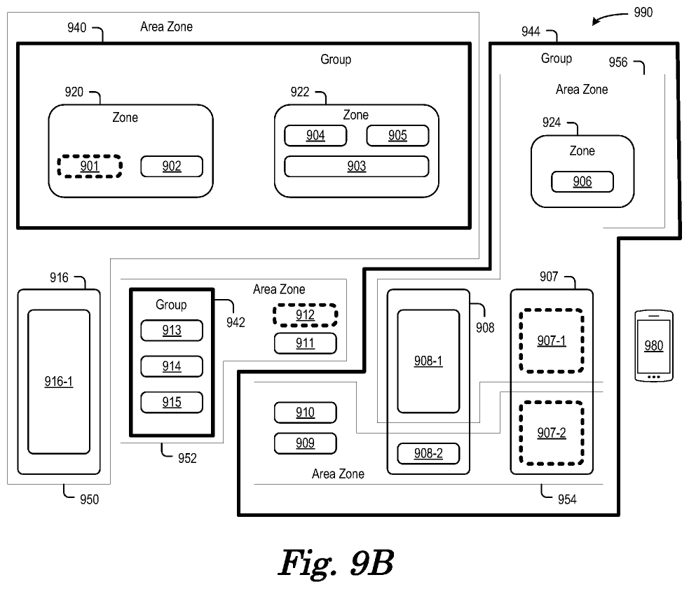

FIG. 9A shows a playback system 900 that includes playback devices 901-906 organized into zones 920-924 and a group 940 according to some example embodiments.

The playback devices 901-906 are similar to or the same as the playback devices disclosed and described elsewhere herein. Likewise, controller device 980 is similar to or the same as the controller devices disclosed and described elsewhere herein.

In FIG. 9A, playback devices 901 and 902 are located in room 930 and are configured into zone 920. Playback devices 903, 904, and 905 are located in room 932 and are configured into zone 922. And playback device 906 is located in room 934 and configured into zone 924. The rooms 930-934 are shown here to illustrate that the different zones 920-924 may be placed into different rooms. However, the rooms 930-934 illustrated in FIG. 9A are not a factor from an audio distribution or control plane standpoint in the embodiments disclosed herein.

Zone 920 is configured as a stereo pair, where playback device 901 and playback device 902 are configured to play left and right channels of a multichannel audio stream, respectively.

Zone 922 is configured as a home theater zone. When zone 922 is not grouped with one or more other zones, playback device 903 is configured to play front right, front left, and center channels of a multichannel home theater audio stream, and playback devices 904 and 905 are configured to play a rear channel (or perhaps a left rear and right rear channel, respectively). However, in FIG. 9A, zone 922 is in group 940 with zone 920. While zone 922 is in group 940 with zone 920 in the example configuration shown in FIG. 9A, zone 922 is configured to play the same multichannel audio stream as zone 920. Therefore, at least in this example, playback device 903 and 904 (in zone 922) are configured to play a left channel of audio along with playback device 901 (in zone 920), and playback device 903 and 905 (in zone 922) are configured to play a right channel of audio along with playback device 902 (in zone 920).

Zone 924 is configured as a standalone zone, where playback device 906 is configured to play left and right channels of a multichannel audio stream.

While zone 920 and zone 922 are configured in group 940, each playback device in each zone 920 and 922 is configured to communicate with each other playback device in the group 940 in a fully-connected configuration to exchange commands, configuration information, events, and state information to each other via dedicated websocket connections between each pair of playback devices within the group 940.

For example, in the embodiment illustrated in FIG. 9A, while zone 920 and zone 922 are configured in group 940, there is a dedicated websocket connection (or similar bi-directional communication link or session) between (i) playback devices 901 and 902, (ii) playback devices 903 and 904, (iii) playback devices 903 and 905, (iv) playback devices 904 and 905, (v) playback devices 901 and 903, (vi) playback devices 901 and 904, (vii) playback devices 901 and 905, (viii) playback devices 902 and 903, (ix) playback devices 902 and 904, and (x) playback devices 902 and 905.

In addition to dedicated websocket connections (or similar bi-directional communication links or session) between each pair of playback devices within group 940, some examples also include dedicated websocket (or similar) connections between all of the playback devices within the playback system 900. In such scenarios, in addition to dedicated websocket connections (or similar bi-directional communication links or session) between each pair of playback devices within group 940, some examples also include dedicated websocket (or similar) connections between (i) each playback device in group 940 and (ii) every other playback device in the playback system 900.

For example, in addition to the ten dedicated websocket (or similar) connections listed above, some embodiments additionally include a dedicated websocket (or similar) connection between (i) playback devices 906 and 901, (ii) playback devices 906 and 902, (iii) playback devices 906 and 903, (iv) playback devices 906 and 904, and (v) playback devices 906 and 905.

Thus, embodiments of system 900 depicted in FIG. 9A that implement a flat, fully-connected control plane require as many as fifteen connections (or similar links and/or sessions) via which each playback device exchanges configuration, command/control, events, and/or state information with every other playback device in the system 900.

This flat, fully-connected control plane where most (or all) playback devices communicate with each other to forward configuration and control information throughout the playback system 900 has several benefits. For example, when the playback devices exchange configuration and control information with each other, each playback device participating in the information exchange can build and maintain a redundant topological model of the playback system 900 along with computing and networking capabilities of the other playback devices in the playback system. Building and maintaining a topological model of the playback system 900 enables playback devices to respond to playback system configuration changes much more quickly than other systems that might lack such a flat, fully-connected control plane implementation.

Also, exchanging configuration and control information among the playback devices also facilitates certain automatic playback system reconfiguration capabilities. One such automatic reconfiguration capability includes playback devices deciding among themselves whether to transfer group management functionality from one playback device within a playback group (e.g., group 940) to another playback device within the group based operational metrics, such as network characteristics, network performance, processor load, memory, and/or other metrics that may be shared among the playback devices. Another benefit of sharing configuration and control information among the playback devices is that controller devices (e.g., controller device 980) configured to monitor and/or control aspects of the playback system 900 can obtain configuration and control information relating to the playback system 900 by accessing a single playback device within the playback system 900 because every playback device has configuration information about all of the other playback devices within the playback system 900.

Although a flat, fully-connected control plane provides operational benefits in many operating environments, the number of device-to-device websockets (or similar communication links and/or sessions) and the amount of configuration and control information exchanged between and among the playback devices grows dramatically as the number of playback devices in a playback system increases, as shown in FIG. 9B.

### A. Multi-player Playback Devices

FIG. 9B shows a playback system 990 that includes playback devices 901-906 and 909-915, Multi-Player Playback Devices 907, 908, and 916 organized into zones 920-924, Area Zones 950-956, and groups 940-944 according to some example embodiments.

Playback system 990 has many more playback entities than playback system 900, i.e., playback system 990 in FIG. 9B includes many more playback devices and Multi-Player Playback Devices (and players implemented therewith) as compared to playback system 900 in FIG. 9A. Because the Area Zone configurations shown in FIG. 9B include the new Area Zone configurations and the new Multi-Player Playback Devices, it can be helpful to understand certain aspects of the structure, function, and operation of the Multi-Player Playback Devices that are depicted in FIG. 9B as well as alternative embodiments thereof.

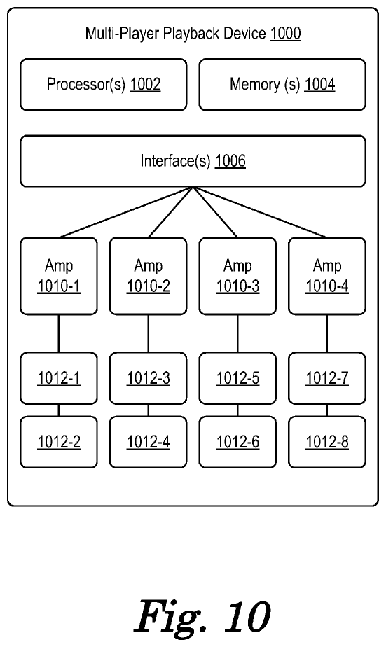

FIG. 10 shows an example block diagram of a Multi-Player Playback Device 1000 configurable to implement from one to eight logical players according to some example embodiments. The Multi-Player Playback Devices 907, 908, and 916 shown in FIG. 9B may be the same as or similar to Multi-Player Playback Device 1000 shown in FIG. 10.

As mentioned earlier, a Multi-Player Playback Device is a playback device comprising multiple configurable audio outputs, one or more processors, and tangible, non-transitory computer readable media storing program instructions that are executed by the one or more processors to cause the Multi-Player Playback Device to perform the Multi-Player Playback Device features and functions described herein.

For example, Multi-Player Playback Device 1000 includes one or more processors 1002 and one or more tangible, non-transitory computer-readable memory 1004. The tangible, non-transitory computer-readable memory 1004 is configured to store program instructions that are executable by the one or more processors 1002. When executed by the one or more processors 1002, the program instructions cause the Multi-Player Playback Device 1000 to perform the Multi-Player Playback Device functions disclosed and described herein.

Multi-Player Playback Device 1000 also includes one or more network interfaces 1006. The network interfaces may include any one or more (i) wired network interfaces, e.g., Ethernet, Universal Serial Bus, Firewire, Power-over-Ethernet, or any other type of wired network interface now known or later developed that is suitable for transmitting and receiving the types of data described herein and/or (ii) wireless network interfaces, e.g., WiFi, Bluetooth, 4G/5G, or any other type of wireless interface now known or later developed that is suitable for transmitting and receive the types of data described herein.

Multi-Player Playback Device includes amplifiers 1010-1, 1010-2, 1010-3, and 1010-4, where each amplifier is connected to two audio outputs. In particular, (i) amplifier 1010-1 is connected to audio outputs 1012-1 and 1012-2, (ii) amplifier 1010-2 is connected to audio outputs 1012-3 and 1012-4, (iii) amplifier 1010-3 is connected to audio outputs 1012-5 and 1012-6; and (iv) amplifier 1010-4 is connected to audio outputs 1012-7 and 1012-8.

Multi-Player Playback Device 1000 includes four amplifiers 1010-1 through 1010-4 and eight audio outputs 1012-1 through 1012-8 as an illustrative example. Other embodiments may have a different number of amplifiers, a different number of audio outputs, and/or a different ratio of amplifiers to audio outputs.

In operation, the Multi-Player Playback Device 1000 is configurable to implement from one to eight “logical” players. Each logical player (sometimes referred to herein as simply a player) can be addressed and managed within a playback system as a distinct playback entity.

In some embodiments, the Multi-Player Playback Device 1000 is configured to operate within any of several different operating modes. In some embodiments, the Multi-Player Playback Device 1000 is reconfigurable to switch between operating in one mode to operating in a different mode.

For example, in some embodiments, the Multi-Player Playback Device 1000 is configurable to operate in a first mode where the Multi-Player Playback Device 1000 is configured to implement eight single-channel logical players, where each logical player is configured to output single-channel audio from one of the eight audio outputs.

In this first mode of operation, each of the audio outputs 1012-1 through 1012-8 plays the same channel of audio. In some embodiments, the single-channel audio comprises a mono audio stream. In some embodiments, the single-channel audio comprises one channel from a multi-channel audio stream. In some scenarios, each of the eight logical players can be connected to a different speaker (e.g., free-standing speakers, speakers mounted in walls or ceilings, and so on) so that each connected speaker plays the same channel of audio. In some embodiments, all eight of the logical players are configured to output the same audio stream. In other embodiments, one or more of the logical players may be configured to output different audio than one or more other logical players.

In some embodiments, the Multi-Player Playback Device 1000 is configurable to operate in a second mode where the Multi-Player Playback Device 1000 is configured to implement four two-channel logical players, wherein each logical player is configured to output two-channel audio from two of the eight audio outputs.

In this second mode of operation, (i) a first logical player uses amp 1010-1 to drive audio outputs 1012-1 and 1012-2 to output two channels of audio, (ii) a second logical player uses amp 1010-2 to drive audio outputs 1012-3 and 1012-4 to output two channels of audio, (ii) a third logical player uses amp 1010-3 to drive audio outputs 1012-5 and 1012-6 to output two channels of audio, and (iv) a fourth logical player uses amp 1010-4 to drive audio outputs 1012-7 and 1012-8 to output two channels of audio. The two channels of audio could be left and right channels of a stereo audio stream. Alternatively, the two channels of audio could be any two different channels of a multichannel audio stream. In some embodiments, all four of the logical players are configured to output the same audio stream. In other embodiments, one or more of the logical players may be configured to output different audio than one or more other logical players.

In some embodiments, the Multi-Player Playback Device 1000 is configurable to operate in a third mode where the Multi-Player Playback Device 1000 is configured to implement two four-channel logical players, wherein each logical player is configured to output four-channel audio from four of the eight audio outputs.

In this third mode of operation, (i) a first logical player uses amps 1010-1 and 1010-2 to drive audio outputs 1012-1, 1012-2, 1012-3, and 1012-4 to output four channels of audio, and (ii) a second logical player uses amps 1010-3 and 1010-4 to drive audio outputs 1012-5, 1012-6, 1012-7, and 1012-8 to output four channels of audio. The four channels of audio could be front left, front right, rear left, and rear right channels of a surround sound audio stream. Alternatively, the four channels of audio could be any four different channels of a multichannel audio stream. In some embodiments, both of the logical players are configured to output the same audio stream. In other embodiments, one of the logical players may be configured to output different audio than the other logical player.

In some embodiments, the Multi-Player Playback Device 1000 is configurable to operate in a fourth mode where the Multi-Player Playback Device 1000 is configured to implement one eight-channel logical player, where the logical player is configured to output eight-channel audio from the eight audio outputs.

In this fourth mode of operation, a single logical player uses amps 1010-1 through 1010-4 to drive audio outputs 1012-1 through 1012-8 to output eight channels of audio. The eight channels of audio could be front left, front center, front right, rear left, rear center, rear right, left subwoofer, and right subwoofer channels of a surround sound audio stream.

Alternatively, the eight channels of audio could be any eight different channels of a multichannel audio stream. In some embodiments, the logical player is configured to output the same channel of audio via each of the eight audio outputs.

Although four operating modes are described here for illustrative purposes, the Multi-Player Playback Device 1000 in some embodiments is configurable to operate in other operating modes that include combinations of differently-configured players. For example, in some embodiments, the Multi-Player Playback Device 1000 is configurable to operate in a mode that includes (i) a first logical player that uses amps 1010-1, 1010-2, and 1010-3 to drive audio outputs 1012-1, 1012-2, and 1012-3 to output six channels of audio, and (ii) a second logical player uses amp 1010-4 to drive audio output 1012-8 to output one channel of audio. The Multi-Player Playback Device 1000 can implement other combinations and configurations of amps and audio outputs to output different channels of audio content.

In some embodiments, several Multi-Player Playback Devices (e.g., several Multi-Player Playback Devices like Multi-Player Playback Device 1000) can be bonded together to implement more sophisticated configurations of one or more logical players.

For example, in some embodiments, the Multi-Player Playback Device 1000 is configured to selectively operate in any of a plurality of bonded modes comprising a first bonded mode and a second bonded mode.

In the first bonded mode, the Multi-Player Playback Device 1000 is configured to operate in a bonded configuration with a second Multi-Player Playback Device that has eight audio outputs similar to Multi-Player Playback Device 1000. In the first bonded mode, the Multi-Player Playback Device 1000 and the second Multi-Player Playback Device are configured to implement a single logical player configured to output any of (i) one set of sixteen channels of audio, (ii) two sets of eight channels of audio, (iii) four sets of four channels of audio, (iv) eight sets of two channels of audio, or (v) sixteen single channels of audio.

In the second bonded mode, the Multi-Player Playback Device 1000 operate in a bonded configuration with a second Multi-Player Playback Device and a third Multi-Player Playback Device, where the second Multi-Player Playback Device and the third Multi-Player Playback Device each have eight audio outputs similar to Multi-Player Playback Device 1000. In the second bonded mode, the Multi-Player Playback Device 1000, the second Multi-Player Playback Device, and the third Multi-Player Playback Device are configured to implement a single logical player configured to output any of (i) one set of twenty four channels of audio, (ii) two sets of twelve channels of audio, (iii) three sets of eight channels of audio, (iv) four sets of six channels of audio, (v) six sets of four channels of audio, (v) eight sets of three channels of audio, (vi) twelve sets of two channels of audio, or (vii) twenty four singles channels of audio.

### B. Area Zone Configurations

Returning to FIG. 9B, playback system 990 includes playback devices 901-906 and 909-915, and Multi-Player Playback Devices 907, 908, and 916. The playback devices 901-906 and 909-915 and the Multi-Player Playback Devices 907, 908, and 916 are organized into zones 920-924, Area Zones 950-956, and groups 940-944 according to some example embodiments.

The Multi-Player Playback Devices 907, 908, and 916 shown in FIG. 9B may be the same as or similar to the Multi-Player Playback Device 1000 shown in FIG. 10, and as such, the Multi-Player Playback Devices 907, 908, and 916 shown in FIG. 9B are configurable to implement any of the logical players, groupings of logical players, and bonded playback devices described with reference to FIG. 10.

In each of the Area Zone configurations, all of the playback entities within the Area Zone are configured to play the same audio stream, which may be a multichannel audio stream.

Zones 920, 922, and 924 in FIG. 9B are the same zones 920, 922, and 924 in FIG. 9A. Zone 920 is configured as a stereo pair, where playback device 901 and playback device 902 are configured to play left and right channels of a multichannel audio stream, respectively, and zone 922 is configured as a home theater zone. Since zone 922 is in group 940 with zone 920, zone 922 is configured to play the same multichannel audio stream as zone 920. Therefore, at least in this example, playback device 903 and 904 (in zone 922) are configured to play a left channel of audio along with playback device 901 (in zone 920), and playback device 903 and 905 (in zone 922) are configured to play a right channel of audio along with playback device 902 (in zone 920). Zone 924 is configured as a standalone zone, where playback device 906 is configured to play left and right channels of a multichannel audio stream.

Playback system 990 also includes several Area Zone configurations, including Area Zones 950-956. Each of the Area Zones 950-956 illustrates different Area Zone features and/or possible configurations. For example, each Area Zone 950-956 includes different arrangements and configurations of playback devices, zones, Multi-Player Playback Devices, players implemented by Multi-Player Playback Devices, and groups thereof.

### C. Area Zone Configurations and Features

Each Area Zone configuration 950-956 is defined by Area Zone configuration information. In some embodiments, the Area Zone configuration information is contained within an Area Zone configuration package, which includes an Area Zone configuration file for each playback entity within the Area Zone.

In some instances, the Area Zone configuration information for each Area Zone 950-956 includes one or more (or all) of: (i) a name that identifies the Area Zone, (ii) the name of each playback entity within the Area Zone; (iii) the name of the playback entity designated as the Area Zone Primary for the Area Zone, (iv) for each playback entity within the Area Zone, one or more playback configuration settings that defines one or more of a volume level or an equalization setting for the playback entity; (v) for each playback entity within the Area Zone, a volume control configuration setting that defines a volume control function performed in response to a volume control command received via a physical volume control associated with the playback entity, e.g., a volume up/down button, a volume knob, a volume slider, a touchpad to control volume, or any other type of volume control associated with the playback entity; (vi) for playback entities that have an associated microphone (e.g., a networked microphone device or other playback entity with an associated microphone), a voice response configuration setting that defines how the playback entity responds to voice commands received via its associated microphone while the playback entity is an active member of the Area Zone; and (vii) for Area Zones configured to play multichannel audio, a channel map that defines the channel or channels that each playback entity is configured to play once the Area Zone has been activated, including at least in some instances, which channel each audio output port of each playback entity is configured to play while the Area Zone is active.

### D. Storing and Updating Area Zone Configuration Information

In some embodiments, an individual playback entity may store several Area Zone configuration packages corresponding to different Area Zone configurations that include that individual playback entity. For example, a playback entity may be member of several different Area Zone configurations. But although a playback entity may be a member of several different Area Zone configurations, the playback entity can be an active member of only one Area Zone at a time.

For example, for a playback entity that is a member of three Area Zones (e.g., a first Area Zone, a second Area Zone, and a third Area Zone), the playback entity is an active member of the first Area Zone only when the first Area Zone has been activated. If the second Area Zone is activated while the playback entity is operating in the first Area Zone, then the playback entity switches from operating in the first Area Zone to operating in the second Area Zone. If the first Area Zone is later reactivated while the playback entity is operating in the second Area Zone, then the playback entity switches from operating in the second Area Zone to operating in the first Area Zone again. If instead, the third Area Zone is activated while the playback entity is operating in the second zone, then the playback entity switches from operating in the second Area Zone to operating in the third Area Zone.

In some embodiments, a playback entity is configured to switch between operating in different Area Zones after (or perhaps in response to) receiving commands (directly or indirectly) from controller device 980 to activate a particular Area Zone. In some scenarios, the controller device 980 (or another computing device or computing system configured to control the playback system 990) sends a command to activate a particular Area Zone to the Area Zone Primary for the Area Zone. After receiving the command to activate the particular Area Zone, the Area Zone Primary sends one or more commands to the Area Zone Secondaries in the Area Zone that cause the Area Zone Secondaries to join the particular Area Zone.

For example, in some embodiments, one or more of the playback entities identified as playback entities for the Area Zone in the Area Zone configuration information receive (and store) configuration settings for the Area Zone from one of: (i) a computing system (e.g., a controller device 980 or a cloud server configured to control the playback system), (ii) the computing system via one of the one or more other playback entities of the Area Zone, or (iii) one of the one or more other playback entities of the Area Zone. After receiving the Area Zone configuration settings, some embodiments include the playback entities activating the Area Zone based on the stored Area Zone configuration information after receiving (or perhaps in response to receiving) a command to activate the Area Zone from one of: (i) the computing system (e.g., the controller device 980 or cloud server configured to control the playback system), (ii) the computing system via one of the one or more other playback entities of the Area Zone, or (iii) one of the one or more other playback entities of the Area Zone.

In some embodiments, a playback entity that is designated as the Area Zone Primary for an area group stores the Area Zone configuration information in the form of an Area Zone configuration package for the Area Zone. In some instances, the Area Zone configuration package includes separate Area Zone configuration files for each playback entity in the Area Zone, including the Area Zone Primary. In some examples where the Area Zone configuration package includes separate Area Zone configuration files for each playback entity in the Area Zone, the Area Zone Primary storing the Area Zone configuration package for the Area Zone includes the Area Zone Primary storing the individual Area Zone configuration files for each playback entity in the Area Zone.

In some embodiments, a playback entity that is designated as an Area Zone Secondary in an area group may not store any Area Zone configuration information for the Area Zone in which the playback entity is an Area Zone Secondary. In such embodiments, the Area Zone Primary for the Area Zone stores the Area Zone configuration package, which includes Area Zone configuration files for each Area Zone Secondary.

In other embodiments, a playback entity that is designated as an Area Zone Secondary in the area group stores its own Area Zone configuration file, but not any Area Zone configuration file for any other playback entity in the Area Zone.

In some instances, (i) the playback entity designated as the Area Zone Primary stores an Area Zone configuration package for the Area Zone, which includes the Area Zone configuration files for all of the Area Zone Secondaries in the Area Zone, and (ii) each playback entity designated as an Area Zone Secondary stores its own Area Zone configuration file, but not any Area Zone configuration file for any other playback entity in the Area Zone. In such embodiments, the Area Zone configuration file for a specific Area Zone Secondary is stored at both (i) the Area Zone Primary as part of the Area Zone configuration package and (ii) the specific Area Zone Secondary.

In some instances, the Area Zone configuration information is additionally or alternatively stored at a controller device (e.g., as controller device 980) or a cloud server.

### E. Area Zone Names

The name of the Area Zone is typically a user-assigned name for the Area Zone. However, in some instances, the name of the Area Zone may be assigned by the Area Zone Primary or perhaps a controller device. In some instances where the Area Zone name is assigned by the Area Zone Primary or controller device, the assigned Area Zone name may be based on any of (i) the name of the room in which the Area Zone Primary is located, (ii) the name of the Area Zone Primary, (iii) the name of the room in which most of the playback entities in the Area Zone are located, (iv) a name based on the names of one or more other Area Zones, or (v) any other naming methodology.

### F. Playback Entity Names

The name of each playback entity within the Area Zone is the name that was assigned to the playback entity when the playback entity was originally configured for the playback system. Adding the playback entity to the Area Zone does not change the name or the playback entity, at least in typical embodiments.

### G. Playback Configuration Settings: Volume Levels and Equalization Settings

The one or more playback configuration settings that define one or more of a volume level or an equalization setting for an individual playback entity are used to implement the initial volume settings and equalization settings for the playback entity. In some embodiments, when the Area Zone is activated, each playback entity implements the volume and/or equalization settings specified in the Area Zone configuration for the playback entity. In some instances, the initial playback volume and/or equalization settings for the Area Zone may be user specified when creating the Area Zone configuration.

In some instances, the initial volume and/or equalization settings for each playback entity within the Area Zone may be based on the overall volume and tone desired for the space(s) in which the playback entities of the Area Zone are located. In some embodiments, the volume setting may include a volume coefficient that specifies a ratio for how the volume of the playback entity should change relative to other playback entities within the Area Zone in response to volume adjustment commands.

For example, to maintain a desired volume balance between playback entities within an Area Zone, a command to increase the Area Zone volume by 3 units may cause some playback entities within the Area Zone to increase their volume by only 1 unit (a 1:3 ratio), some playback entities within the Area Zone to increase their volume by 2 units (a 2:3 ratio), some playback entities within the Area Zone to increase their volume by 3 units (a 1:1 ratio), and other playback entities within the Area Zone to increase their volumes by 4, 5, or 6 units (a 4:3, 5:3, or 2:1 ratio, respectively). Implementing volume coefficients for individual playback entities may be desirable in Area Zones created from different types of playback devices and Multi-Player Playback Devices that may have different numbers of speakers and/or control different numbers of speakers.

### H. Volume Control Configuration Settings

The volume control configuration setting for an individual playback entity defines a volume control function performed in response to a volume control command received via a physical volume control associated with the playback entity, e.g., a volume up/down button, a volume knob, a volume slider, a touchpad to control volume, or any other type of volume control. In operation, the volume control configuration setting is configurable for each playback entity. For example, the volume control configuration setting for a particular playback entity may be any of several different volume control configuration settings.

In some embodiments, a first volume control configuration setting causes the playback entity to adjust only its own volume in response to receiving a volume control command via the physical volume control associated with the playback entity without affecting the volume of any other playback entity within the Area Zone. In this respect, the first volume control configuration setting is akin to a local volume only setting because the first volume control configuration setting causes the physical volume control associated with the playback entity to control only the volume of that single playback entity without affecting the volume level of any other playback entity in the Area Zone.

In some embodiments, a second volume control configuration setting causes the playback entity to, in response to receiving a volume control command via the physical volume control associated with the playback entity, adjust (i) the playback volume of the playback entity and (ii) a playback volume of at least one other playback entity in a bonded zone with that playback entity. For example, if the playback entity is in a bonded zone with another playback entity with the Area Zone, then the second volume control configuration causes the playback entity to adjust the volume of itself and all the other playback entities in the bonded zone with that playback entity.

In some embodiments, a third volume control configuration setting causes the playback entity to, in response to receiving a volume control command via the physical volume control associated with the playback entity, adjust (i) the playback volume of the playback entity and (ii) a playback volume of at least one other playback entity within the Area Zone. For example, the third volume control configuration causes the playback entity to adjust the volume of itself and one or more other playback entities in the Area Zone, regardless of whether the one or more other entities are in a bonded zone with that playback entity.

In some embodiments, a fourth volume control configuration setting causes the playback entity to, in response to receiving a volume control command via the physical volume control associated with the playback entity, adjust (i) the playback volume of the playback entity and (ii) a playback volume of every other playback entity within the Area Zone. In this respect, the fourth volume control configuration setting is akin to an Area Zone volume setting because the fourth volume control configuration setting causes the physical volume control associated with the playback entity to control the volume of every playback entity in the Area Zone.

In some embodiments, a fifth volume control configuration setting disables the physical volume control associated with the playback entity while the playback entity in the Area Zone. While the physical volume control is disabled, volume control commands received via the physical volume control associated with the playback entity do not affect the volume of that playback entity or any other playback entity within the Area Zone.

### I. Voice Response Configuration Settings

For playback entities that have an associated microphone (e.g., a networked microphone device or other playback entity with an associated microphone), the Area Zone configuration package in some embodiments also includes a voice response configuration setting that defines how the playback entity responds to voice commands received via its associated microphone while the playback entity is an active member of the Area Zone. In operation, the voice response configuration setting is configurable for each playback entity. For example, the voice response configuration setting for a particular playback entity may be any of several different voice response configuration settings.

In some embodiments, a first voice response configuration setting for an individual playback entity causes the playback entity to process voice commands received via the microphone associated with the playback entity.

In some embodiments, a second voice response configuration setting for an individual playback entity causes the playback entity to forward voice commands received via its associated microphone to the Area Zone Primary for processing.

In some embodiments, a third voice response configuration setting for an individual playback entity causes the playback entity to forward voice commands received via its associated microphone to another device or system separate from the playback system for processing.

In some embodiments, a fourth voice response configuration setting for an individual playback entity causes the playback entity to forward voice commands received via its associated microphone to a voice command processing server for processing.

In some embodiments, a fifth voice response configuration setting for an individual playback entity causes the playback entity, when the playback entity is configured as an Area Zone Secondary, after receiving a voice input via a microphone associated with the playback entity, (i) when the voice input corresponds to a command to be executed by the playback entity, execute the voice command corresponding to the voice input, (ii) when the voice input corresponds to a command to be executed by a different playback entity, either (a) transmit the voice input to the Area Zone Primary or (b) create an ad-hoc connection between the individual playback entity and the other playback entity, and then transmit the voice input to the other playback entity via the ad-hoc connection.

In some embodiments, a sixth voice response configuration setting for an individual playback entity causes the playback entity, when the playback entity is configured as the Area Zone Primary, after receiving a voice input via a first microphone associated with the playback entity, (i) when the voice input corresponds to a command to be executed by the playback entity, execute the voice command corresponding to the voice input, (ii) when the voice input corresponds to a command to be executed by a different playback entity, transmit the command to that other, different playback entity.

In some embodiments, a seventh voice response configuration setting for an individual playback entity causes the playback entity when the playback entity is configured as the Area Zone Primary, after receiving a voice input from a different playback entity (that that different playback entity originally received via its own associated microphone), (i) determine one or more commands for one or more playback entities of the Area Zone based on the voice input, and (ii) transmit the one or more commands to the one or more playback entities for execution.

In some embodiments, an eighth voice response configuration setting for an individual playback entity disables the associated microphone and/or disables processing (or forwarding) of voice commands received via the microphone associated with the playback entity while the playback entity in the Area Zone.

In some embodiments, the voice response configuration setting for an individual playback entity may include any combination of non-mutually-exclusive voice response configuration settings outlined above.

### J. Control Surface Response Configuration

For playback entities that have one or more physical control surfaces in addition to volume (e.g., buttons, switches, knobs, dials, sliders, and so on), the Area Zone configuration package in some embodiments also includes a control surface response configuration setting that defines how the playback entity responds to physical inputs received the one or more physical controls while the playback entity is an active member of the Area Zone. In operation, the control surface response configuration setting is configurable for each playback entity. For example, the voice response configuration setting for a particular playback entity may be any of several different voice response configuration settings.

For example, a first control surface response configuration setting for an individual playback entity causes the playback entity, when the playback entity is configured as an Area Zone Secondary, (i) in response to receiving an input via a first physical user interface associated with the playback entity, transmit an indication of the physical input to the Area Zone Primary, and (ii) if the playback entity receives a command from the Area Zone Primary in response to the indication, execute the command.

For example, a second control surface response configuration setting for an individual playback entity causes the playback entity, when the playback entity is configured as the Area Zone Primary, after receiving an indication from a different playback entity based on an input via a physical user interface associated with that different playback entity, (i) determine one or more commands for one or more playback entities of the Area Zone, and (ii) cause the one or more playback entities to execute the one or more commands.

Examples of inputs that may correspond to commands include, among other inputs, (i) a skip track input, (ii) a play input, (iii) a pause input, (iv) a fast-forward input, (v) a rewind input, (vi) a return to the beginning of the track input, (vii) a join group input, (viii) a leave group input, (ix) a join Area Zone input, (x) a leave Area Zone input, (xi) a reboot/restart input, (xii) a switch from wireless to wired input, and (xiii) a switch from wired to wireless input.

In some embodiments, the control surface response configuration setting for an individual playback entity may include any combination of non-mutually-exclusive control surface response configuration settings outlined above.

### K. Area Zone Primary Designation

In some embodiments, the Area Zone configuration information may expressly specify a particular playback entity to operate as the Area Zone Primary for the Area Zone.

In other embodiments, the Area Zone configuration information may not expressly specify which particular playback entity should operates as the Area Zone Primary for the Area Zone. Instead, the Area Zone configuration information may include a configuration setting for “dynamic Area Zone Primary determination” or similar. In such scenarios, one or more (or all) of the playback entities in the Area Zone negotiate with each other to determine which playback entity should operate as the Area Zone Primary for the Area Zone.

Thus, in some embodiments, one or more (or all) of the playback entities identified in the Area Zone configuration package coordinate with one or more (or all) of the other playback devices identifies in the Area Zone configuration package for the Area Zone to determine which playback entity (e.g., which playback device or which logical player) should operate as the Area Zone Primary for the Area Zone.

Once a particular playback entity has been designated as the Area Zone Primary for the Area Zone, configuration information for the Area Zone is updated to reflect the designated Area Zone Primary. In some instances, the Area Zone configuration information for the Area Zone is updated to reflect the designated Area Zone Primary. In some instances, updating the Area Zone configuration information includes updating the Area Zone configuration file for each Area Zone Secondary to reflect the designated Area Zone Primary. In some instances, updating the Area Zone configuration information includes saving (or causing to be saved) an updated Area Zone configuration package (including Area Zone configuration files for the individual playback entities in the Area Zone) at any one or more of (i) the Area Zone Primary, (ii) one or more Area Zone Secondaries, (iii) a controller device (e.g., controller device 980), and/or (iv) a cloud server configured to control and/or manage the playback system.

In some instances, the playback entities coordinate among themselves to designate a particular playback entity to function as the Area Zone Primary when the Area Zone is first activated. And once the Area Zone has been activated with a particular playback entity as the Area Zone Primary, that particular playback entity continues to function as the Area Zone Primary until (i) the Area Zone is deactivated, e.g., by switching to a different Area Zone configuration, or (ii) the playback entity functioning as the Area Zone Primary becomes unreachable or unreliable for some reason such as network congestion or failures, power failure, or other problems.

In some instances, the playback entities coordinate among themselves to identify the Area Zone Primary when the Area Zone is first activated. And once the Area Zone has been activated with a particular Area Zone Primary, the playback entities renegotiate which playback entity should function as the Area Zone Primary (i) on a periodic or semi-periodic basis, (ii) in response to determining that the currently-designated Area Zone Primary has become unsuitable or unsatisfactory for performing the Area Zone Primary role, e.g., the currently-designated Area Zone Primary has become unreliable and/or unresponsive.

In some embodiments, the determination of which playback entity should operate as the Area Zone Primary for the Area Zone is based on one or more of (i) which playback entity is identified first in a listing of playback entities in the Area Zone configuration information, (ii) which playback entities are configured to receive audio content via a wired network connection versus which playback entities are configured to receive audio content via a wireless network connection, (iii) a measure of network latency between each playback entity in the Area Zone and the audio source, (iv) a measure of transmission signal quality between each playback entity in the Area Zone and the audio source, (v) a measure of network latency between each playback entity in the Area Zone and each other playback entity in the Area Zone, (vi) a measure of transmission signal quality between each playback entity in the Area Zone and each other playback entity in the Area Zone, (vii) a measure of each playback entity's computing resources available for performing the function of an Area Zone Primary, (viii) the media access control (MAC) address of each playback device and Multi-Player Playback Device.

### L. Example Area Zone Configurations

Each of the Area Zone examples 950-956 depicted in FIG. 9B illustrates different Area Zone features and/or possible configurations. For example, each Area Zone 950-956 includes different arrangements and configurations of playback devices, zones, Multi-Player Playback Devices, players implemented by Multi-Player Playback Devices, and groups thereof.

Area Zone 950 shows how an Area Zone can include a grouping of zones and a Multi-Player Playback Device.

Area Zone 950 includes (i) one group 940 that includes (a) zone 920, which includes playback devices 901 and 902 and (b) zone 922, which includes playback devices 904-906, and (ii) one Multi-Player Playback Device 916 that implements a single logical player 916-1. While Area Zone 950 is active, all of the playback entities in Area Zone 950 are configured to play the same audio stream, which could be a multichannel audio stream.

Playback device 901 is configured as the Area Zone Primary for Area Zone 950 as indicated by the heavy dotted line surrounding playback device 901. Thus, while Area Zone 950 is activated, playback device 901 is configured to perform any one or more (or all) of the functions performed by an Area Zone Primary disclosed herein.

Playback devices 902-905 and Multi-Player Playback Device 916 are all configured as Area Zone Secondaries for Area Zone 950. Thus, while Area Zone 950 is activated, playback devices 902-905 and Multi-Player Playback Device 916 are configured to perform any one or more (or all) of the functions performed by an Area Zone Secondary disclosed herein.

Area Zone 952 shows how an Area Zone can include a grouping of playback devices and standalone playback devices.

Area Zone 952 includes (i) one group 942 that includes three playback devices 913-915, and (ii) two standalone playback devices 911 and 912. While Area Zone 952 is active, all of the playback entities in Area Zone 952 are configured to play the same audio stream, which may be a multichannel audio stream.

Playback device 912 is configured as the Area Zone Primary for Area Zone 952 as indicated by the heavy dotted line surrounding playback device 912. Thus, while Area Zone 952 is activated, playback device 912 is configured to perform any one or more (or all) of the functions performed by an Area Zone Primary disclosed herein.

Playback devices 911 and 913-915 are all configured as Area Zone Secondaries for Area Zone 952. Thus, while Area Zone 952 is activated, playback devices 911 and 913-915 are configured to perform any one or more (or all) of the functions performed by an Area Zone Secondary disclosed herein.

Area Zone 954 shows how an Area Zone can include several standalone playback devices and several logical players implemented by several Multi-Player Playback Devices. Area Zone 954 also shows how multiple Area Zones can be grouped together into a group.

Area Zone 954 includes (i) two standalone playback devices 909 and 910, and (ii) two logical players 908-2 (implemented by Multi-Player Playback Device 908) and 907-2 (implemented by Multi-Player Playback Device 907). While Area Zone 954 is active, all of the playback entities in Area Zone 954 are configured to play the same audio stream, which may be a multichannel audio stream.

Logical player 907-2 is configured as the Area Zone Primary for Area Zone 954 as indicated by the heavy dotted line surrounding logical player 907-2. Thus, while Area Zone 954 is activated, logical player 907-2 is configured to perform any one or more (or all) of the functions performed by an Area Zone Primary disclosed herein.

Playback devices 909-910 and logical player 908-2 are all configured as Area Zone Secondaries for Area Zone 954. Thus, while Area Zone 954 is activated, playback devices 909-910 and logical player 908-2 are configured to perform any one or more (or all) of the functions performed by an Area Zone Primary disclosed herein.

Area Zone 956 shows how an Area Zone can include several standalone playback devices and several logical players implemented by several Multi-Player Playback Devices. Area Zone 956 also shows how multiple Area Zones can be grouped together into a group.

Area Zone 956 includes (i) one zone 924, which includes one playback device 906, and (ii) two logical players 908-1 (implemented by Multi-Player Playback Device 908) and 907-1 (implemented by Multi-Player Playback Device 907). While Area Zone 956 is active, all of the playback entities in Area Zone 956 are configured to play the same audio stream, which may be a multichannel audio stream.

Logical player 907-1 is configured as the Area Zone Primary for Area Zone 956 as indicated by the heavy dotted line surrounding logical player 907-1. Thus, while Area Zone 956 is activated, logical player 907-1 is configured to perform any one or more (or all) of the functions performed by an Area Zone Primary disclosed herein.

Playback device 906 and logical player 908-1 are all configured as Area Zone Secondaries for Area Zone 956. Thus, while Area Zone 956 is activated, playback device 906 and logical player 908-1 are configured to perform any one or more (or all) of the functions performed by an Area Zone Primary disclosed herein.

Area Zone 954 and Area Zone 956 are also grouped into group 944. While Area Zone 954 and 956 in group 944, Area Zone 954 and 956 are configured to play the same audio stream, which may be a multichannel audio stream.

In operation, the playback entities in each of the Area Zones 950-956 are communicatively connected to each other via any of (i) one or more wired network links, (ii) one or more wireless network links, and/or (iii) any combination of wired and/or wireless network links. Although wireless network links provide flexible installation and easy setup and operation compared to wired network links, wired network links can often provide better reliability and more consistent performance than wireless network links. Switched wired network links in particular tend to provide more reliable and consistent performance than shared wired network links and/or wireless network links.

Therefore, in some embodiments, Area Zones are configured to utilize wired network links (switched or shared) rather than wireless network networks. In some instances, Area Zone implementations use different configurations of wired and/or wireless links in combination with unicast and/or multicast transmission of (i) Media and Timing (M&T) information (i.e., audio content, playback timing, and perhaps clock timing) from the Area Zone Primary to each of the Area Zone Secondaries and (ii) Configuration and Command (C&C) information (i.e., commands, configuration information, events, and state information) between the Area Zone Primary and each of the Area Zone Secondaries.

For example, in some embodiments, when the Area Zone includes fewer than a first threshold number of playback entities, the Area Zone can be implemented with any combination of wired and/or wireless network links and multicast and/or unicast transmission schemes. In particular, the Area Zone Primary can transmit M&T information to and exchange C&C information with each Area Zone Secondary within the Area Zone via unicast and/or multicast transmissions over wired and/or wireless network links. In some embodiments, fewer than the first threshold corresponds to fewer than about four to ten playback entities.

In some Area Zone configurations having fewer than the first threshold number of playback entities, the Area Zone Primary distributes M&T information to the Area Zone Secondaries via unicast transmissions in manner similar to how a group coordinator (described above) in a playback group (described above) sends M&T information to group members via unicast transmissions to each group member in the playback group.

With prior playback group configurations, group members send Negative Acknowledgments (NACKs) to the group coordinator to inform that group coordinator that the group member did not receive a packet, and to request that the group coordinator retransmit the missed packet. However, a problem may arise in a scenario where an Area Zone Secondary is not known in the playback group topology for a group coordinator when the group coordinator is not the Area Zone Primary. For example, a group coordinator of a playback group with an Area Zone may not have knowledge of an Area Zone Secondary that is not in the playback group. Nevertheless, if the group coordinator is functioning as the audio sourcing device, the group coordinator may be requested to both (i) transmit M&T information to an IP address of an Area Zone Secondary not represented in the playback group topology and/or (ii) accept and process NACKs from an Area Zone Secondary, and retransmit missing packets in response to the NACKs. However, the group coordinator may want (or need) to validate that the Area Zone Secondary from which it is receiving NACKs is a valid playback entity in the playback system.

One solution in some embodiments is for the Area Zone Primary of the Area Zone to proxy the AddMember (playback group command) on behalf of the zone secondaries. Another solution in some embodiments is for the group coordinator to verify that the Area Zone Secondary at issue is in the same playback system using Multicast Domain Name System (mDNS) discovery. In operation, mDNS discovery acts as a topology service. Using mDNS as a topology service in this manner may not enable discovery of the full state of each playback entity in the playback system, but using mDNS as a topology service in this manner could at least verify that a particular playback entity is within the playback system. Using mDNS as a topology service in this manner may additionally enable verification, based on mDNS TXT records, that a particular Area Zone Secondary in communication with the zone primary of the Area Zone. These solutions could be used in any Area Zone configuration disclosed herein where a group coordinator of a playback group within an Area Zone may need to process packets received from an Area Zone Secondary that may not be a member of the playback group.

In another example, when the Area Zone includes more than the first threshold number of playback entities but fewer than a second threshold number of playback entities, the Area Zone can generally be implemented with any combination of wired and/or wireless network links and multicast and/or unicast transmission schemes. However, some embodiments include the Area Zone Primary using (i) multicast transmissions to distribute M&T information to and exchange C&C information with each Area Zone Secondary connected to the Area Zone via a wired network link and (ii) unicast transmissions to distribute M&T information to and exchange C&C information with each Area Zone Secondary connected to the Area Zone via a wireless network link. In some embodiments, the Area Zone Primary is configured to transmit M&T to and exchange C&C information with the wired Area Zone Secondaries in the Area Zone by implementing a M&T group and a C&C group in the manner described previously. In some embodiments, more than the first threshold of playback entities but fewer than the second threshold number of playback entities corresponds to more than about four to ten playback entities and fewer than about fifteen to thirty playback entities.

In another example, when the Area Zone includes more the second threshold number of playback entities, the Area Zone in some embodiments is implemented only with wired network links and multicast and/or unicast transmission schemes. In some such embodiments, the Area Zone is implemented only with wired network links and multicast transmission schemes. In some embodiments, the Area Zone Primary is configured to transmit M&T to and exchange C&C information with the wired Area Zone Secondaries in the Area Zone by implementing a M&T group and a C&C group in the manner described previously. In some embodiments, more than the second threshold of playback entities corresponds to more than about thirty playback entities.

### VIII. Example Methods Relating to Area Zones

FIG. 11 shows a method flowchart depicting example aspects of storing Area Zone configurations, activating Area Zone configurations, and performing various Area Zone operations according to some example embodiments. Method 1100 may be performed by any of the playback entities disclosed and described herein.

For example, one or more (or all) aspects of method 1100 may be performed by any one or more (or all) of the playback entities shown and described with reference to FIGS. 9A, 9B, and 8.

Method 1100 begins at method block 1102, which includes a first playback entity receiving configuration settings for one or more area zone configurations.

In some embodiments, the area zone comprises the first playback entity and one or more other playback entities. In some embodiments, the playback entities in the area zone are configured to play audio content from a common audio source.

In some embodiments, receiving configuration settings for one or more area zone configurations at block 1102 includes the first playback entity receiving configuration settings for the one or more area zones from (i) a computing system separate from the first playback entity, (ii) the computing system via one of the one or more other playback entities in the area zone, or (iii) one of the one or more other playback entities in the area zone.

In some embodiments, the area zone configuration settings include one or more (or all) of: (i) a name that identifies the first playback entity in the area zone; (ii) one or more playback configuration settings that define one or more of a volume level or an equalization setting for the first playback entity; and (iii) a volume control configuration setting that defines whether a physical volume control associated with the first playback entity is configured to control (a) a playback volume the first playback entity, or (b) the playback volume of the first playback entity and a playback volume of at least one other playback entity in the area zone.

In some embodiments, for audio content that include multichannel audio content, the area zone configuration settings additionally include channel instructions based on a channel map for the area zone configuration. The channel instructions specify how to route individual channels of the multichannel audio to individual audio outputs of each playback entity in the area zone for playback by the playback entities in the area zone.

The area zone configuration settings in some embodiments may additionally and/or alternatively include any one or more (or all) of the area zone configuration settings disclosed herein.

In some embodiments where the first playback entity is designated as the area zone primary for the first area zone, after receiving the areas zone configuration settings at block 1102, the first playback entity is configured to store area zone configuration settings for the first playback entity and each other playback entity in the first area zone. In some embodiments where the first playback entity is configured as an area zone secondary, after receiving the areas zone configuration settings at block 1102, the first playback entity is configured to store the area zone configuration settings for the first playback entity, but not area zone configuration settings for any other playback entity other than the first playback entity.

Method block 1104 includes the first playback entity receiving a command to activate a first area zone configuration.

In some embodiments, receiving a command to activate a first area zone configuration at block 1104 includes the first playback entity receiving a command to activate the first area zone configuration settings from (i) a computing system separate from the first playback entity, (ii) the computing system via one of the one or more other playback entities in the area zone, or (iii) one of the one or more other playback entities in the area zone.

Method block 1106 includes the first playback entity activating the first area zone configuration after receiving the command to activate the first area zone configuration at block 1104. In some embodiments, activating the first area zone configuration includes implementing the area zone configuration settings for the area zone received at block 1102.

In example embodiments where the area zone configuration settings designate the first playback entity as the area zone primary for the first area zone, activating the first area zone configuration at block 1106 includes the first playback entity starting to operate as the area zone primary for the first area zone.

In some embodiments where the area zone configuration settings do not designate any particular playback entity as the area zone primary for the first area zone, activating the first area zone configuration at block 1106 includes the first playback entity coordinating with one or more other playback entities in the first area zone to determine which playback entity should operate as an area zone primary for the area zone.

In operation, the determination of which playback entity should operate as the area zone primary for the area zone is based on one or more of (i) which playback entity is identified first in a listing of playback entities in the area zone, (ii) which playback entities are configured to receive audio content from the common audio source via a wired network connection versus which playback entities are configured to receive audio content from the common audio source via a wireless network connection, (iii) a measure of network latency between each playback entity in the area zone and the common audio source, (iv) a measure of transmission signal quality between each playback entity in the area zone and the common audio source, (v) a measure of network latency between each playback entity in the area zone and each other playback entity in the area zone, (vi) a measure of transmission signal quality between each playback entity in the area zone and each other playback entity in the area zone, (vii) a measure of each playback entity's computing resources available for performing primary player functions, (viii) each playback entity's media access control (MAC) address. In some embodiments, the determination of which playback entity should operate as the area zone primary may be based on any other area zone primary determination factor described herein.

In scenarios were the first playback entity has been determined to function as the area zone primary for the first area zone, activating the first area zone configuration at block 1106 additionally includes informing a cloud server that the first playback entity is operating as the area zone primary for the area zone after the first playback entity has been determined to function as the area zone primary.

Method block 1108 includes the first playback entity operating in the first area zone configuration after activating the first area zone configuration at block 1106.

Method block 1110 includes the first playback entity receiving a volume adjustment input via a physical volume control associated with the first playback entity. In some embodiments, the physical volume control associated with the playback entity includes any one or more of a volume up/down button, a volume knob, a volume slider, a touchpad to control volume, or any other type of volume control.

Method block 1112 includes, after receiving the volume adjustment input at block 1110, the first playback entity adjusting either (i) the playback volume of only the first playback entity or (ii) the playback volume of the first playback entity and at least one other playback entity in the area zone.

For example, in some embodiments, the first area zone configuration setting includes a volume control configuration setting that defines a volume control function performed in response to a volume control input. In some instances, the volume control configuration setting causes the first playback entity block 1112 to, after receiving a volume adjustment input via the volume control at 1110, and based on the volume control configuration setting, adjust either (i) the playback volume of only the first playback entity or (ii) the playback volume of the first playback entity and the at least one other playback entity in the area zone.

In alternative embodiments, the volume control configuration setting may cause the first playback entity to perform one or more different actions as previously described herein.

For example, in some embodiments, the volume control configuration setting specifies that the physical volume control associated with the first playback entity is configured to control the playback volume of the first playback entity and every other playback entity in the area zone. In such embodiments, after receiving a volume adjustment input via the physical volume control associated with the first playback entity at block 1110, and based on the volume control configuration setting (received in block 1102 an activated in block 1104), block 1112 includes the first playback entity adjusting the playback volume of the first playback entity and every other playback entity in the area zone.

Method block 1114 includes the first playback entity first playback receiving a command to activate a second area zone configuration while the first playback entity is operating in the first area zone configuration. Some embodiments of block 1114 may additionally include receiving second configuration settings for a second area zone, where the second area zone comprises the first playback entity and one or more other playback entities. However, in some embodiments where the block 1102 step of receiving configuration settings for one or more area zone configurations includes receiving the second configuration settings for the second area zone, block 1114 need not include receiving the second configuration settings for the second area zone.

Method block 1116 includes the first playback entity activating the second area zone. For example, in some embodiments, method block 1116 includes, while the first playback entity is operating in the first area zone, and after receiving a command to activate the second area zone at block 1114, the first playback entity switching from operating in the first area zone to operating in the second area zone, where the configuration settings for the second area zone are different than the configuration settings for the first area zone.

Method block 1118 includes the first playback entity switching from operating in the first area zone configuration to operating in the second area zone configuration.

Some embodiments of method 1100 may include other functions performed by the first playback entity, depending at least in part on whether the first playback entity is operating as an area zone primary or an area zone secondary of the first area zone or the second area zone.

For example, in instances where the first playback entity is configured as the area zone primary for the first area zone, method 1100 may additionally include (i) receiving a request for a listing of playback entities in the first area zone, (ii) after receiving the request for the listing of playback entities in the first area zone from a requesting device, (iii) the first playback entity transmitting a response to the requesting device, where the response includes the listing of playback entities in the first area zone.

Alternatively, in instances where the first playback entity is configured as an area zone secondary in the first area zone, method 1100 may additionally includes (i) receiving a request for a listing of playback entities in the first area zone, (ii) after receiving the request for the listing of playback entities in the first area zone from the requesting device, the first playback entity forwarding the request to the area zone primary for the first area zone. In such instances, another playback entity configured as the area zone primary for the first area zone receives the request forwarded from the first playback entity (configured as the area zone secondary) and responds to the requesting device with the listing of playback entities in the first area zone.

As another example, in some embodiments where the first playback entity is configured to operate as an area zone secondary for the first area zone, operating in the first area zone configuration at block 1108 includes the first playback entity (i) in response to receiving an input via a first physical user interface associated with the first playback entity, transmitting an indication of the physical input to the area zone primary, and (ii) when the first playback entity receives a command from the area zone primary in response to the indication, executing the command.

Alternatively, in some embodiments when the first playback entity is configured to operate as the area zone primary for the first area zone, operating in the first area zone configuration at block 1108 includes the first playback entity (i) after receiving an indication from a second playback entity based on an input via a second physical user interface associated with the second playback entity, (i) determining one or more commands for one or more playback entities of the area zone, and (ii) causing the one or more playback entities to execute the one or more commands.

As another example, in some embodiments when the first playback entity is configured to operate as the area zone primary for the first area zone, operating in the first area zone configuration at block 1108 includes the first playback entity (i) establishing a group address for the area zone, (ii) providing the group address to each other playback entity in the area zone, and (iii) transmitting commands to the area zone via the group address.

Alternatively, in some embodiments where the first playback entity is configured to operate as an area zone secondary for the first area zone, operating in the first area zone configuration at block 1108 includes the first playback entity (i) subscribing to a group address provided by the area zone primary, and (ii) after subscribing the group address, executing area zone commands received from the area zone primary via the group address.

Some embodiments of method 1100 may include other functions performed by the first playback entity, depending at least in part on whether the first playback entity is configured to receive audio content via a wired or a wireless network interface.

For example, in some embodiments when the first playback entity is configured to receive audio content and playback timing via a wired network interface, operating in the first area zone configuration at block 1108 includes the first playback entity (i) subscribing to a multicast group corresponding to the audio content and playback timing, and (ii) playing audio based on audio content and playback timing for the audio content, where the audio content and the playback timing are received via the multicast group.

Alternatively, in some embodiments when the first playback entity is configured to receive audio content and playback timing via a wireless network interface, operating in the first area zone configuration at block 1108 includes the first playback entity playing audio based on audio content and playback timing for the audio content, where the audio content and the playback timing are received via a unicast network address for the first playback entity.

Some embodiments of method 1100 may include performing certain voice command processing functions by the first playback entity, depending at least in part on (i) a voice response configuration setting in the area zone configuration information and (ii) whether the first playback entity is operating as an area zone primary or an area zone secondary of the first area zone or the second area zone.

For example, in some embodiments when the first playback entity is configured to operate as an area zone secondary in the first area zone, operating in the first area zone configuration at block 1108 includes the first playback entity, after receiving a voice input via a first microphone associated with the first playback entity, (i) when the voice input corresponds to a command to be executed by the first playback entity, executing the voice command corresponding to the voice input, (ii) when the voice input corresponds to a command to be executed by a second playback entity different than the first playback entity, either (a) transmitting the voice input to the area zone primary or (b) creating an ad-hoc connection between the first playback entity and the second playback entity, and transmitting the voice input to the second playback entity via the ad-hoc connection. Some such embodiments may additionally or alternatively include, after receiving a voice input via a first microphone associated with the first playback entity, routing the voice input to a voice command processor.

Alternatively, in some embodiments when the first playback entity is configured to operate as the area zone primary for the first area zone, operating in the first area zone configuration at block 1108 includes the first playback entity, after receiving a voice input via a first microphone associated with the first playback entity, (i) when the voice input corresponds to a command to be executed by the first playback entity, executing the voice command corresponding to the voice input, (ii) when the voice input corresponds to a command to be executed by a second playback entity different than the first playback entity, transmitting the command to the second playback entity.

And in some embodiments when the first playback entity is configured to operate as the area zone primary for the first area zone, operating in the first area zone configuration at block 1108 additionally includes the first playback entity, after receiving a voice input from a second playback entity that originally received the voice input via a second microphone associated with the second playback entity, (i) determining one or more commands for one or more playback entities of the area zone based on the voice input, and (ii) transmitting the one or more commands to the one or more playback entities for execution.

### IX. Example Embodiments

Embodiment 1: A playback device comprising: one or more processors; a playback device clock; and tangible, non-transitory computer-readable media comprising program instructions executable by the one or more processors such that the playback device is configured to, while the playback device is configured as a primary playback device in a playback system comprising the playback device and a playback system coordinator separate from the playback device: (i) after receiving reference clock timing information from a reference clock, determine a timing offset between a clock time of the playback device clock and a clock time of the reference clock; (ii) receive a first series of frames from the playback system coordinator, wherein the first series of frames comprises (a) audio content and (b) system playback timing for the audio content; (iii) for a playback group comprising the playback device and one or more secondary playback devices, generate group playback timing for the audio content based on the system playback timing received from the playback system coordinator and the timing offset between the clock time of the playback device clock and the clock time of the reference clock; (iv) transmit playback device clock timing information from the playback device to the one or more secondary playback devices of the playback group; (v) transmit a second series of frames from the playback device to the one or more secondary playback devices of the playback group, wherein the second series of frames comprises the audio content and the group playback timing for the audio content; and (vi) play the audio content in a groupwise fashion with the one or more secondary playback devices of the playback group based on the group playback timing and the playback device clock.

Embodiment 2: The playback device of Embodiment 1, wherein the reference clock comprises one of (i) a clock at the playback system coordinator or (ii) a playback system clock.

Embodiment 3: The playback device of Embodiment 1, wherein the program instructions executable by the one or more processors such that the playback device is configured to receive a first series of frames from the playback system coordinator comprise program instructions executable by the one or more processors such that the playback device is configured to: receive the first series of frames from the playback system coordinator via one of (i) a multicast transmission from the system coordinator via a wireless Local Area Network (LAN), (ii) a unicast transmission from the system controller via the wireless LAN, (iii) a multicast transmission from the system controller via a wired LAN, or (iv) a unicast transmission from the system controller via the wired LAN.

Embodiment 4: The playback device of Embodiment 1, wherein the program instructions executable by the one or more processors such that the playback device is configured to transmit a second series of frames from the playback device to the one or more secondary playback devices of the playback group comprise program instructions executable by the one or more processors such that the playback device is configured to: transmit the second series of frames from the playback device to the one or more secondary playback devices of the playback group via one of (i) a multicast transmission to the one or more secondary playback devices via the wireless Local Area Network (LAN), (ii) a unicast transmission to the one or more secondary playback devices via the wireless LAN, (iii) a multicast transmission to the one or more secondary playback devices via a wired LAN, or (iv) a unicast transmission to the one or more secondary playback devices via the wired LAN.

Embodiment 5: The playback device of Embodiment 1, wherein the program instructions executable by the one or more processors such that the playback device is configured to play the audio content in a groupwise fashion with the one or more secondary playback devices of the playback group based on the group playback timing and the playback device clock comprise program instructions executable by the one or more processors such that the playback device is configured to: play the audio content in synchrony with the one or more secondary playback devices of the playback group and the playback system coordinator based on the group playback timing and the playback device clock.

Embodiment 6: The playback device of Embodiment 1, wherein the program instructions executable by the one or more processors such that the playback device is configured to determine a timing offset between a clock time of the playback device clock and a clock time of the reference clock comprise program instructions executable by the one or more processors such that the playback device is configured to: (i) after receiving an indication of a current clock time (t₁) of the reference clock, (a) record a receipt time (t₂) of the playback device clock of when the playback device received the indication of the current clock time (t₁) of the reference clock, and (b) transmit a delay request message from the playback device to the reference clock, wherein the delay request message comprises an identifier corresponding to the delay request message; and (ii) after receiving a delay request response from the reference clock in response to the delay request message, wherein the delay response comprises an indication of a time (t₃) when the reference clock transmitted the delay request response, (a) record a receipt time (t₄) of the playback device clock of when the playback device received the delay request response from the reference clock, and (b) calculate the timing offset between the playback device clock and the reference clock according to ((t₂−t₁)+(t₄−t₃))/2.

Embodiment 7: The playback device of Embodiment 1, wherein the program instructions comprise further program instructions executable by the one or more processors such that the playback device is further configured to: (i) before the playback device is configured as a primary playback device in the playback system comprising the playback device and the playback system coordinator separate from the playback device, determine whether the playback device will operate as the primary playback device for the playback group or a secondary playback device in the playback group; and (ii) after determining that the playback device will operate as the primary playback device for the playback group, configure the playback device to operate as the primary playback device for the playback group.

Embodiment 8: The playback device of Embodiment 7, wherein the program instructions executable by the one or more processors such that the playback device is configured to determine whether the playback device will operate as the primary playback device for the playback group or a secondary playback device in the playback group comprise program instructions executable by the one or more processors such that the playback device is configured to: (i) coordinate with all of the playback devices in the playback group to determine which playback device should operate as the primary playback device for the playback group, wherein the determination of which playback device should operate as the primary playback device for group is based on one or more of (a) a measure of network latency between each playback device in the playback group and the playback system coordinator, (b) a measure of transmission signal quality between each playback device in the playback group and the playback system coordinator, (c) a measure of network latency between each playback device in the playback group and each other playback device in the playback group, (d) a measure of transmission signal quality between each playback device in the playback group and each other playback device in the playback group, (e) a measure of each playback device's computing resources available for performing primary playback device functions, or (f) each playback device's media access control (MAC) address.

Embodiment 9: The playback device of Embodiment 1, wherein the program instructions comprise further program instructions executable by the one or more processors such that the playback device is configured to, while the playback device is configured as a primary playback device in a playback system comprising the playback device and a playback system coordinator separate from the playback device: for an audio playback command received either from the playback system coordinator or from a controller device configured to control the playback system, transmitting one or more group audio playback commands to the one or more secondary playback devices of the playback group to effectuate the audio playback command, wherein the audio playback command comprises at least one of (i) a volume adjustment command, (ii) a start audio playback command, (iii) a stop audio playback command, or (iv) a pause audio playback command.

Embodiment 10: The playback device of Embodiment 1, wherein the system playback timing generated by the playback system coordinator for an individual portion of audio content in the first series of frames is a future time that is a first duration of time ahead of a current clock time of the reference clock at the time that the playback system coordinator generated the system playback timing for that individual portion of audio content, wherein the group playback timing generated by the playback device for that same individual portion of audio content in the second series of frames is a future time that is a second duration of time ahead of a current clock time of the playback device clock at the time that the playback device generated the group playback timing for that individual portion of audio content, and wherein the second duration of time is shorter than the first duration of time.

Embodiment 11: A playback device comprising: one or more processors; a playback device clock; and tangible, non-transitory computer-readable media comprising program instructions executable by the one or more processors such that the playback device is configured to, while the playback device is configured as a secondary playback device in a playback group comprising a primary playback device and the playback device: (i) after receiving clock timing information from the primary playback device, determine a timing offset between a clock time of the playback device clock and a clock time of the primary playback device; (ii) receive a series of frames from the primary playback device, wherein the series of frames comprises (a) audio content and (b) group playback timing for the audio content; and (ii) play the audio content in a groupwise fashion with at least the primary playback device of the playback group based on the group playback timing and the playback device clock.

Embodiment 12: The playback device of Embodiment 11, wherein the program instructions executable by the one or more processors such that the playback device is configured to play the audio content in synchrony with at least the primary playback device of the playback group based on the group playback timing and the playback device clock comprise program instructions executable by the one or more processors such that the playback device is configured to: (i) generate sample-rate adjusted audio content by adjusting a sample rate of at least a portion of the audio content to compensate for a difference between a clock rate of the playback device clock and a clock rate of the primary playback device clock when the clock rate of the playback device clock differs from the clock rate of the primary playback device clock; and (ii) play the sample-rate adjusted audio content in synchrony with at least the primary playback device of the playback group based on the clock time of the playback device and the group playback timing information for the audio content.

Embodiment 13: The playback device of Embodiment 11, wherein the program instructions executable by the one or more processors such that the playback device is configured to play the audio content in synchrony with at least the primary playback device of the playback group based on the group playback timing and the playback device clock comprise program instructions executable by the one or more processors such that the playback device is configured to: (i) generate local playback timing for the audio content based on the group playback timing and the timing offset between a clock time of the playback device clock and a clock time of the primary playback device; and (ii) play the audio content in synchrony with at least the primary playback device of the playback group based on the local playback timing and the playback device clock.

Embodiment 14: The playback device of Embodiment 11, wherein the program instructions executable by the one or more processors such that the playback device is configured to receive a series of frames from the primary playback device comprise program instructions executable by the one or more processors such that the playback device is configured to: receive the series of frames from the primary playback device via one of (i) a multicast transmission from the primary playback device via a wireless Local Area Network (LAN), (ii) a unicast transmission from the primary playback device via the wireless LAN, (iii) a multicast transmission from the primary playback device via a wired LAN, or (iv) a unicast transmission from the primary playback device via the wired LAN.

Embodiment 15: The playback device of Embodiment 11, wherein the program instructions executable by the one or more processors such that the playback device is configured to determine a timing offset between a clock time of the playback device clock and a clock time of the primary playback device comprise program instructions executable by the one or more processors such that the playback device is configured to: (i) after receiving an indication of a current clock time (t₁) of the primary playback device, (a) record a receipt time (t₂) of the playback device clock of when the playback device received the indication of the current clock time (t₁) of the primary playback device, and (b) transmit a delay request message from the playback device to the primary playback device, wherein the delay request message comprises an identifier corresponding to the delay request message; and (ii) after receiving a delay request response from the primary playback device in response to the delay request message, wherein the delay response comprises an indication of a time (t₃) when the primary playback device transmitted the delay request response, (a) record a receipt time (t₄) of the playback device clock of when the playback device received the delay request response from the primary playback device, and (b) calculate the timing offset between the playback device clock and the primary playback device according to ((t₂−t₁)+(t₄−t₃))/2.

Embodiment 16: The playback device of Embodiment 11, wherein the program instructions comprise further program instructions executable by the one or more processors such that the playback device is further configured to: (i) before the playback device is configured as a secondary playback device in the playback system comprising the playback device and the primary playback device, determine whether the playback device will operate as the primary playback device for the playback group or a secondary playback device in the playback group; and (ii) after determining that the playback device will operate as a secondary playback device in the playback group, configure the playback device to operate as a secondary playback device in the playback group.

Embodiment 17: The playback device of Embodiment 16, wherein the program instructions executable by the one or more processors such that the playback device is configured to determine whether the playback device will operate as the primary playback device for the playback group or a secondary playback device in the playback group comprise program instructions executable by the one or more processors such that the playback device is configured to coordinate with all of the playback devices in the playback group to determine which playback device should operate as the primary playback device for the playback group, wherein the determination of which playback device should operate as the primary playback device for group is based on one or more of (i) a measure of network latency between each playback device in the playback group and the playback system coordinator, (ii) a measure of transmission signal quality between each playback device in the playback group and the playback system coordinator, (iii) a measure of network latency between each playback device in the playback group and each other playback device in the playback group, (iv) a measure of transmission signal quality between each playback device in the playback group and each other playback device in the playback group, (v) a measure of each playback device's computing resources available for performing primary playback device functions, or (vi) each playback device's media access control (MAC) address.

Embodiment 18: A first playback entity comprising: one or more processors; one or more audio outputs; and tangible, non-transitory computer-readable media comprising program instructions executable by the one or more processors such that the first playback entity is configured to: (1) receive configuration settings for an area zone, wherein the area zone comprises the first playback entity and one or more other playback entities, wherein all the playback entities in the area zone are configured to play audio content from a common audio source, and wherein the configuration settings comprise: (i) a name that identifies the first playback entity in the area zone; (ii) one or more playback configuration settings that define one or more of a volume level or an equalization setting for the first playback entity; and (iii) a volume control configuration setting that defines whether a physical volume control associated with the first playback entity is configured to control (a) a playback volume the first playback entity, or (b) the playback volume of the first playback entity and a playback volume of at least one other playback entity in the area zone; and (2) after receiving a command to activate the area zone, implementing the configuration settings, thereby causing the first playback entity to operate as a playback entity in the area zone.

Embodiment 19: The first playback entity of Embodiment 18, wherein the program instructions comprise program instructions executable by the one or more processors such that the first playback entity is configured to: after receiving a volume adjustment input via the volume control, and based on the volume control configuration setting, adjust either (i) the playback volume of only the first playback entity or (ii) the playback volume of the first playback entity and the at least one other playback entity in the area zone.

Embodiment 20: The first playback entity of Embodiment 18, wherein the physical volume control associated with the first playback entity is configured to control the playback volume of the first playback entity and every other playback entity in the area zone, and wherein the program instructions comprise program instructions executable by the one or more processors such that the first playback entity is configured to: after receiving a volume adjustment input via the physical volume control associated with the first playback entity, and based on the volume control configuration setting, adjust the playback volume of the first playback entity and every other playback entity in the area zone.

Embodiment 21: The first playback entity of Embodiment 18, wherein the first playback entity comprises a logical player implemented by a first playback device, wherein a single logical player is configurable to play audio via one or more of the audio outputs, and wherein the first playback device is configurable to implement two or more logical players.

Embodiment 22: The first playback entity of Embodiment 18, wherein the one or more other playback entities are implemented by one or more physical playback devices separate from the first playback entity.

Embodiment 23: The first playback entity of Embodiment 18, wherein the configuration settings for the area zone comprise instructions for the first playback entity to create a bonded player configuration with at least a second playback entity, wherein in the bonded player configuration, the first playback entity and the second playback entity are configured to operate as a single playback entity.

Embodiment 24: The first playback entity of Embodiment 18, wherein the one or more audio outputs comprises eight audio outputs, and wherein the program instructions comprise program instructions executable by the one or more processors such that the first playback entity is configured to selectively operate in any of a plurality of modes comprising: (i) a first mode where the first playback entity is configured to implement eight single-channel logical players, wherein each logical player is configured to output single-channel audio from one of the eight audio outputs; (ii) a second mode where the first playback entity is configured to implement four two-channel logical players, wherein each logical player is configured to output two-channel audio from two of the eight audio outputs; (iii) a third mode where the first playback entity is configured to implement two four-channel logical players, wherein each logical player is configured to output four-channel audio from four of the eight audio outputs; and (iv) a fourth mode where the first playback entity is configured to implement one eight-channel logical player, where the logical player is configured to output eight-channel audio from the eight audio outputs.

Embodiment 25: The first playback entity of Embodiment 18, wherein the one or more audio outputs comprises eight audio outputs, and wherein the program instructions comprise program instructions executable by the one or more processors such that the first playback entity is configured to selectively operate in any of a plurality of bonded modes comprising: (i) a first bonded mode where the first playback entity is configured to operate in a bonded configuration with a second playback entity comprising eight audio outputs, and wherein the first playback entity and the second playback entity are configured to implement a single logical player configured to output any of (a) one set of sixteen channels of audio, (b) two sets of eight channels of audio, (c) four sets of four channels of audio, (d) eight sets of two channels of audio, or (e) sixteen single channels of audio; and (ii) a second bonded mode where the playback entity is configured to operate in a bonded configuration with the second playback entity and a third playback entity comprising eight audio outputs, and wherein the first playback entity, the second playback entity, and the third playback entity are configured to implement a single logical player configured to output any of (a) one set of twenty four channels of audio, (b) two sets of twelve channels of audio, (c) three sets of eight channels of audio, (d) four sets of six channels of audio, (e) six sets of four channels of audio, (f) eight sets of three channels of audio, (g) twelve sets of two channels of audio, or (h) twenty four singles channels of audio.

Embodiment 26: The first playback entity of Embodiment 18, wherein the area zone configuration settings designate one playback entity as an area zone primary for the area zone, and wherein when the first playback entity is designated as the area zone primary for the area zone, the first playback entity is configured to store area zone configuration settings for the first playback entity and each other playback entity in the area zone.

Embodiment 27: The first playback entity of Embodiment 26, wherein when the first playback entity is configured as an area zone secondary, the first playback entity is configured to store the area zone configuration settings for the first playback entity, but not area zone configuration settings for any other playback entity other than the first playback entity.

Embodiment 28: The first playback entity of Embodiment 18, wherein the program instructions comprise program instructions executable by the one or more processors such that the first playback entity is configured to: (i) coordinate with one or more other playback entities in the area zone to determine which playback entity should operate as an area zone primary for the area zone, wherein the determination of which playback entity should operate as area zone primary for the area zone is based on one or more of (a) which playback entity is identified first in a listing of playback entities in the area zone, (b) which playback entities are configured to receive audio content from the common audio source via a wired network connection versus which playback entities are configured to receive audio content from the common audio source via a wireless network connection, (c) a measure of network latency between each playback entity in the area zone and the common audio source, (d) a measure of transmission signal quality between each playback entity in the area zone and the common audio source, (e) a measure of network latency between each playback entity in the area zone and each other playback entity in the area zone, (f) a measure of transmission signal quality between each playback entity in the area zone and each other playback entity in the area zone, (g) a measure of each playback entity's computing resources available for performing primary player functions, (h) each playback entity's media access control (MAC) address; and (ii) when it has been determined that the first playback entity should operate as the area zone primary for the area zone, inform a cloud server that the first playback entity is operating as the area zone primary for the area zone.

Embodiment 29: The first playback entity of Embodiment 18, wherein the configuration settings for the area zone comprise first configuration settings for a first area zone, and wherein the program instructions comprise program instructions executable by the one or more processors such that the first playback entity is configured to: (i) receive second configuration settings for a second area zone, wherein the second area zone comprises the first playback entity and one or more other playback entities; and (ii) while the first playback entity is operating in the first area zone, and after receiving a command to activate the second area zone, switch from operating in the first area zone to operating in the second area zone, wherein the configuration settings for the second area zone are different than the configuration settings for the first area zone.

Embodiment 30: The first playback entity of Embodiment 18, wherein the audio content from the common audio source comprises multi-channel audio content, wherein the area zone configuration settings further comprise channel instructions based on a channel map for the area zone configuration, wherein the channel instructions specify how to route audio based on one or more channels of the multi-channel audio content to one or more audio outputs associated with each playback entity in the area zone, and wherein the program instructions comprise program instructions executable by the one or more processors such that the first playback entity is configured to: after receiving multi-channel audio content from the common audio source, play audio based on the one or more channels of the multi-channel audio content via the one or more audio outputs of the first playback entity according to the channel instructions.

Embodiment 31: The first playback entity of Embodiment 18, wherein the program instructions comprise program instructions executable by the one or more processors such that the first playback entity is configured to: (i) receive configuration settings for the area zone from (a) a computing system separate from the first playback entity, (b) the computing system via one of the one or more other playback entities in the area zone, or (c) one of the one or more other playback entities in the area zone; and (ii) receive a command to activate the area zone configuration settings from (a) the computing system separate from the first playback entity, (b) the computing system via one of the one or more other playback entities in the area zone, or (c) one of the one or more other playback entities in the area zone.

Embodiment 32: The first playback entity of Embodiment 18, wherein the area zone configuration settings designate one playback entity as an area zone primary for the area zone, and wherein the program instructions comprise program instructions executable by the one or more processors such that the first playback entity is configured to: (i) when the first playback entity is configured as the area zone primary for the area zone, after receiving a request for a listing of playback entities in the area zone from a requesting device, transmit a response to the requesting device, wherein the response comprises a listing of playback entities in the area zone; and (ii) when the first playback entity is configured as an area zone secondary, after receiving a request for a listing of playback entities in the area zone from a requesting device, forwarding the request to the area zone primary for the area zone.

Embodiment 33: The first playback entity of Embodiment 18, wherein the area zone configuration settings designate one playback entity as an area zone primary for the area zone, and wherein the program instructions comprise program instructions executable by the one or more processors such that the first playback entity is configured to: (i) when the first playback entity is configured as an area zone primary for the area zone, (a) establish a group address for the area zone, (b) provide the group address to each other playback entity in the area zone, and (c) transmit commands to the area zone via the group address; and (ii) when the first playback entity is configured as an area zone secondary, (a) subscribe to a group address provided by the area zone primary, and (b) after subscribing the group address, execute area zone commands received from the area zone primary via the group address.

Embodiment 34: The first playback entity of Embodiment 18, wherein the program instructions comprise program instructions executable by the one or more processors such that the first playback entity is configured to: (i) when the first playback entity is configured to receive audio content via a wired network interface, (a) subscribe to a multicast group corresponding to the audio and playback timing, and (b) play audio based on audio content and playback timing for the audio content, wherein the audio content and the playback timing are received via the multicast group; and (ii) when the first playback entity is configured to receive audio via a wireless network interface, play audio based on audio content and playback timing for the audio content, wherein the audio content and the playback timing are received via a unicast network address for the first playback entity.

Embodiment 35: The first playback entity of Embodiment 18, wherein the program instructions comprise program instructions executable by the one or more processors such that the first playback entity is configured to: (i) when the area zone includes fewer than a first threshold number of playback entities, play audio based on audio content and playback timing for the audio content, wherein the audio content and the playback timing are received via a unicast network address for the first playback entity; (ii) when the area zone includes more than the first threshold number of playback entities but fewer than a second threshold number of playback entities, and the first playback entity is configured to receive audio via a wireless network interface, play audio based on audio content and playback timing for the audio content, wherein the audio content and the playback timing are received via a unicast network address for the first playback entity; (iii) when the area zone includes more than the first threshold number of playback entities but fewer than a second threshold number of playback entities, and the first playback entity is configured to receive audio content via a wired network interface, (a) subscribe to a multicast group corresponding to the audio, and (b) play audio based on audio content and playback timing for the audio content, wherein the audio content and the playback timing are received via the multicast group; and (iv) when the area zone includes more the second threshold number of playback entities, (a) subscribe to a multicast group corresponding to the audio, and (b) play audio based on audio content and playback timing for the audio content, wherein the audio content and the playback timing are received via the multicast group.

Embodiment 36: The first playback entity of Embodiment 18, wherein the program instructions comprise program instructions executable by the one or more processors such that the first playback entity is configured to: (i) when the first playback entity is configured as an area zone secondary, (a) in response to receiving an input via a first physical user interface associated with the first playback entity, transmit an indication of the physical input to the area zone primary, and (b) when the first playback entity receives a command from the area zone primary in response to the indication, execute the command; and (ii) when the first playback entity is configured as the area zone primary, after receiving an indication from a second playback entity based on an input via a second physical user interface associated with the second playback entity, (a) determine one or more commands for one or more playback entities of the area zone, and (b) cause the one or more playback entities to execute the one or more commands.

Embodiment 37: The first playback entity of Embodiment 18, wherein the program instructions comprise program instructions executable by the one or more processors such that the first playback entity is configured to: when the first playback entity is configured as an area zone secondary, after receiving a voice input via a first microphone associated with the first playback entity, (i) when the voice input corresponds to a command to be executed by the first playback entity, execute the voice command corresponding to the voice input, (ii) when the voice input corresponds to a command to be executed by a second playback entity different than the first playback entity, either (a) transmit the voice input to the area zone primary or (b) create an ad-hoc connection between the first playback entity and the second playback entity, and transmit the voice input to the second playback entity via the ad-hoc connection.

Embodiment 38: The first playback entity of Embodiment 18, wherein the program instructions comprise program instructions executable by the one or more processors such that the first playback entity is configured to: when the first playback entity is configured as an area zone secondary, after receiving a voice input via a first microphone associated with the first playback entity, route the voice input to a voice command processor.

Embodiment 39: The first playback entity of Embodiment 18, wherein the program instructions comprise program instructions executable by the one or more processors such that the first playback entity is configured to: (i) when the first playback entity is configured as the area zone primary, after receiving a voice input via a first microphone associated with the first playback entity, (a) when the voice input corresponds to a command to be executed by the first playback entity, execute the voice command corresponding to the voice input, (b) when the voice input corresponds to a command to be executed by a second playback entity different than the first playback entity, transmit the command to the second playback entity; and (ii) when the first playback entity is configured as the area zone primary, after receiving a voice input from a second playback entity that originally received the voice input via a second microphone associated with the second playback entity, (a) determine one or more commands for one or more playback entities of the area zone based on the voice input, and (b) transmit the one or more commands to the one or more playback entities for execution.

### X. Conclusions

The above discussions relating to playback devices, controller devices, playback zone configurations, and media/audio content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative example configurations mutually exclusive of other example configurations. As such, the example configurations described herein, explicitly and implicitly understood by one skilled in the art, can be combined with other example configurations.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain example configurations of the present disclosure can be practiced without certain, specific details. In other instances, well known methods, procedures, components, and circuitry have not been described in detail to avoid unnecessarily obscuring aspects of the example configurations. Accordingly, the scope of the present disclosure is defined by the appended claims rather than the foregoing description of example configurations.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1-43. (canceled)

44. A playback device comprising:
one or more processors;
a playback device clock; and
tangible, non-transitory computer-readable media comprising program instructions executable by the one or more processors such that the playback device is configured to, while the playback device is configured as a primary playback device in a playback system comprising the playback device and a playback system coordinator separate from the playback device:
after receiving reference clock timing information from a reference clock, determine a timing offset between a clock time of the playback device clock and a clock time of the reference clock;
receive a first series of frames from the playback system coordinator, wherein the first series of frames comprises (i) audio content and (ii) system playback timing for the audio content;
for a playback group comprising the playback device and one or more secondary playback devices, generate group playback timing for the audio content based on the system playback timing received from the playback system coordinator and the timing offset between the clock time of the playback device clock and the clock time of the reference clock;
transmit playback device clock timing information from the playback device to the one or more secondary playback devices of the playback group;
transmit a second series of frames from the playback device to the one or more secondary playback devices of the playback group, wherein the second series of frames comprises the audio content and the group playback timing for the audio content; and
play the audio content in a groupwise fashion with the one or more secondary playback devices of the playback group based on the group playback timing and the playback device clock.

45. The playback device of claim 44, wherein the reference clock comprises one of (i) a clock at the playback system coordinator or (ii) a playback system clock.

46. The playback device of claim 44, wherein the program instructions executable by the one or more processors such that the playback device is configured to receive a first series of frames from the playback system coordinator comprise program instructions executable by the one or more processors such that the playback device is configured to:
receive the first series of frames from the playback system coordinator via one of (i) a multicast transmission from the playback system coordinator via a wireless Local Area Network (LAN), (ii) a unicast transmission from the playback system coordinator via the wireless LAN, (iii) a multicast transmission from the playback system coordinator via a wired LAN, or (iv) a unicast transmission from the playback system coordinator via the wired LAN.

47. The playback device of claim 44, wherein the program instructions executable by the one or more processors such that the playback device is configured to transmit a second series of frames from the playback device to the one or more secondary playback devices of the playback group comprise program instructions executable by the one or more processors such that the playback device is configured to:
transmit the second series of frames from the playback device to the one or more secondary playback devices of the playback group via one of (i) a multicast transmission to the one or more secondary playback devices via a wireless Local Area Network (LAN), (ii) a unicast transmission to the one or more secondary playback devices via the wireless LAN, (iii) a multicast transmission to the one or more secondary playback devices via a wired LAN, or (iv) a unicast transmission to the one or more secondary playback devices via the wired LAN.

48. The playback device of claim 44, wherein the program instructions executable by the one or more processors such that the playback device is configured to play the audio content in a groupwise fashion with the one or more secondary playback devices of the playback group based on the group playback timing and the playback device clock comprise program instructions executable by the one or more processors such that the playback device is configured to:
play the audio content in synchrony with the one or more secondary playback devices of the playback group and the playback system coordinator based on the group playback timing and the playback device clock.

49. The playback device of claim 44, wherein the program instructions executable by the one or more processors such that the playback device is configured to determine a timing offset between a clock time of the playback device clock and a clock time of the reference clock comprise program instructions executable by the one or more processors such that the playback device is configured to:
after receiving an indication of a current clock time (t1) of the reference clock, (i) record a receipt time (t2) of the playback device clock of when the playback device received the indication of the current clock time (t1) of the reference clock, and (ii) transmit a delay request message from the playback device to the reference clock, wherein the delay request message comprises an identifier corresponding to the delay request message; and
after receiving a delay request response from the reference clock in response to the delay request message, wherein the delay response comprises an indication of a time (t3) when the reference clock transmitted the delay request response, (i) record a receipt time (t4) of the playback device clock of when the playback device received the delay request response from the reference clock, and (ii) calculate the timing offset between the playback device clock and the reference clock according to ((t2−t1)+(t4−t3))/2.

50. The playback device of claim 44, wherein the program instructions comprise further program instructions executable by the one or more processors such that the playback device is further configured to:
before the playback device is configured as a primary playback device in the playback system comprising the playback device and the playback system coordinator separate from the playback device, determine whether the playback device will operate as the primary playback device for the playback group or a secondary playback device in the playback group; and
after determining that the playback device will operate as the primary playback device for the playback group, configure the playback device to operate as the primary playback device for the playback group.

51. The playback device of claim 50, wherein the program instructions executable by the one or more processors such that the playback device is configured to determine whether the playback device will operate as the primary playback device for the playback group or a secondary playback device in the playback group comprise program instructions executable by the one or more processors such that the playback device is configured to:
coordinate with all of the playback devices in the playback group to determine which playback device should operate as the primary playback device for the playback group, wherein the determination of which playback device should operate as the primary playback device for group is based on one or more of (i) a measure of network latency between each playback device in the playback group and the playback system coordinator, (ii) a measure of transmission signal quality between each playback device in the playback group and the playback system coordinator, (iii) a measure of network latency between each playback device in the playback group and each other playback device in the playback group, (iv) a measure of transmission signal quality between each playback device in the playback group and each other playback device in the playback group, (v) a measure of each playback device's computing resources available for performing primary playback device functions, or (vi) each playback device's media access control (MAC) address.

52. The playback device of claim 44, wherein the program instructions comprise further program instructions executable by the one or more processors such that the playback device is configured to, while the playback device is configured as a primary playback device in a playback system comprising the playback device and a playback system coordinator separate from the playback device:
for an audio playback command received either from the playback system coordinator or from a controller device configured to control the playback system, transmitting one or more group audio playback commands to the one or more secondary playback devices of the playback group to effectuate the audio playback command, wherein the audio playback command comprises at least one of (i) a volume adjustment command, (ii) a start audio playback command, (iii) a stop audio playback command, or (iv) a pause audio playback command.

53. The playback device of claim 44, wherein the system playback timing generated by the playback system coordinator for an individual portion of audio content in the first series of frames is a future time that is a first duration of time ahead of a current clock time of the reference clock at the time that the playback system coordinator generated the system playback timing for that individual portion of audio content, wherein the group playback timing generated by the playback device for that same individual portion of audio content in the second series of frames is a future time that is a second duration of time ahead of a current clock time of the playback device clock at the time that the playback device generated the group playback timing for that individual portion of audio content, and wherein the second duration of time is shorter than the first duration of time.

54. A playback device comprising:
one or more processors;
a playback device clock; and
tangible, non-transitory computer-readable media comprising program instructions executable by the one or more processors such that the playback device is configured to, while the playback device is configured as a secondary playback device in a playback group comprising a primary playback device and the playback device:
after receiving clock timing information from the primary playback device, determine a timing offset between a clock time of the playback device clock and a clock time of the primary playback device;
receive a series of frames from the primary playback device, wherein the series of frames comprises (i) audio content and (ii) group playback timing for the audio content; and
play the audio content in a groupwise fashion with at least the primary playback device of the playback group based on the group playback timing and the playback device clock.

55. The playback device of claim 54, wherein the program instructions executable by the one or more processors such that the playback device is configured to play the audio content in synchrony with at least the primary playback device of the playback group based on the group playback timing and the playback device clock comprise program instructions executable by the one or more processors such that the playback device is configured to:
generate sample-rate adjusted audio content by adjusting a sample rate of at least a portion of the audio content to compensate for a difference between a clock rate of the playback device clock and a clock rate of the primary playback device clock when the clock rate of the playback device clock differs from the clock rate of the primary playback device clock; and
play the sample-rate adjusted audio content in synchrony with at least the primary playback device of the playback group based on the clock time of the playback device and the group playback timing information for the audio content.

56. The playback device of claim 54, wherein the program instructions executable by the one or more processors such that the playback device is configured to play the audio content in synchrony with at least the primary playback device of the playback group based on the group playback timing and the playback device clock comprise program instructions executable by the one or more processors such that the playback device is configured to:
generate local playback timing for the audio content based on the group playback timing and the timing offset between a clock time of the playback device clock and a clock time of the primary playback device; and
play the audio content in synchrony with at least the primary playback device of the playback group based on the local playback timing and the playback device clock.

57. The playback device of claim 54, wherein the program instructions executable by the one or more processors such that the playback device is configured to receive a series of frames from the primary playback device comprise program instructions executable by the one or more processors such that the playback device is configured to:
receive the series of frames from the primary playback device via one of (i) a multicast transmission from the primary playback device via a wireless Local Area Network (LAN), (ii) a unicast transmission from the primary playback device via the wireless LAN, (iii) a multicast transmission from the primary playback device via a wired LAN, or (iv) a unicast transmission from the primary playback device via the wired LAN.

58. The playback device of claim 54, wherein the program instructions executable by the one or more processors such that the playback device is configured to determine a timing offset between a clock time of the playback device clock and a clock time of the primary playback device comprise program instructions executable by the one or more processors such that the playback device is configured to:
after receiving an indication of a current clock time (t1) of the primary playback device, (i) record a receipt time (t2) of the playback device clock of when the playback device received the indication of the current clock time (t1) of the primary playback device, and (ii) transmit a delay request message from the playback device to the primary playback device, wherein the delay request message comprises an identifier corresponding to the delay request message; and
after receiving a delay request response from the primary playback device in response to the delay request message, wherein the delay response comprises an indication of a time (t3) when the primary playback device transmitted the delay request response, (i) record a receipt time (t4) of the playback device clock of when the playback device received the delay request response from the primary playback device, and (ii) calculate the timing offset between the playback device clock and the primary playback device according to ((t2−t1)+(t4−t3))/2.

59. The playback device of claim 54, wherein the program instructions comprise further program instructions executable by the one or more processors such that the playback device is further configured to:
before the playback device is configured as a secondary playback device in a playback system comprising the playback device and the primary playback device, determine whether the playback device will operate as the primary playback device for the playback group or a secondary playback device in the playback group; and
after determining that the playback device will operate as a secondary playback device in the playback group, configure the playback device to operate as a secondary playback device in the playback group.

60. The playback device of claim 59, wherein the program instructions executable by the one or more processors such that the playback device is configured to determine whether the playback device will operate as the primary playback device for the playback group or a secondary playback device in the playback group comprise program instructions executable by the one or more processors such that the playback device is configured to:
coordinate with all of the playback devices in the playback group to determine which playback device should operate as the primary playback device for the playback group, wherein the determination of which playback device should operate as the primary playback device for group is based on one or more of (i) a measure of network latency between each playback device in the playback group and a playback system coordinator, (ii) a measure of transmission signal quality between each playback device in the playback group and the playback system coordinator, (iii) a measure of network latency between each playback device in the playback group and each other playback device in the playback group, (iv) a measure of transmission signal quality between each playback device in the playback group and each other playback device in the playback group, (v) a measure of each playback device's computing resources available for performing primary playback device functions, or (vi) each playback device's media access control (MAC) address.
